(19) United States
(12) Patent Application Publication
(10) Pub. No.: US 2022/0237930 A1
(43) Pub. Date: Jul. 28, 2022

(54) CELL AGE CLASSIFICATION AND DRUG SCREENING

(71) Applicants: FOUNTAIN THERAPEUTICS, INC., San Francisco, CA (US); THE BOARD OF TRUSTEES OF THE LELAND STANFORD JUNIOR UNIVERSITY, Stanford, CA (US)

(72) Inventors: Thomas A. RANDO, Stanford, CA (US); Joe RODGERS, San Francisco, CA (US); Hiu Tung CHEUNG, San Francisco, CA (US); Kirsten OBERNIER, San Francisco, CA (US); Fabian ORTEGA, San Francisco, CA (US); Ryan ZARCONE, San Francisco, CA (US)

(21) Appl. No.: 17/674,342

(22) Filed: Feb. 17, 2022

Related U.S. Application Data
(63) Continuation of application No. PCT/US2020/047279, filed on Aug. 20, 2020.
(60) Provisional application No. 62/890,043, filed on Aug. 21, 2019.

(51) Int. Cl. G06V 20/69; G06V 10/764; G06T 7/00

(52) U.S. Cl. CPC G06V 20/698; G06T 7/0012; G06V 10/764

(57) ABSTRACT

The present disclosure provides methods and systems for cell age classification. The method for cell age classification may process images of cells to generate enhanced cell images. The enhanced image of the cell may focus on cell age-dependent phenotypes that may be characteristic of the biological age of the cell. To further improve cell age classification, enhanced cell images may be concatenated and provided to a machine learning-based classifier as an image array and as a single data point. The machine learning-based classifier may use the concatenated enhanced cell images to more accurately determine the age group of the cells. Furthermore, the effects of drug candidates on the biological age of the cells can be determined by contacting the cells of a known chronological age with one or more drug candidates and obtaining images of the cells at a time after the cells have been contacted with the drug candidates.

### CROSS-REFERENCE

This application is a continuation of International Application Serial No. PCT/US2020/047279, filed Aug. 20, 2020, which claims priority to U.S. Provisional Patent Application No. 62/890,043 filed Aug. 21, 2019, which are entirely incorporated herein by references.

### STATEMENT REGARDING FEDERALLY SPONSORED RESEARCH

This invention was made with Government support under contract AG036695 awarded by the National Institutes of Health. The Government has certain rights in the invention.

### BACKGROUND

Cell image processing and analysis often pose several computational challenges. Preparatory steps are usually required to transform collected raw images into corrected images that can be used for analysis. For example, images from a microscopy setup are subject to noise and other acquisition artefacts, and may require post-image processing to correct the images. Cell segmentation can be difficult due to inherent variability in cell appearances. Cell tracking can be difficult to achieve in the presence of multiple overlapping objects. Oftentimes, the images of the cells may contain useful or important features that are not easily discernible to the human eye.

### SUMMARY

There is a need for improved processing and analysis of cell images, in particular to obtain high quality cell images, and to extract valuable data based on features that are inherent in those images. Examples of useful or valuable data may include cell age-dependent phenotypes, morphology and the like. The systems and methods disclosed herein can enable cells to be classified according to their biological ages, which can be useful for screening various effects of drug candidates or therapeutics on cell aging and cell rejuvenation.

An aspect of the disclosure provides a computer-implemented method for drug screening. The method may include contacting one or more cells of a known chronological age with one or more drug candidates. The method may include obtaining one or more images of the one or more cells at a time after said cells have been contacted with the one or more drug candidates. The method may include applying a machine learning-based classifier comprising a multi-class model on the one or more images to determine a biological age of the one or more cells based at least on cell morphology or function.

In some embodiments, the method may include comparing the biological age of the one or more cells with the known chronological age, to determine if the one or more drug candidates have an effect on the cell morphology or function. In some cases, the one or more drug candidates may be used to research effects on aging. In some cases, the one or more drug candidates may comprise one or more therapeutic candidates that are designed to modify one or more age-dependent phenotypes. In some cases, the one or more drug candidates may comprise small molecules, GRAS molecules, FDA/EMA approved compounds, biologics, aptamers, viral particles, nucleic acids, peptide mimetics, peptides, monoclonal antibodies, proteins, fractions from cell-conditioned media, fractions from plasma, serum, or any combination thereof. In some cases, the method may further comprise contacting each of the one or more cells with a different therapeutic candidate. In some cases, the one or more age-dependent phenotypes may comprise: size of chromosomes, size of nucleus, size of cell, nuclear shape, nuclear and or cytoplasmic granularity, pixel intensity, texture, and nucleoli number and appearance, or subcellular structures including mitochondria, lysosomes, endomembranes, actin filaments, cell membrane, microtubules, endoplasmic reticulum, or shape of cell. In some cases, the method may determine an extent or rate of accelerated aging if the one or more cells are determined to have undergone the accelerated aging based on changes to the one or more age-dependent phenotypes. In some cases, the method may determine an aging effect attributable to the one or more drug candidates that is causing the accelerated aging. In some cases, the method may determine an extent or rate of delay in natural aging if the one or more cells are determined to have experienced the delay in natural aging based on changes to the one or more age-dependent phenotypes. In some cases, the method may further comprise determining a rejuvenation effect attributable to the one or more drug candidates that is causing the delay in natural aging.

In some embodiments, the one or more cells may comprise a plurality of cells of different chronological ages. In some cases, the different chronological ages may be on an order ranging from weeks, months, or years. In some cases, the one or more cells may comprise a plurality of cells of different cell types. In some cases, the one or more cells may comprise epithelial cells, neurons, fibroblast cells, stem or progenitor cells, endothelial cells, muscle cells, astrocytes, glial cells, blood cells, contractile cells, secretory cells, adipocytes, vascular smooth muscle cells, vascular endothelial cells, cardiomyocytes, or hepatocytes.

In some embodiments, the method may further comprise contacting the one or more cells with one or more labels. In some cases, the labels may comprise fluorophores or antibodies. In some cases, the fluorophores may be selected from the group consisting of 4′,6-diamidino-2-phenylindole (DAPI), fluorescein, 5-carboxyfluorescein, 2′7′-dimethoxy-4′5′-dichloro-6-carboxyfluorescein, rhodamine, 6-carboxyrhodamine (R6G), N,N,N′,N′-tetramethyl-6-carboxyrhodamine, 6-carboxy-X-rhodamine, 4-acetamido-4′-isothiocyanato-stilbene-2,2′ disulfonic acid, acridine, acridine isothiocyanate, 5-(2′-aminoethyl)amino-naphthalene1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide; anthranilamide, Brilliant Yellow, coumarin, 7-amino-4-methylcoumarin, 7-amino-4-trifluoromethylcoumarin, cyanosine, 5′,5″-dibromopyrogallol-sulfonephthalein (Bromopyrogallol Red), 7-diethylamino-3-(4′-isothiocyanatophenyl)-4-methylcoumarin, diethylenetraimine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-dimethylaminophenylazophenyl-4′-isothiocyanate (DABITC), eosin, eosin isothiocyanate, erythrosine, erythrosine B, erythrosine isothiocyanate, ethidium, 5-(4,6-dichlorotriazin-2-yl)aminofluorescein (DTAF), fluorescein, fluorescein isothiocyanate, QFITC (XRITC), fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene, pyrene butyrate, succinimidyl 1-pyrene butyrate, Reactive Red 4 (Cibacron Brilliant Red 3B-A), lissamine rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101, tetramethyl rhodamine, tetramethyl rhodamine isothiocyanate (TRITC), riboflavin, rosolic acid, terbium chelate derivatives, Hoescht 33342, Hoescht 33258, Hoescht 34580, Propidium iodine, and DRAQ5.

In some embodiments, the method may further comprise processing the one or more images prior to applying the machine learning-based classifier. In some cases, processing the one or more images may comprise enhancing a clarity of a nuclear region of the cell in each of the one or more images. In some cases, the clarity of the nuclear region of the cell in each of the one or more images may be enhanced by using (1) at least one image of the cell generated using light microscopy or (2) at least one image of the cell generated using fluorescence staining. In some cases, the clarity of the nuclear region of the cell in each of the one or more images may be enhanced by combining (1) and (2). In some cases, the clarity of the nuclear region of the cell in each of the one or more images may be enhanced by using each of (1) and (2) separately. In some cases, the light microscopy may include phase-contrast, brightfield, confocal, DIC, polarized light or darkfield microscopy. In some cases, processing the one or more images may comprise at least one of the following: size filtering, background subtraction, normalization, standardization, whitening, edge enhancement, adding noise, reducing noise, elimination of imaging artifacts, cropping, magnification, resizing, rescaling, and color, contrast, brightness adjustment, or object segmentation. In some cases, processing the one or more images may comprise enhancing a clarity of an organelle of the cell in each of the one or more images. In some cases, the organelle of the cell may be nucleolus, nucleus, ribosome, vesicle, rough endoplasmic reticulum, golgi apparatus, cytoskeleton, smooth endoplasmic reticulum, mitochondria, vacuole, cytosol, lysosome, and/or chloroplasts.

In some embodiments, the machine learning-based classifier may be trained using a plurality of images obtained from a same cell type of different known chronological ages. In some cases, the machine learning-based classifier may comprise a deep neural network. In some cases, the deep neural network may comprise a convolutional neural network (CNN). In some cases, the machine learning-based classifier may comprise a regression-based learning algorithm, linear or non-linear algorithms, feed-forward neural network, generative adversarial network (GAN), or deep residual networks. In some cases, the multi-class model may comprise a plurality of age groups. In some cases, the multi-class model may comprise at least two different cell age groups. In some cases, the multi-class model may comprise three or more different cell age groups. In some cases, the machine learning-based classifier may be further configured to account for molecular data in conjunction with the one or more images to determine changes to the one or more age-dependent phenotypes. In some cases, the machine learning-based classifier may be further configured to account for proteomics, metabolomics or gene expression data in conjunction with the one or more images to determine changes to the one or more age-dependent phenotypes. In some cases, the machine learning-based classifier may be further configured to account for one or more functional assays in conjunction with the one or more images to determine changes to the one or more age-dependent phenotypes. In some cases, the one or more functional assays may include assays for mitochondrial, lysosomal, mitotic function/status, DNA or epigenetic repair, or response to injury.

In another aspect, the present disclosure provides a machine learning-based classifier. In some cases, the machine learning-based classifier may be configured to receive one or more processing images of one or more cells. In some cases, the machine learning-based classifier may utilize a multi-class model to classify the one or more cells according to their biological age(s) based on the one or more processed images. In some cases, the one or more images of the one or more cells are taken at a time after said cells have been contacted with one or more drug candidates. In some cases, the one or more cells may be classified according to their biological age(s) based at least on cell morphology or function as determined from the one or more processed images.

In another aspect, the present disclosure provides a computer-implemented method for cell age classification. The method may include processing a plurality of images of a plurality of cells to generate a plurality of enhanced cell images. The method may also include concatenating a set of enhanced cell images selected from the plurality of enhanced cell images to generate a concatenated array of enhanced cell images. The method may also include providing the concatenated array of enhanced cell images into a machine learning-based classifier. The method may also include using the machine learning-based classifier to classify the plurality of enhanced cell images according to a biological age of each of the plurality of cells.

In some embodiments, the biological ages of the plurality of cells may range from at least 12 weeks to 30 months. In some cases, the plurality of cell age groups may be separated by an interval of at most 24 months or weeks and by at least 1 month.

In some embodiments, each of the plurality of enhanced cell images may comprise at least (1) a first image region focusing on a nucleus of the cell, and optionally (2) a second image region focusing on a general region of the cell. In some cases, the general region of the cell may comprise a cytoplasm of the cell.

In some embodiments, the machine learning-based classifier may comprise a deep neural network. In some cases, the deep neural network may comprise a convolutional neural network (CNN). In some cases, the machine learning-based classifier may comprise a regression-based learning algorithm, linear or non-linear algorithms, feed-forward neural network, generative adversarial network (GAN), or deep residual networks. In some cases, the machine learning-based classifier may be configured to classify the plurality of enhanced cell images based on a plurality of cell age groups. In some cases, the machine learning-based classifier may be configured to automatically classify the plurality of enhanced cell images. In some cases, the machine learning-based classifier may be configured to classify the plurality of enhanced cell images in less than 1 minute. In some cases, the machine learning-based classifier may be configured to classify the plurality of enhanced cell images at an accuracy of greater than 66%. In some cases, the machine learning-based classifier may be trained using a set of images of cells of different known chronological ages

In some embodiments, the plurality of images may comprise at least 10,000 images of different cells.

In some embodiments, processing the plurality of images of the plurality of cells may further comprise at least one of the following: size filtering, background subtraction, normalization, standardization, whitening, adding noise, reducing noise, elimination of imaging artifacts, cropping, magnification, resizing, rescaling, and color, contrast, brightness adjustment, or object segmentation.

In some embodiments, the biological age may be a measured or apparent age of each of the plurality of cells based at least on cell morphology or function.

In some embodiments, the plurality of enhanced cell images may be classified according to the biological age and a known chronological age of each of the plurality of cells.

In another aspect, the present disclosure provides a non-transitory computer readable-medium comprising machine-executable instructions that, upon execution by one or more processors, implements a method for cell age classification. In some cases, the method may include processing a plurality of images of a plurality of cells to generate a plurality of enhanced cell images. In some cases, the method may use a machine learning-based classifier to classify the plurality of enhanced cell images according to a biological age of each of the plurality of cells.

In another aspect, the present disclosure provides a machine learning-based classifier. The machine learning-based classifier may be configured to receive a plurality of processed images of a plurality of cells. The machine learning-based classifier may be configured to classify the plurality of enhanced cell images according to biological ages of the cells. In some cases, the machine learning-based classifier may concatenate a set of enhanced cell images selected from the plurality of enhanced cell images to generate a concatenated array of enhanced cell images. In some cases, the concatenated array of enhanced cell images may be processed as a data point within the classifier.

In another aspect, the present disclosure provides a computer-implemented method for use in cell age classification. The method may include generating a first image focusing on a general region of a cell. The method may also include generating a second image focusing on a nuclear region of the cell. The method may also include using at least one of the first image or the second image to generate an enhanced image of the cell. In some cases, the enhanced image of the cell may be used to determine a biological age of the cell.

In some embodiments, the general region of the cell may comprise a cytoplasm of the cell. In some cases, the general region of the cell may be defined by a plasma membrane of the cell. In some cases, the nuclear region may comprise a nucleus of the cell. In some cases, the nuclear region may comprise a nuclear membrane of the cell. In some cases, the first image may be generated using light microscopy. In some cases, the light microscopy may include phase-contrast, brightfield, confocal, DIC, polarized light or darkfield microscopy. In some cases, the second image may be generated using in part fluorescence staining. In some cases, the fluorescence staining may comprise contacting the one or more cells with one or more labels. In some cases, the labels may comprise fluorophores or antibodies. In some cases, the fluorophores may be selected from the group consisting of 4′,6-diamidino-2-phenylindole (DAPI), fluorescein, 5-carboxyfluorescein, 2′7′-dimethoxy-4′5′-dichloro-6-carboxyfluorescein, rhodamine, 6-carboxyrhodamine (R6G), N,N,N′,N′-tetramethyl-6-carboxyrhodamine, 6-carboxy-X-rhodamine, 4-acetamido-4′-isothiocyanato-stilbene-2,2′ disulfonic acid, acridine, acridine isothiocyanate, 5-(2′-aminoethyl)amino-naphthalene1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide; anthranilamide, Brilliant Yellow, coumarin, 7-amino-4-methylcoumarin, 7-amino-4-trifluoromethylcoumarin, cyanosine, 5′,5″-dibromopyrogallol-sulfonephthalein (Bromopyrogallol Red), 7-diethylamino-3-(4′-isothiocyanatophenyl)-4-methylcoumarin, diethylenetraimine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-dimethylaminophenylazophenyl-4′-isothiocyanate (DABITC), eosin, eosin isothiocyanate, erythrosine, erythrosine B, erythrosine isothiocyanate, ethidium, dichlorotriazin-2-yl)aminofluorescein (DTAF), fluorescein, fluorescein isothiocyanate, QFITC (XRITC), fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene, pyrene butyrate, succinimidyl 1-pyrene butyrate, Reactive Red 4 (Cibacron Brilliant Red 3B-A), lissamine rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101, tetramethyl rhodamine, tetramethyl rhodamine isothiocyanate (TRITC), riboflavin, rosolic acid, terbium chelate derivatives, Hoescht 33342, Hoescht 33258, Hoescht 34580, Propidium iodine, and DRAQ5.

In some embodiments, the enhanced image of the cell may be generated by combining the first image and the second image. In some cases, combining the first image and the second image may comprise superimposing the first image and the second image. In some embodiments, the nuclear region of the cell may be enhanced in the second image. In some embodiments, the enhanced image of the cell may contain visual details of proteins in the nuclear region of the cell. In some cases, the visual details may be used for determining the biological age of the cell. In some cases, the first image and the second image may have different background colors or contrast. In some cases, the first image and the second image may have different pixel values. In some cases, the first image may have a grayscale background and the second image may have a black background. In some embodiments, the enhanced image of the cell may comprise a colored image of the nuclear region of the cell. In some cases, the colored image may be configured to enhance a visibility or appearance of features lying within the nuclear region of the cell.

In another aspect, the present disclosure provides a non-transitory computer readable-medium comprising machine-executable instructions that, upon execution by one or more processors, implements a method for processing cell images for use in cell age classification. The method may include generating a first image focusing on a general region of a cell. The method may include generating a second image focusing on a nuclear region of the cell. The method may include using at least one the first image or the second image to generate an enhanced image of the cell. In some cases, the enhanced image of the cell may be used to determine a biological age of the cell.

In another aspect, the present disclosure provides a computer-implemented method for improving cell age classification. The method may include concatenating a plurality of enhanced cell images into an image array. In some cases, the plurality of enhanced cell images may be associated with a plurality of cells of a same or similar biological age. The method may provide the image array as a data point into a machine learning-based classifier. The method may use the machine learning-based classifier to determine an age group of the plurality of cells.

In some embodiments, the image array may comprise a square array of the plurality of enhanced cell images. In some cases, the square array may comprise an n by n array of the enhanced cell images. In some cases, n is any integer that is greater than 2.

In some embodiments, the image array may comprise a rectangular array of the plurality of enhanced cell images. In some cases, the rectangular array may comprise an m by n array of the enhanced cell images. In some cases, m and n are different integers. In some cases, the method may provide the image array as the data point into the machine learning-based classifier. In some cases, providing the image array may enhance the accuracy in determining the age group of the plurality of cells.

In some embodiments, the plurality of enhanced cell images may be pooled from a plurality of different test wells or samples to reduce or eliminate well-to-well variability.

In some embodiments, the machine learning-based classifier may be configured to determine the age group of the plurality of cells using a multi-class classification model. In some cases, the multi-class classification model may comprise a plurality of cell age groups. In some cases, the plurality of cell age groups may comprise at least three different cell age groups. In some cases, the at least three different cell age groups may be spaced apart by an interval of at least 4 weeks. In some cases, the machine learning-based classifier may be configured to determine a probability of the plurality of cells being classified within each of the plurality of cell age groups. In some cases, the machine learning-based classifier may be configured to determine the age group of the plurality of cells by weighing the probabilities of the plurality of cells across the plurality of cell age groups.

In some embodiments, the machine learning-based classifier may comprise a deep neural network. In some cases, the deep neural network may comprise a convolutional neural network (CNN). In some cases, the machine learning-based classifier may comprise a regression-based learning algorithm, linear or non-linear algorithms, feed-forward neural network, generative adversarial network (GAN), or deep residual networks.

In some embodiments, each of the plurality of enhanced cell images may comprise at least (1) a first image region focusing on a nucleus of the cell, and optionally (2) a second image region focusing on a general region of the cell. In some cases, the general region of the cell may comprise a cytoplasm of the cell.

In another aspect, the present disclosure provides a non-transitory computer readable-medium comprising machine-executable instructions that, upon execution by one or more processors, implements a method for improving cell age classification. The method may include concatenating a plurality of enhanced cell images into an image array. The method may provide the image array as a data point into a machine learning-based classifier. The method may also include using the machine learning-based classifier to determine the age group of the plurality of cells. In some cases, the plurality of enhanced cell images may be associated with a plurality of cells having a same or similar age group.

In another aspect, the present disclosure provides a machine learning-based classifier. The machine learning-based classifier may be configured to receive at least one image array comprising a plurality of processed cell images associated with a plurality of cells. The machine learning-based classifier may also classify the plurality of cells according to their biological ages based on the processed cell images. In some cases, the image array may be processed as a data point within the classifier.

In another aspect, the present disclosure provides a method of processing cell images for use in cell age determination. The method may generate a first image focusing on a general region of a cell. The method may generate a second image focusing on a nuclear region of the cell. The method may also include combining or processing the first image and the second image to generate an enhanced image of the cell. The method may also include determining a biological age of the cell based at least on a set of features identified from the enhanced image of the cell. The first image and the second image may include superimposing the first image and the second image. The method may also include processing the plurality of images of the plurality of cells wherein processing comprises at least one of the following: size filtering, background subtraction, normalization, standardization, whitening, adding noise, reducing noise, elimination of imaging artifacts, cropping, magnification, resizing, color adjustment, contrast adjustment, brightness adjustment, or object segmentation. The method may also include processing the one or more images comprises enhancing a clarity of an organelle of the cell in each of the one or more images. The set of features may include one or more morphological cell changes and/or one or more age-dependent phenotypes. The age-dependent phenotypes may be selected from size of chromosomes, size of nucleus, size of cell, nuclear shape, nuclear and or cytoplasmic granularity, pixel intensity, texture, and nucleoli number and appearance, or subcellular structures including mitochondria, lysosomes, endomembranes, actin, cell membrane, microtubules, endoplasmic reticulum, or shape of cell.

In another aspect, the present disclosure provides a method of processing cell images for cell aging analysis. The method may include processing a first image associated with a nucleus of a cell. The method may include processing a second image associated with a region outside of the nucleus of the cell. The method may also use at least one of the processed first image or the processed second image to determine a biological age or a cell aging phenotype of the cell based at least on a set of features identified from the processed first image or the processed second image. The set of features may be one or more morphological cell changes and/or one or more age-dependent phenotypes. The age-dependent phenotypes may be selected from size of chromosomes, size of nucleus, size of cell, nuclear shape, nuclear and or cytoplasmic granularity, pixel intensity, texture, and nucleoli number and appearance, or subcellular structures including mitochondria, lysosomes, endomembranes, actin, cell membrane, microtubules, endoplasmic reticulum, or shape of cell. The method may process the first image and/or second image. Processing the first image and/or second image may include at least one of the following: size filtering, background subtraction, normalization, standardization, whitening, adding noise, reducing noise, elimination of imaging artifacts, cropping, magnification, resizing, color adjustment, contrast adjustment, brightness adjustment, or object segmentation.

In another aspect, the present disclosure provides a method of processing cell images for cell aging analysis. The method may include processing a first image associated with a nucleus of a cell. The method may also include processing a second image associated with a region outside of the nucleus of the cell. The method may also include using at least one of (1) a first set of features identified from the processed first image or (2) a second set of features identified from the processed second image, to determine a biological age or a cell aging phenotype of the cell. The biological age or the cell aging phenotype of the cell may be determined using (1) the first set of features identified from the processed first image and (2) second set of features identified from the processed second image. The biological age or the cell aging phenotype of the cell may be determined using a combined set of features obtained or derived in part from the first and second sets of features. Processing the first image and/or second image may include at least one of the following: size filtering, background subtraction, normalization, standardization, whitening, adding noise, reducing noise, elimination of imaging artifacts, cropping, magnification, resizing, color adjustment, contrast adjustment, brightness adjustment, or object segmentation. The first set of features and/or second set of features may include one or more morphological cell changes and/or one or more age-dependent phenotypes.

In another aspect, the present disclosure may provide a method of processing cell images for cell aging analysis. The method may include processing a first set of images focusing on a nucleus of one or more cells. The method may also include processing a second set of images focusing on a region outside of the nucleus of the one or more cells. The method may include using at least one of the first set or the second set of processed images to determine (1) a biological age of the one or more cells or (2) a cell aging phenotype of the one or more cells. Processing the first set of images and the second set of images may include providing the first and second set of images into a machine learning model. The machine learning model may include a neural network. Processing the first image and/or second image may include at least one of the following: size filtering, background subtraction, normalization, standardization, whitening, adding noise, reducing noise, elimination of imaging artifacts, cropping, magnification, resizing, color adjustment, contrast adjustment, brightness adjustment, or object segmentation.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a general workflow starting from high-content biology to drug discovery, in accordance with embodiments of the present disclosure.

FIG. 2 shows a workflow for cell isolation and culture, in accordance with embodiments of the present disclosure.

FIG. 3 shows dermal fibroblast (dFB) protocols established and validated, in accordance with embodiments of the present disclosure.

FIG. 4 shows liver sinusoidal endothelial cells (LSEC) protocols established and validated, in accordance with embodiments of the present disclosure.

FIG. 5 shows a workflow including cell isolation, image data processing, and age classification of cell images using deep learning, in accordance with embodiments of the present disclosure.

FIG. 6 shows deep learning-based segmentation and quality control filtering to create enhanced cell images for age classification, in accordance with embodiments of the present disclosure.

FIG. 7 shows concatenated enhanced cell images that can increase accuracy of age classification, in accordance with embodiments of the present disclosure.

FIG. 8 shows cell age validation, in accordance with embodiments of the present disclosure.

FIG. 9 shows age classification of cells having a variety of ages, in accordance with embodiments of the present disclosure.

FIG. 10 shows measurements of biological age of primary cells from different tissues, in accordance with embodiments of the present disclosure.

FIG. 11 shows measurements of change in biological age after treatment with peptides FTX0013 and FTX0011, in accordance with embodiments of the present disclosure.

FIG. 12 shows measurements in change of biological age across experiments, in accordance with embodiments of the present disclosure.

FIG. 13 shows treatment with small molecules FTX0017 can provide rejuvenating effect in two cell types, in accordance with embodiments of the present disclosure.

FIG. 14 shows different multi-class models, in accordance with embodiments of the present disclosure.

FIG. 15 shows methods and systems developed as a multi-class, multi-experiment model to encompass biological heterogeneity, in accordance with embodiments of the present disclosure.

FIG. 16 shows the efficacy of the screening model, in accordance with embodiments of the present disclosure.

FIG. 17 shows treatment with small molecule FTX0017 in three independent experiments, in accordance with embodiments of the present disclosure.

FIG. 18 shows set up for small molecule screening, in accordance with embodiments of the present disclosure.

FIG. 19 shows screening funnel, in accordance with embodiments of the present disclosure.

FIG. 20 shows molecular signatures of aging, in accordance with embodiments of the present disclosure.

FIG. 21 shows advantages of supplementing methods and systems with molecular data, in accordance with embodiments of the present disclosure.

FIG. 22 shows target identification for directed drug development and hit validation.

FIG. 23 shows the effects on aging when the serum from old cells are mixed with young cells, in accordance with embodiments of the present disclosure.

FIG. 24 shows a comparison between ages of humans and mice, in accordance with embodiments of the present disclosure.

FIG. 25 shows a computer system that is programmed or otherwise configured to implement methods provided herein.

FIG. 26 shows a DAPI channel gray scale image in accordance with embodiments of the present disclosure.

FIG. 27 shows a phase gradient contrast gray-scale image, in accordance with embodiments of the present disclosure.

FIG. 28 shows a mask image generated by the deep learning model, in accordance with embodiments of the present disclosure.

FIG. 29 shows example coordinates for a cell and a bounding box, in accordance with embodiments of the present disclosure.

FIG. 30 shows a smart patch and concatenated smart patches, in accordance with embodiments of the present disclosure.

FIG. 31 shows various model accuracies, in accordance with embodiments of the present disclosure.

FIG. 32 shows computer parameters for scoring 5×5 concatenated smart patches, in accordance with embodiments of the present disclosure.

FIG. 33 shows generation of a reconstructed phase image for feature extraction, in accordance with embodiments of the present disclosure.

FIG. 34A shows feature extraction on DAPI channel images, in accordance with embodiments of the present disclosure.

FIG. 34B and FIG. 34C shows features extracted from a cell nucleus of a DAPI channel image, in accordance with embodiments of the present disclosure.

FIG. 34D shows features extracted from speckles of a DAPI channel image, in accordance with embodiments of the present disclosure.

FIG. 35 shows dimensional reduction analysis of extracted features, in accordance with embodiments of the present disclosure.

FIG. 36 shows various age grouped cells demographics, in accordance with embodiments of the present disclosure.

FIG. 37 shows computer parameters for data extraction and analysis on a smart patch, in accordance with embodiments of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Smart patch(es) as referred to herein may correspond to enhanced cell image(s), cell image(s) that have undergone one or more of the following: image processing, pre-processing, or post-processing techniques described elsewhere herein.

Whenever the term “at most about” or “at least about” precedes the first numerical value in a series of two or more numerical values, the term “at most about” or “at least about” applies to each of the numerical values in that series of numerical values. For example, at most about 3, 2, or 1 is equivalent to at most about 3, at most about 2, or at most about 1.

### Overview

The biological age of a cell or plurality of cells can provide vital information into the health of an organism. Biological age as referred to herein may be defined as the measured or apparent age of the one or more cells. For humans or animals, the biological age of the plurality of cells may help clinicians evaluate and recommend ways to delay health effects of aging and potentially allow for improved treatments. Currently, there is no single indicator that can be used as a golden index to estimate the biological age of a cell or plurality of cells. Since the cells of organisms can age at different rates despite having the same chronological age, accuracy in determining the biological age of a cell or plurality of cells is needed. Chronological age as referred to herein may be defined as the amount of time the animal was alive prior to harvesting cells from that animal.

By employing image processing techniques and machine learning techniques to focus on certain regions and features of a cell image, more precise cell or biological age determination and classification can be achieved. The machine learning-based classifier along with multi-class model can utilize concatenated enhanced images to reduce the data points and time required to train a machine learning model and produce accurate age classified cells from a variety of single or separate experiments. As a result, the age of a cell or plurality of cells can be used as a target for therapeutics and the response to a drug candidate measured and quantifiable.

In addition, the throughput of drug candidate screening can be amplified as more cells may have their ages classified and verified before and after contact with a drug candidate, thereby allowing the effect of cell rejuvenation or cell aging to be measured. This in turn may allow for links between cell aging effects and indications for the treatment of diseases and cancers.

The following description can be generally divided into the following: (1) protocols for preparation of biological samples, (2) imaging and image processing, (3) machine learning models for cell age classification, and (4) quantifying the effects of therapeutics on cell aging/rejuvenation using trained multi-class models.

### I. Cell Preparation

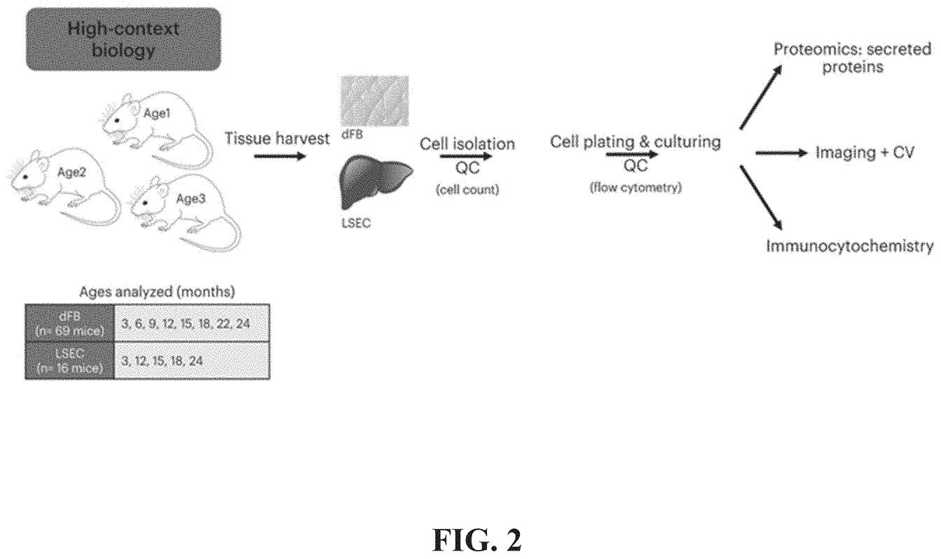

FIG. 2 shows mice that may have different chronological ages as described elsewhere herein. These mice may have their tissues harvested. The tissue may be harvested from, for example, the dermis of a mouse. The dermis may be processed after removal from the mice. The process may include, for example, mincing the tissue, heating the tissue, cooling the tissue, centrifuging the tissue, contacting the tissue with enzymes, contacting the tissue with a tool, or contacting the tissue with a chemical compound, etc. The tissue may be minced to about 2 millimeters. The tissues may be harvested from living or deceased mice. The plurality of cells harvested from the tissue of the mice may be dermal fibroblast (dFB), liver sinusoidal endothelial cells (LSEC), or any other types of cells as described elsewhere herein. Tissue dissociation of the tissue from the mice may be performed using, for example, enzyme dissociation and/or mechanical dissociation. Examples of enzymes for enzyme dissociation may be, Enzyme P, Enzyme A, Enzyme D, collagenase, trypsin, elastase, hyaluronidase, papin, chymotrypsin, deoxyribonuclease I, neutral protease, trypsin inhibitor, animal origin free enzymes, celase GMP, lyophilized proteins, proteolytic enzymes, reconstituted enzymes, or a combination thereof, etc. A solution may be added to stop, limit, reduce the enzyme dissociation reaction. The solution may be, for example, Dulbecco's modified eagle medium (DMEM), horse serum (HS), or DMEM 10% HS, etc. Tissue dissociation may be performed using a dissociation kit. Buffers may be used in tissue dissociation. Examples of buffers include, Cell Dissociation Buffer Enzyme-free PBS, Cell Dissociation Buffer Enzyme-Free Hank's Balanced Salt Solution, or Buffer L, etc.

The quantity of cells in the dissociated tissue (i.e cell suspension) may be determined as described elsewhere herein. The cell suspension may include live or dead cells. In some cases, dead cells may be separated from the cell suspension. Dead cells may be removed by processing the cell suspension as described elsewhere herein. The quantity of cells in cell suspension may be at least about 10\hat{ }5 cells, 10\hat{ }6 cells, 10\hat{ }7 cells, 10\hat{ }8 cells, 10\hat{ }9 cells, 10\hat{ }10 cells or more. The quantity of cells in cell suspension may be at most about 10\hat{ }10 cells, 10\hat{ }9 cells, 10\hat{ }8 cells, 10\hat{ }7 cells, 10\hat{ }6 cells, 10\hat{ }5 cells or less.

The plurality of cells may be labeled. The plurality of cells may be labeled magnetically. The plurality of cells may be marked/identified with a system, for example, cluster of differentiation (CD) system. The CD system may be used for the identification and investigation of the plurality of cells. The CD system may have markers, for example, CD90.2, CD1, CD2 CD3, CD4, CD5, CD6, CD7, CD8, CD9, CD10, CD11, CD13, CD14, CD15, CD16, CD17, CD18, CD19, CD20, CD21, CD22, CD23, CD24, CD25, CD26, CD27, CD28, CD29, CD30, CD31, CD32, CD33, CD34, CD35, CD36, CD37, CD38, CD39, CD40, CD41, CD42, CD43 CD44, CD45, CD46, CD47, CD48, CD49, CD50, CD51, CD52, CD53, CD54, CD55, CD56, CD57, CD58, CD59, CD61, CD62, CD63, CD64, CD66, CD68, CD69, CD70, CD71, CD72, CD73, CD74, CD78, CD79, CD80, CD81, CD82, CD83, CD84, CD85, CD86, CD87, CD88, CD89, CD90, CD91, CD92, CD93, CD94, CD95, CD96, CD97, CD98, CD99, CD100, CD101, CD102, CD103, CD104, CD105, CD106, CD107, CD108, CD109, CD110, CD111, CD112, CD113, CD114, CD115, CD116, CD117, CD118, CD119, CD120, CD121, CD122, CD123, CD124, CD125, CD126, CD127, CD129, CD130, CD131, CD132, CD133, CD134, CD135, CD136, CD137, CD138, CD140b, CD141, CD142, CD143, CD144, CD146, CD147, CD148, CD150, CD151, CD152, CD153, CD154, CD155, CD156, CD157, CD158, CD159, CD160, CD161, CD162, CD163, CD164, CD166, CD167, CD168, CD169, CD170, CD171, CD172, CD174, CD177, CD178, CD179, CD180, CD181, CD182, CD183, CD184, CD185, CD186, CD191, CD192, CD193, CD194, CD195, CD196, CD197, CD198, CD199, CD200, CD201, CD202, CD204, CD205, CD206, CD207, CD208, CD209, CD210, CD212 CD213, CD217, CD218, CD220, CD221, CD222, CD223, CD224, CD225, CD226, CD227, CD228, CD229, CD230, CD233, CD234, CD235, CD236, CD238, CD239, CD240, CD240, CD241, CD243, CD244, CD246, CD247, CD248, CD249, CD252, CD253, CD254, CD256, CD257, CD258, CD261, CD262, CD263, CD264, CD265, CD266, CD267, CD268, CD269, CD271, CD272, CD273, CD274, CD275, CD276, CD278, CD279, CD280, CD281, CD282, CD283, CD284, CD286, CD288, CD289, CD290, CD292, CD293, CD294, CD295, CD297, CD298, CD299, CD300A, CD301, CD302, CD303, CD304, CD305, CD306, CD307, CD309, CD312, CD314, CD315, CD316, CD317, CD318, CD320, CD321, CD322, CD324, CD325, CD326, CD328, CD329, CD331, CD332, CD333, CD334, CD335, CD336, CD337, CD338, CD339, CD340, CD344, CD349, CD350, or a combination thereof, etc. The plurality of cells may include positive (+) or negative (−) to indicate whether a plurality of cell expresses or lacks a CD molecule.

The plurality of magnetically labeled cells may be separated. The plurality of magnetically labeled cells may be separated using magnetic-activated cell sorting (MACS). The MACS method may separate cell populations depending on their CD molecules (i.e surface antigens). The method may separate an unwanted cell type that is magnetically labeled. The method may separate a wanted cell type. The method may use superparamagnetic nanoparticles and/or columns. The superparamagnetic nanoparticles may be at least about 1 nm, 10 nm, 100 nm, 500 nm, 1000 nm, or more. The superparamagnetic nanoparticles may be at most about 1000 nm, 500 nm, 100 nm, 10 nm, 1 nm or less. The magnetic nanoparticles may be, for example, microbeads. The microbeads may be, for example, CD90.2 microbeads. The column may be placed between permanent magnets so that when the plurality of magnetically labeled cells pass through, the plurality of magnetically labeled cells may be captured. The plurality of magnetically labeled cells that may be collected may be, for example, a plurality of positive cells, a plurality of negative cells, etc. The column may include steel wool. The plurality of magnetically labeled cells may be separated by positive or negative selection.

The plurality of cells (e.g. plurality of positive cells) may be suspended in a growth media, for example, natural media and/or artificial media. The growth media may be used to culture the plurality of cells. Examples of artificial media may be serum containing media, serum-free media, chemically defined media, or protein-free media, etc. The growth media may have a buffer system, inorganic salts, amino acids, carbohydrates, proteins and peptides, fatty acids and lipids, vitamins, trace elements, media supplements, antibiotics, or serum in media, etc. The buffer system may be, for example, a natural buffering system, HEPES, or phenol red, etc. A growth media may be used in a particular form, for example, powder, concentrated, or working solution, etc.

The plurality of cells (e.g plurality of positive cells) may be counted. The plurality of cells in a sample may be counted. The plurality of cells may be counted with a hemocytometer. The hemocytometer may be divided into, for example, 9 major squares of 1 mm×1 mm size. The four corners squares may be further subdivided into 4×4 grids. The 4×4 squares may be used to calculate plurality of cells per milliliter (cells/ml) and quantity of plurality of cells per sample (cells/sample).

The plurality of cells (e.g plurality of positive cells) may be diluted to an appropriate volume of cell suspension. The plurality of cells may be diluted with a growth media and horse serum, for example, Promocell fibroblast growth medium with horse serum (HS). The concentration of plurality of cells may be at least about 1 k cells/ml, 10 k cells/ml, 30 k cells/ml, 100 k cells/ml, 1000 k cells/ml, or more. The concentration of plurality of cells may be at most about 1000 k cells/ml, 100 k cells/ml, 30 k cells/ml, 10 k cells/ml, 1 k cells/ml, or less. The concentration of plurality of cells may be from about 1 k cells/ml to 1000 k cells/ml, 1 k cells/ml to 100 k cells/ml, 1 k cells/ml to 30 k cells/ml, 1 k cells/ml to 10 k cells/ml, 10 k cells/ml to 1000 k cells/ml, 10 k cells/ml to 100 k cells/ml, or 100 k cells/ml to 1000 k cells/ml.

The plurality of cells (e.g plurality of positive cells) may be plated. The plurality of cells may be plated into a well culture plate. The plurality of cells may be plated into a well culture plate with a multichannel pipette. The multichannel pipette may plate at least about 1 k cells/well, 10 k cells/well, 100 k cells/well, or more. The multichannel pipette may plate at most about 100 k cells/well, 10 k cells/well, 1 k cells/well, or less. The multichannel pipette may plate from about 1 k cells/well to 100 k cells/well, 1 k cells/well to 10 k cells/well, 10 k cells/well to 100 k cells/well. The well plate may be coated. The well plate may be coated with, for example, poly-D-lysine, collagen type I, etc.

The plurality of cells (e.g plurality of positive cells) may be cultured. The plurality of cells that have been plated may be cultured. The plurality of cells may be incubated for at least about 1 hr, 6 hrs, 12 hrs, 18 hrs, 24 hrs, 48 hrs or more. The plurality of cells may be incubated for at most about 48 hrs, 24 hrs, 18 hrs, 12 hrs, 6 hrs, 1 hr, or less. The plurality of cells may be incubated from about 1 hr to 48 hrs, 1 hr to 24 hrs, 1 hr to 12 hrs, 1 hr to 6 hrs, 6 hrs to 48 hrs, 6 hrs to 24 hrs, 6 hrs to 12 hrs, 12 hrs to 48 hrs, 12 hrs to 24 hrs, 18 hrs to 48 hrs, 18 hrs to 24 hrs, or 24 hrs to 48 hrs. In some cases, the media of the cultured cells may be aspirated. In some cases, the media may be replaced with another media, for example, with serum-free fibroblast growth medium.

The plurality of cells (e.g plurality of positive cells) may be cultured under a set of conditions. The set of conditions may include, temperature, gases, humidity percentage, or exposure to light, etc. In some cases, the temperature may be at about 37° C. In some cases, the culture may be under gases such as water, carbon dioxide, oxygen, nitrogen, air, or argon, etc. In some cases, the percentage of humidity may be at least about 25%, 50%, 75%, 100% or more. In some cases, the percentage of humidity may be at most about 100%, 75%, 50%, 25% or less. In some cases, the percentage of humidity may be from about 25% to 100%, 50% to 100%, or 75% to 100%. In some cases, the plurality of cells may be exposed to light or not exposed to light.

The plurality of cells (e.g plurality of positive cells) may be fixed. The plurality of cells may be fixed prior to imaging. The plurality of cells may be fixed for fluorescent staining. The plurality of cells may be fixed to prevent decay, terminate any ongoing biochemical reaction, to adjust the mechanical strength, and/or to adjust the stability of the plurality of cells. The plurality of cells may be fixed by heat, immersion, and/or perfusion. The plurality of cells may be fixed using chemical fixation. Chemical fixation may include, crosslinking fixatives, precipitating fixatives, oxidizing agents, mercurial, picrates, HOPE (Hepes-glutamic acid buffer-mediated organic solvent protection effect) fixatives, or a combination thereof, etc. Examples of cross-linking fixatives may include aldehydes like formaldehyde, glutaraldehyde, etc. Examples of precipitating fixatives may include acetone and alcohols, like ethanol, methanol, or acetic acid. Examples of oxidizing agents may include oxmiumm tetroxide, potassium dichromate, chromic acid, or potassium permanganate, etc. Examples of merucrials may include B-5 or Zenker's fixative. Chemical fixation may include a buffer, for example, neutral buffered formalin.

A variety of factors may also be adjusted to affect fixing of the plurality of cells, for example, the pH (acidity or basicity), osmolarity, size of the plurality of cells, volume of the fixative, concentration of the fixative, temperature, duration, time from removal to fixation, or a combination thereof etc. The plurality of cells may be fixed as described elsewhere herein.

The plurality of cells (e.g. plurality of positive cells) that may be fixed may be stained. The stain may be a fluorescent compound as described elsewhere herein.

The plurality of cells (e.g plurality of positive cells) may be measured for physical and/or chemical characteristics. The plurality of cells may be probed using flow cytometry. Flow cytometry may be used for cell counting, cell sorting, determining cell characteristics and function, biomarker detection, detecting microorganisms, imaging, immunocytochemistry, or diagnosis, etc. Acquisition (i.e process of collecting data from samples using the flow cytometer), may be done using a computer that may be connected to the flow cytometer and software that may handle the digital interface of the flow cytometer. The software may be capable of adjusting parameters (e.g voltage, compensation) of the sample/plurality of cells being tested. A wide variety of reagents may be used during flow cytometery, for example, antibodies, fluorescently labeled antibodies, dyes, buffers, cell stimulation reagents, protein transport inhibitors, fc blocks, control reagents, or chemical compounds, etc.

Flow cytometry may be performed on at least about 1 k cells/sample, 10 k cells/sample, 30 k cells/sample, 50 k cells/sample, 100 k cells/sample, 1000 k cells/sample, or more. The concentration of plurality of cells may be at most about 1000 k cells/sample, 100 k cells/sample, 50 k cells/sample, 30 k cells/sample, 10 k cells/sample, 1 k cells/sample, or less. The concentration of plurality of cells for may be from about 1 k cells/sample to 1000 k cells/sample, 1 k cells/ml to 100 k cells/sample, 1 k cells/sample to 50 k cells/sample, 1 k cells/sample to 30 k cells/sample, 1 k cells/sample to 10 k cells/sample, 10 k cells/sample to 1000 k cells/sample, 10 k cells/sample to 100 k cells/sample, or 100 k cells/sample to 1000 k cells/sample. Conjugated flow antibodies may be added to the sample. The ratio of conjugates flow antibodies may be about 1:100. The samples may be further incubated for at least about 1 min, 10 min, 20 min, 30 min, 60 min, or more. The samples may be further incubated for at most about 60 min, 30 min, 20 min, 10 min, 1 min, or less. The samples may be further prepared prior to flow cytometry analysis as described elsewhere herein.

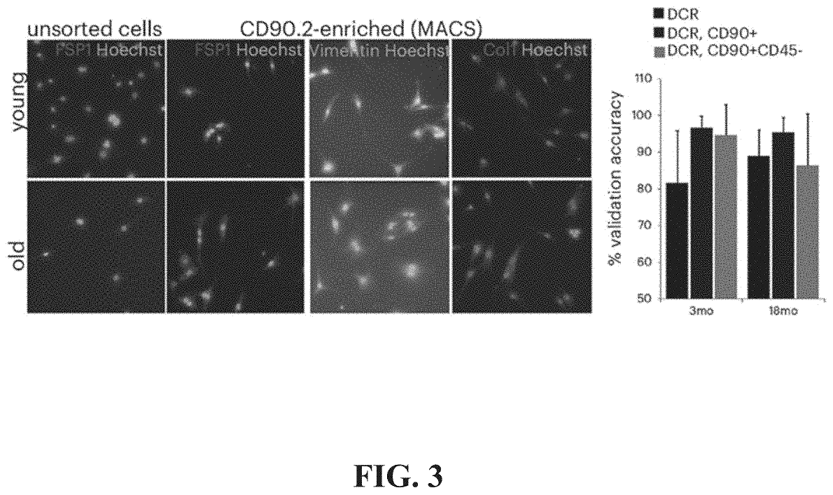

FIG. 3 shows the dFB protocols established and validated, in accordance with embodiments of the present disclosure. FIG. 3 shows images of unsorted cells from dFB stained with Hoechst that have been classified as described elsewhere herein. The validation study illustrates that against the standard (DCR), the CD90 enriched cells (CD90+) were accurately validated with about 95% in 3-month-old cells. In the 18-month-old cells, the CD90 enriched cells (CD90+) were accurately validated with about 94%. These results illustrate that the CD90 enriched cells may provide more accurate age validation.

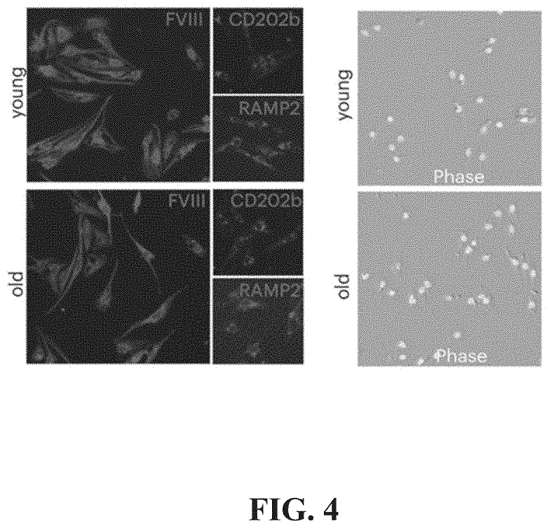

FIG. 4 shows the LSEC protocols established and validated, in accordance with embodiments of the present disclosure. FIG. 4 shows images of unsorted cells from LSEC stained and classified as described elsewhere herein. The validation study resulted in age validation accuracy of about 93%. FIG. 4 illustrates the stained images of old and young cells that enable the machine learning process for age classification. The results shown in FIG. 3 and FIG. 4 illustrate that the protocols may be used for a variety different type of cells with high age validation accuracy.

### II. Cell Imaging and Image Processing

In another aspect, the disclosure provides a method of processing cell images for use in cell age classification. The method may comprise generating a first image focusing on a general region of a cell. In some cases, the general region of a cell may be as described elsewhere herein. For example, in some embodiments, the general region of the cell may comprise a cytoplasm of the cell. The general region of the cell may be defined by a plasma membrane of the cell. In some cases, the method may generate at least about 1, 2, 3, 4, 5, 6, 7, 8, 9, 10, 15, 20, 25, 30, 35, 40, 45, 50, 55, 60, 65, 70, 75, 80, 85, 90, 95, 100, 200, 300, 400, 500, 600, 700, 800, 900, 1000, 10000 or more images that focus on a general region of a cell. In some cases, the method may generate at most about 10000, 1000, 900, 800, 700, 600, 500, 400, 300, 200, 100, 95, 90, 85, 80, 75, 70, 65, 60, 55, 50, 45, 40, 35, 30, 25, 20, 15, 10, 9, 8, 7, 6, 5, 4, 3, 2, or less images that focus on a general region of a cell. In some cases, the method may generate from about 1 to 10000, 1 to 1000, 1 to 500, 1 to 100, 1 to 50, 1 to 10, 1 to 9, 1 to 8, 1 to 7, 1 to 6, 1 to 5, 1 to 4, 1 to 3, 1 to 2, 5 to 10000, 5 to 1000, 5 to 500, 5 to 100, 5 to 50, 5 to 10, 5 to 9, 5 to 8, 5 to 7, or 5 to 6 images that focus on a general region of a cell.

The method may further comprise generating a second image focusing on a nuclear region of the cell. In some cases, the second image may focus on an organelle of a cell as described elsewhere herein. In some cases, the second image may focus on a different region of the cell as described elsewhere herein. For example, in some embodiments, the nuclear region may comprise a nucleus of the cell. In some embodiments, the nuclear region may comprise a nuclear membrane of the cell. In some cases, the method may generate at least about 1, 2, 3, 4, 5, 6, 7, 8, 9, 10, 15, 20, 25, 30, 35, 40, 45, 50, 55, 60, 65, 70, 75, 80, 85, 90, 95, 100, 200, 300, 400, 500, 600, 700, 800, 900, 1000, 10000 or more images that focus on the nuclear region of the cell. In some cases, the method may generate at most about 10000, 1000, 900, 800, 700, 600, 500, 400, 300, 200, 100, 95, 90, 85, 80, 75, 70, 65, 60, 55, 50, 45, 40, 35, 30, 25, 20, 15, 10, 9, 8, 7, 6, 5, 4, 3, 2, or less images that focus on the nuclear region of the cell. In some cases, the method may generate from about 1 to 10000, 1 to 1000, 1 to 500, 1 to 100, 1 to 50, 1 to 10, 1 to 9, 1 to 8, 1 to 7, 1 to 6, 1 to 5, 1 to 4, 1 to 3, 1 to 2, 5 to 10000, 5 to 1000, 5 to 500, 5 to 100, 5 to 50, 5 to 10, 5 to 9, 5 to 8, 5 to 7, or 5 to 6 images that focus on the nuclear region of the cell.

In some embodiments, the method may use at least one of the first image or the second image to generate an enhanced image of the cell. In some embodiments, the enhanced image of the cell may be used to determine a biological age of the cell.

In some embodiments, the first image may be generated using light microscopy. The light microscopy may include phase-contrast, brightfield, confocal, DIC, polarized light or darkfield microscopy. Other microscopies as described elsewhere herein may be used.

In some embodiments, the second image may be generated using in part fluorescence staining. The fluorescence staining may comprise contacting the one or more cells with one or more labels. The labels may comprise fluorophores or antibodies. The fluorophores may be selected from the group consisting of 4′,6-diamidino-2-phenylindole (DAPI), fluorescein, 5-carboxyfluorescein, 2′7′-dimethoxy-4′5′-dichloro-6-carboxyfluorescein, rhodamine, 6-carboxyrhodamine (R6G), N,N,N′,N′-tetramethyl-6-carboxyrhodamine, 6-carboxy-X-rhodamine, 4-acetamido-4′-isothiocyanato-stilbene-2,2′ disulfonic acid, acridine, acridine isothiocyanate, 5-(2′-aminoethyl)amino-naphthalene1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide; anthranilamide, Brilliant Yellow, coumarin, 7-amino-4-methylcoumarin, 7-amino-4-trifluoromethylcoumarin, cyanosine, 5′,5″-dibromopyrogallol-sulfonephthalein (Bromopyrogallol Red), 7-diethylamino-3-(4′-isothiocyanatophenyl)-4-methylcoumarin, diethylenetraimine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-dimethylaminophenylazophenyl-4′-isothiocyanate (DABITC), eosin, eosin isothiocyanate, erythrosine, erythrosine B, erythrosine isothiocyanate, ethidium, dichlorotriazin-2-yl)aminofluorescein (DTAF), fluorescein, fluorescein isothiocyanate, QFITC (XRITC), fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene, pyrene butyrate, succinimidyl 1-pyrene butyrate, Reactive Red 4 (Cibacron Brilliant Red 3B-A), lissamine rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101, tetramethyl rhodamine, tetramethyl rhodamine isothiocyanate (TRITC), riboflavin, rosolic acid, terbium chelate derivatives, Hoescht 33342, Hoescht 33258, Hoescht 34580, Propidium iodine, and DRAQ5.

In some embodiments, the enhanced image of the cell may be generated by combining the first image and the second image. Combining the first image and the second image may comprise superimposing the first image and the second image. The first image and the second image may be superimposed using a programming language script, consumer software, and/or enterprise software. More than one image may be superimposed to generate an enhanced image.

In some embodiments, an organelle of the cell may be enhanced in the second image. In some embodiments, the nuclear region of the cell may be enhanced in the second image. In some embodiments, the enhanced image of the cell may contain visual details of proteins in the nuclear region of the cell. In some embodiments, the enhanced image of the cell may contain visual details of drug candidates in the nuclear region of the cell. The visual details may be used for determining the biological age of the cell.

In some embodiments, the first image and the second image may have different background colors or contrast. In some embodiments, the first image and the second image may have different RGB values. The first image may have a grayscale background and the second image may have a black background. The first image and the second image may have other color space/models as described elsewhere herein.

In some embodiments, the enhanced image of the cell may comprise a colored image of an organelle of the cell. The organelle, may be, for example nucleolus, nucleus, ribosome, vesicle, rough endoplasmic reticulum, golgi apparatus, cytoskeleton, smooth endoplasmic reticulum, mitochondria, vacuole, cytosol, lysosome, and/or chloroplasts.

In some embodiments, the enhanced image of the cell may comprise a colored image of the nuclear region of the cell. The colored image may be configured to enhance a visibility or appearance of features lying within the nuclear region of the cell. The colored image may have a color model/space as described elsewhere herein.

In some embodiments, the one or more images may be processed prior to applying the machine learning-based classifier. The processing of the one or more images may comprise at least one of the following: size filtering, background subtraction, superimposition, elimination of imaging artifacts, whitening, adding noise, reducing noise, edge enhancement, cropping, magnification, resizing, rescaling, and color, contrast, brightness adjust, or object segmentation. An inverted phase image and/or phase channel image may be rescaled. For example, the pixel values from 0.5 to 0.7 of the inverted phase image and/or phase channel image may be stretched across the entire dynamic range. For instance, if the pixel range for the image is 0 to 100, the pixels that have value of 50 may be rescaled to 1 and the pixels that have the value of 70 may be rescaled to 100. The values between 50 and 70 may then be proportionally rescaled from 1 to 100. In some embodiments, a binary mask may be used to remove background pixels from a raw nuclear image. The processing of the one or more images may comprise enhancing the clarity of a nuclear region of the cell in each of the one or more images. The clarity of the nuclear region of the cell in each of the one or more images may be enhanced by using (1) at least one image of the cell generated using light microscopy or (2) at least one image of the cell generated using fluorescence staining. The clarity of the nuclear region of the cell in each of the one or more images may be enhanced by combining (1) and (2). The clarity of the nuclear region of the cell in each of the one or more images may be enhanced by using each of (1) and (2) separately. The light microscopy may include phase-contrast, brightfield, confocal, DIC, or darkfield microscopy. Other microscopies as described elsewhere herein may be used. In some embodiments, a raw gray-scale image of a cell may be difficult to identify features and/or measure granularity. Processing a raw gray-scale image may allow for easier identification of features (e.g., example 25).

The one or more images may be cropped. For example, the one or more images may be cropped to a particular dimension. The image may be cropped to have a width of N pixels and a height of M pixels where in combination produce an image an image with N by M pixels and a total quantity of pixels of N×M. In some cases, N may be the width of pixels of an image and M may be the height of pixels of an image. In some cases, N may be the height of pixels of the image and M may be the width of the image. The image may be cropped to at least about 1000 pixels×10000 pixels, 2000 pixels×10000 pixels, 3000 pixels×10000 pixels, 4000 pixels×10000 pixels, 5000 pixels×10000 pixels, 6000 pixels×10000 pixels, 7000 pixels×10000 pixels, 8000 pixels×10000 pixels, 9000 pixels×10000 pixels, 10000 pixels×10000 pixels, 11000 pixels×10000 pixels, 12000 pixels×10000 pixels, 13000 pixels×10000 pixels, 14000 pixels×10000 pixels, 15000 pixels×10000 pixels, 16000 pixels×10000 pixels, 17000 pixels×10000 pixels, 18000 pixels×10000 pixels, 19000 pixels×10000 pixels, 20000 pixels×10000 pixels, 21000 pixels×10000 pixels, 22000 pixels×10000 pixels, 23000 pixels×10000 pixels, 24000 pixels×10000 pixels, 25000 pixels×10000 pixels, 26000 pixels×10000 pixels, 27000 pixels×10000 pixels, 28000 pixels×10000 pixels, 29000 pixels×10000 pixels, 30000 pixels×10000 pixels, 40000 pixels×10000 pixels, or more. The image may be cropped to at most about 40000 pixels×10000 pixels, 30000 pixels×10000 pixels, 29000 pixels×10000 pixels, 28000 pixels×10000, 27000 pixels×10000 pixels, 26000 pixels×10000 pixels, 25000 pixels×10000 pixels, 24000 pixels×10000 pixels, 23000 pixels×10000 pixels, 22000 pixels×10000 pixels, 21000 pixels×10000 pixels, 20000 pixels×10000 pixels, 19000 pixels×10000 pixels, 18000 pixels×10000 pixels, 17000 pixels×10000 pixels, 16000 pixels×10000 pixels, 15000 pixels×10000 pixels, 14000 pixels×10000 pixels, 13000 pixels×10000 pixels, 12000 pixels×10000 pixels, 11000 pixels×10000 pixels, 10000 pixels×10000 pixels, 9000 pixels×10000 pixels, 8000 pixels×10000 pixels, 7000 pixels×10000 pixels, 6000 pixels×10000 pixels, 5000 pixels×10000 pixels, 4000 pixels×10000 pixels, 3000 pixels×10000 pixels, 2000 pixels×10000 pixels, 1000 pixels×10000 pixels, or less.

In some embodiments, a programming language script may be used to receive microscopy images and nuclear masks. The programming language script may be, for example, MATLAB, python, java, javascript, Ruby, C++, or Perl, etc. The programming language script may output enhanced cell images and concatenated enhanced cell images. The programming language script may need the paths (i.e the name of a file or directory which specifies a unique location in a file computer system) to the microscopy images and nuclear masks. The programming language script may need a file detailing the configuration of the well plate it may be processing. The file may indicate, for example, the contents of each well, the chronological age of the sample, or whether the sample will be used as training data, etc.

The programming language script may process an image and draw a bounding perimeter (e.g., bounding box) around a classified pixel (e.g., a pixel that is a good foreground, bad foreground, or background, etc). The perimeter may be a shape, for example, a polyhedron, a square, rectangle, circle, star, box or oval, etc. The perimeter may have no definite shape but may completely enclose the classified pixel. More than one shape may be used. In some embodiments, the box that encloses a pixel may have a dimension of q by l pixels. In some embodiments, q and l may be different integers. In some cases, q or l may be at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 101, 102, 103, 104, 105, 106, 107, 108, 109, 110, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 3000, 4000, 5000, 6000, 7000, 8000, 9000, 10000, 12500, 15000, 20000, 30000, 40000, 50000, 100000, 10000000, 100000000, 1000000000, 10000000000, 100000000000, or more. In some cases, q or l may be at most about 100000000000, 10000000000, 1000000000, 100000000, 10000000, 100000, 50000, 40000, 30000, 20000, 15000, 12500, 10000, 9000, 8000, 7000, 6000, 5000, 4000, 3000, 2000, 1900, 1800, 1700, 1600, 1500, 1400, 1300, 1200, 1100, 1000, 950, 900, 850, 800, 750, 700, 650, 600, 550, 500, 450, 400, 350, 300, 250, 200, 180, 160, 140, 120, 110, 109, 108, 107, 106, 105, 104, 103, 102, 101 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, or less. In some cases, q or l may be from about 1 to 100000000000, 1 to 10000000, 1 to 100000, 1 to 1000, 1 to 500, 1 to 250, 1 to 200, 1 to 150, 1 to 100, 1 to 50, 1 to 25, 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 5 to 100000000000, 5 to 10000000, 5 to 100000, 5 to 1000, 5 to 500, 5 to 250, 5 to 200, 5 to 150, 5 to 100, 5 to 50, 5 to 25, 5 to 20, 5 to 19, 5 to 18, 5 to 17, 5 to 16, 5 to 15, 5 to 14, 5 to 13, 5 to 12, 5 to 11, 5 to 10, 5 to 9, 5 to 8, 5 to 7, 5 to 6, 10 to 100000000000, 10 to 10000000, 10 to 100000, 10 to 1000, 10 to 500, 10 to 250, 10 to 200, 10 to 150, 10 to 100, 10 to 50, 10 to 25, 10 to 20, 10 to 19, 10 to 18, 10 to 17, 10 to 16, 10 to 15, 10 to 14, 10 to 13, 10 to 12, 10 to 11, 100 to 100000000000, 100 to 10000000, 100 to 100000, 100 to 1000, 100 to 500, 100 to 250, 100 to 200, 100 to 150, 150 to 100000000000, 150 to 10000000, 150 to 100000, 150 to 1000, 150 to 500, 150 to 250, or 150 to 200. In some embodiments, the bounding perimeter (e.g., bounding box) may have a dimension of 101 pixels by 101 pixels (i.e. 101×101)

The dimension of the smart patch image may be equal to the dimension of the bounding perimeter (e.g., bounding box). For example, the bounding perimeter may have dimensions of 101×101, the corresponding smart patch image generated using the contents within the bounding perimeter may be 101×101. In some cases, the smart patch generated may have dimensions smaller than the dimensions of the bounding perimeter. In some cases, the smart patch generated may have dimensions larger than the dimensions of the bounding perimeter. The dimensions of the bounding perimeter may be adjusted to maximize the image size of the corresponding generated smart patch image while minimizing the number of smart patches that contain two or more cells.

The dimensions of the bounding perimeter may be adjusted to maximize the quantity of smart patch images generated from a cell well image. The dimensions of the bounding perimeter may be adjusted to provide higher quality data to the machine learning algorithm (e.g., minimize unwanted data that may be provided to the machine learning algorithm). For example, the dimensions of the bounding perimeter may be adjusted to minimize the number of corresponding smart patches that contain two or more cells when smart patches that contain only one cell may be desired. The optimal dimension of the bounding perimeter may be used to generate greater quantity of higher quality image data provided to the machine learning algorithm. In some cases, the dimensions of the bounding perimeter may be dependent on a cell parameter (e.g., the cell size, the cell type (e.g., stem cells, blood cell, white blood cells, nerve cells, etc), the cell shape, etc). For example, a larger cell size may use a larger bounding perimeter than a smaller cell size.

In some embodiments, if more than one classified pixel is within a perimeter, the classified pixel may be eliminated from the image. For example, if a bounding square (i.e. perimeter) is used, and two nuclei (i.e two classified pixels) are found within the bounding square, the nuclei may be eliminated from the image. In some cases, if the bounding square is at the edge of the image, the nuclei found within the bounding square and the image edge may be eliminated from the image.

In some embodiments, the programming language script may assemble an enhanced cell image. The enhanced cell image made be assembled by stacking a nuclear patch (background subtracted) with a quantity of identical phase patch image. The quantity of identical phase patches may be at least about 1, 2, 3, 4, 5, 6, 7, 8, 9, 10, 15, 20, 30, 40, 50, 100, or more. The quantity of identical phase patches may be at most about 100, 50, 40, 30, 20, 15, 10, 9, 8, 7, 6, 5, 4, 3, 2, or less. The quantity of identical phase patches may be from about 1 to 100, 1 to 50, 1 to 20, 1 to 10, 1 to 9, 1 to 8, 1 to 7, 1 to 6, 1 to 5, 1 to 4, 1 to 3, 1 to 2, 2 to 100, 2 to 50, 2 to 20, 2 to 10, 2 to 9, 2 to 8, 2 to 7, 2 to 6, 2 to 5, 2 to 4, or 2 to 3.

In some embodiments, the one or more images may be in a raster format image or vector format image. Such raster image file formats may be but not limited to: CZI format, JPEG (Joint Photographic Experts Group), JFIF (JPEG File Interchange Format), JPEG 2000, Exif (Exchangeable image file format), SPIFF (Still Picture Interchange File Format), TIFF (Tagged Image File Format), GIF (Graphics Interchange Format), BMP (Windows bitmap), PNG (Portable Network Graphics, “.png”), PPM (portable pixmap file format), PGM (portable graymap file format), PBM (portable bitmap file format), PNM (Portable aNy Map), WebP, HDR raster formats, HEIF (High Efficiency Image File Format), BAT, BPG (Better Portable Graphics), DEEP, DRW (Drawn File), ECW (Enhanced Compression Wavelet), FITS (Flexible Image Transport System), FLIF (Free Lossless Image Format), ICO, ILBM, IMG (ERDAS IMAGINE Image), IMG (Graphics Environment Manager image file), JPEG XR, layered image file format, Nrrd (Nearly raw raster data), PAM (Portable Arbitrary Map), PCX (Personal Computer eXchange), PGF (Progressive Graphics File), PLBM (Planar Bitmap), SGI, SID, Sun Raster, TGA (TARGA), VICAR (NASA/JPL image transport format), XISF (Extensible Image Serialization Format), AFPhoto (Affinity Photo Document), CD5 (Chasys Draw Image), CPT (Corel Photo Paint), PSD (Adobe PhotoShop Document), PSP (Corel Paint Shop Pro), XCF (eXperimental Computing Facility format), and PDN (Paint Dot Net). Such vector formats may be but not limited to: CGM (Computer Graphics Metafile), Gerber format (RS-274X), SVG (Scalable Vector Graphics), AFDesign (Affinity Designer document), AI (Adobe Illustrator Artwork), CDR (CorelDRAW), DrawingML, GEM metafiles, Graphics Layout Engine, HPGL, HVIF (Haiku Vector Icon Format), MathML, NAPLPS (North American Presentation Layer Protocol Syntax), ODG (OpenDocument Graphics), !DRAW, QCC, ReGIS, Remote imaging protocol, VML (Vector Markup Language), Xar format, XPS (XML Paper Specification), AMF (Additive Manufacturing File Format), Asymptote, blend, COLLADA, .dgn, .dwf, .dwg, .dxf, eDrawings, .flt, FVRML, FX3D, HSF, IGES, IMML (Immersive Media Markup Language), IPA, JT, .MA (Maya ASCII format), .MB (Maya Binary format), .OBJ (Alias|Wavefront file format), OpenGEX (Open Game Engine Exchange), PLY, POV-Ray scene description language, PRC, STEP, SKP, STL (stereolithography format), U3D (Universal 3D file format), VRML (Virtual Reality Modeling Language), XAML, XGL, XVL, xVRML, X3D, 0.3D, 3DF, 0.3DM, 0.3 ds, 3DXML, and X3D. In some cases, the digital image file format may be a compound format that uses both pixel and vector data.

In some embodiments, the one or more images may be converted into another image file format using a programming language script. The programming language script may be for example, Python, Java, Javascript, MATLAB, Ruby, C++, or Perl, etc.

In some embodiments, the bit depth of the one or more image may be at least about 1 bit, 2 bits, 3 bits, 4 bits, 5 bits, 6 bits, 7 bits, 8 bits, 16 bits, 24 bits, 32 bits, 40 bits, 48 bits, or more. The bit depth of an image may be at most about 48 bits, 40 bits, 32 bits, 24 bits, 16 bits, 8 bits, 7 bits, 6 bits, 5 bits, 4 bits, 3 bits, 2 bits, or less. The bit depth of an image may be from about 1 bit to 48 bits, 1 bit to 24 bits, 1 bit to 16 bits, 1 bit to 8 bits, 8 bits to 48 bits, 8 bits to 24 bits, or 8 bits to 16 bits.

In some embodiments, the pixel values of one or more image may pertain to a color space/model and may be scaled appropriately. The color model may be the CIE XYZ color model. In some cases, the color model may be CIELAB color model. In some cases, the color model may be for example, a subtractive color model or additive color model. An additive color model may use red, green, and blue (RGB) values. The RGB values, may, for example, be from 0 to 255 for each individual color channel. A subtractive color model may use cyan, magenta, yellow, and black (CMYB). The color model may be a HSV color model that describes colors in hue, saturation, and value (HSV). The color model may be a HSL color model that describes colors in hue, saturation, and lightness (HSL). The color model may be a grayscale model where the pixel of a grayscale image has a brightness value ranging from 0 (black) to 255 (white). The color model may be converted into a different color model. More than one color model may be utilized. Each color channel of a color space/model (for example, the red, green, and/or blue color channel of the color additive model RGB), may be separated into a distinct file dependent on the number of color channels.

In some embodiments, the one or more images may be of any pixel quantity and/or dimension. For example, an image may be described in terms of a width and height where a pixel may be a unit of measurement. The image may have a width of N pixels and a height of M pixels where in combination produce an image with N by M pixels and a total quantity of pixels of N×M, for example an image with 14000 px by 10000 px will have a total of 140000000 px. In some cases, N may be the width of pixels of an image and M may be the height of pixels of an image. In some cases, N may be the height of pixels of the image and M may be the width of the image. The width and/or height of the image may be at least about 1 pixel (px), 2 px, 3 px, 5 px, 7 px, 9 px, 10 px, 15 px, 20 px, 25 px, 30 px, 35 px, 40 px, 45 px, 50 px, 60 px, 70 px, 75 px, 80 px, 85 px, 90 px, 95 px, 100 px, 120 px, 140 px, 150 px, 170 px, 190 px, 200 px, 250 px, 300 px, 400 px, 500 px, 600 px, 700 px, 800 px, 900 px, 1000 px, 1200 px, 1400 px, 1600 px, 1800 px, 2000 px, 3000 px, 4000 px, 5000 px, 10000 px, 50000 px, 100000 px, 500000 px, 1000000 px, 5000000 px, 10000000 px, 50000000 px, 100000000 px, 1000000000 px, 10000000000 px, 100000000000 px, 1000000000000 px, 10000000000000 px, 100000000000000 px, 1000000000000000 px, 10000000000000000 px, or more. The width and/or height of the image may be at most about 10000000000000000 px, 1000000000000000 px, 100000000000000 px, 10000000000000 px, 1000000000000 px, 100000000000 px, 10000000000 px, 1000000000 px, 100000000 px, 50000000 px, 10000000 px, 5000000 px, 1000000 px, 500000 px, 100000 px, 50000 px, 10000 px, 5000 px, 4000 px, 3000 px, 2000 px, 1800 px, 1600 px, 1400 px, 1200 px, 1000 px, 900 px, 800 px, 700 px, 600 px, 500 px, 400 px, 300 px, 250 px, 200 px, 190 px, 170 px, 150 px, 120 px, 100 px, 95 px, 90 px, 85 px, 80 px, 75 px, 70 px, 60 px, 50 px, 45 px, 40 px, 35 px, 30 px, 25 px, 20 px, 15 px, 10 px, 9 px, 8 px, 7 px, 5 px, 3 px, 2 px, or less. The width and/or height of the image may be from about 1 px to 10000000000000000 px, 1 px to 1000000000000000 px, 1 px to 100000000000000 px, 1 px to 10000000000000 px, 1 px to 1000000000000 px, 1 px to 100000000000 px, 1 px to 10000000000 px, 1 px to 1000000000 px, 1 px to 100000000 px, 1 px to 10000000 px, 1 px to 1000000 px, 1 px to 100000 px, 1 px to 10000 px, 1 px to 1000 px, 1 px to 100 px, 1 px to 50 px, 1 px to 25 px, 1 px to 15 px, 10 px to 100000000000 px, 10 px to 10000000000 px, 10 px to 1000000000 px, 10 px to 100000000 px, 10 px to 10000000 px, 10 px to 1000000 px, 10 px to 100000 px, 10 px to 10000 px, 10 px to 1000 px, 10 px to 100 px, 10 px to 50 px, 100 px to 100000000000 px, 100 px to 10000000000 px, 100 px to 1000000000 px, 100 px to 100000000 px, 100 px to 10000000 px, 100 px to 1000000 px, 100 px to 100000 px, 100 px to 10000 px, 100 px to 1000 px, 100 px to 500 px, 100 px to 100000000000 px, 100 px to 10000000000 px, 100 px to 1000000000 px, 1000 px to 100000000 px, 1000 px to 10000000 px, 1000 px to 1000000 px, 1000 px to 100000 px, 1000 px to 10000 px, 1000 px to 5000 px, 1000 px to 2000 px, 1000 px to 100000000000 px, 1000 px to 10000000000 px, 1000 px to 1000000000 px, 10000 px to 100000000 px, 10000 px to 10000000 px, 10000 px to 1000000 px, 10000 px to 100000 px, or 10000 px to 50000 px.

In another aspect, the present disclosure provides a non-transitory computer readable-medium comprising machine-executable instructions that, upon execution by one or more processors, implements a method for processing cell images for use in cell age classification. The method may comprise generating a first image focusing on a general region of a cell. In some embodiments, the method may further comprise generating a second image focusing on a nuclear region of the cell. As described elsewhere herein, the method may use at least one the first image or the second image to generate an enhanced image of the cell. In some embodiments, the enhanced image of the cell may be used to determine a biological age of the cell as described elsewhere herein.

### III. Machine Learning Models for Cell Age Classification

In some embodiments, the method may further comprise applying a machine learning-based classifier on the one or more images to determine a biological age of the one or more cells based at least on cell morphology or function. The biological age may be defined as the measured or apparent age of the one or more cells. In some cases, the biological age and the chronological age may be the same, if the measured or apparent age is the same as the chronological age. In some cases, the biological age and the chronological age are different. For example, a biological age that is greater than the respective chronological age may indicate that the cell has undergone accelerated aging. Conversely, a biological age that is less than the respective chronological age may indicate that the cell has undergone a delay in aging.

Examples of the machine learning-based classifier may comprise a regression-based learning algorithm, linear or non-linear algorithms, feed-forward neural network, generative adversarial network (GAN), or deep residual networks. The machine learning-based classifier may be, for example, unsupervised learning classifier, supervised learning classifier, or a combination thereof. The unsupervised learning classifier may be, for example, clustering, hierarchical clustering, k-means, mixture models, DBSCAN, OPTICS algorithm, anomaly detection, local outlier factor, neural networks, autoencoders, deep belief nets, hebbian learning, generative adversarial networks, self-organizing map, expectation-maximization algorithm (EM), method of moments, blind signal separation techniques, principal component analysis, independent component analysis, non-negative matrix factorization, singular value decomposition, or a combination thereof. The supervised learning classifier may be, for example, support vector machines, linear regression, logistic regression, linear discriminant analysis, decision trees, k-nearest neighbor algorithm, neural networks, similarity learning, or a combination thereof. In some embodiments, the machine learning-based classifier may comprise a deep neural network (DNN). The deep neural network may comprise a convolutional neural network (CNN). The CNN may be, for example, U-Net, ImageNet, LeNet-5, AlexNet, ZFNet, GoogleNet, VGGNet, ResNet18 or ResNet, etc. Other neural networks may be, for example, deep feed forward neural network, recurrent neural network, LSTM (Long Short Term Memory), GRU (Gated Recurrent Unit), Auto Encoder, variational autoencoder, adversarial autoencoder, denoising auto encoder, sparse auto encoder, boltzmann machine, RBM (Restricted BM), deep belief network, generative adversarial network (GAN), deep residual network, capsule network, or attention/transformer networks, etc.

In some embodiments, the machine learning-based classifier may be further configured to account for molecular data in conjunction with the one or more images to determine changes to the one or more age-dependent phenotypes. The molecular data includes data generated from a variety of sources, including but not limited to a molecular simulations and/or database of molecular properties. The molecular properties may be quantum mechanics, physical chemistry, biophysics, and/or physiology, etc. A wide variety of datasets of molecular properties may be used, for example, GDB-13, QM7, QM7b, QM8, QM9, ESOL, FreeSolve, Lipophilicity, PubChem BioAssay (PCBA), Maximum Unbiased Validation (MUV), HIV, PDBbind, BACE, BBBP, Tox21, ToxCast, SIDER, ClinTox, or a combination thereof, etc. Featurization methods may include but not limited to, extended-connectivity fingerprints (ECFP), coulomb matrix, grid featurizer, symmetry function, graph convolution, weave, or a combination thereof, etc. The molecular data may include, the chemical reactivity, chemical structure, chemical bonds, chemical elements, atomic numbers, number of protons, number of electrons, approximate mass, electric charges, diameter of a molecule, shape, orbital shape, size, or energy levels, etc.

In some embodiments, the machine learning-based classifier may be further configured to account for proteomics, metabolomics or gene expression data in conjunction with the one or more images to determine changes to the one or more age-dependent phenotypes. The proteomics, metabolomics or gene expression data may include mass spectrometry data (e.g. mass-to-charge ratios, retention times, intensities for observed proteins as axis, fragmentation spectra, chromatographic peaks, area under the curve, etc), nuclear magnetic resonance data, (proton nmr, carbon nmr, or phosphorous nmr, etc), gas chromatography data, gas chromatography mass spectrometry data (GC-MS), high performance liquid chromatography (HPLC) data, targeted metabolomics assays data, untargeted metabolomics assays, microarray data, single channel arrays data, dual channel arrays data, gene expression matrices (rows representing genes, columns representing samples (e.g. various tissues, developmental stages and treatments), and each cell containing a number characterizing the expression level of the particular gene in the particular sample), gene transcript data, gene regulation data, metabolic and signaling pathways data, the genetic mechanisms of disease data, response to drug treatments data, fluorescence, or polymerase chain reaction (PCR) data, etc.

In some embodiments, the machine learning-based classifier may be further configured to account for one or more functional assays in conjunction with the one or more images to determine changes to the one or more age-dependent phenotypes (e.g. features). The one or more functional assays may include assays for mitochondrial, lysosomal, mitotic function/status, cellular proliferation, cytokine secretion, induction of killing, antiviral activity, degranulation, cytotoxicity, chemotaxis, and promotion of colony formation, cell viability, oxidative metabolism, membrane potential, intracellular ionized calcium, intracellular pH, intracellular organelles, gene reporter assays or response to injury.

In some embodiments, the machine learning-based classifier may be trained using a plurality of images obtained from a same cell type of different known chronological ages. The cell type may be, for example, epithelial cells, neurons, fibroblast cells, stem or progenitor cells, endothelial cells, muscle cells, astrocytes, glial cells, blood cells, contractile cells, secretory cells, adipocytes, vascular smooth muscle cells, vascular endothelial cells, cardiomyocytes, hepatocytes, stem cells, red blood cells, white blood cells, neutrophils, eosinophils, basophils, lymphocytes, platelets, nerve cells, neurological cells, skeletal muscle cells, cardiac muscle cells, smooth muscle cells, cartilage cells, bone cells, osteoblasts, osteoclasts, osteocytes, lining cells, skin cells, keratinocytes, melanocytes, Merkel cells, Langerhans cells, epithellal cells, fat cells, sex cells, insect cells, human cells, animal cells (e.g mouse cells, pig cells, horse cells, bird cells, bear cells, tiger cells, or goats, etc), or organ cells, etc.

In some embodiments, the machine learning-based classifier may be trained using a plurality of images obtained from at least about 1 experiment, 2 experiments, 3 experiments, 4 experiments, 5 experiments, 6 experiments, 7 experiments, 8 experiments, 9 experiments, 10 experiments, 15 experiments, 20 experiments, 25 experiments, 50 experiments, 100 experiments, 500 experiments, 1000 experiments, 10000 experiments, or more. The machine learning-based classifier may be trained using a plurality of images obtained from at most about 10000 experiments, 1000 experiments, 500 experiments, 100 experiments, 50 experiments, 25 experiments, 20 experiments, 15 experiments, 10 experiments, 9 experiments, 8 experiments, 7 experiments, 6 experiments, 5 experiments, 4 experiments, 3 experiments, 2 experiments, or less. The machine learning-based classifier may be trained using a plurality of images obtained from 1 experiment to 10000 experiments, 1 experiment to 1000 experiments, 1 experiment to 100 experiments, 1 experiment to 50 experiments, 1 experiment to 25 experiments, 1 experiment to 20 experiments, 1 experiment to 15 experiments, 1 experiment to 10 experiments, 1 experiment to 9 experiments, 1 experiment to 8 experiments, 1 experiment to 7 experiments, 1 experiment to 6 experiments, 1 experiment to 5 experiments, 5 experiment to 10000 experiments, 5 experiment to 1000 experiments, 5 experiment to 100 experiments, 5 experiment to 50 experiments, 5 experiment to 25 experiments, 5 experiment to 20 experiments, 5 experiment to 15 experiments, 5 experiment to 10 experiments, 5 experiment to 9 experiments, 5 experiment to 8 experiments, 5 experiment to 7 experiments, 5 experiment to 6 experiments, 10 experiment to 10000 experiments, 10 experiment to 1000 experiments, 10 experiment to 100 experiments, 10 experiment to 50 experiments, 10 experiment to 25 experiments, 10 experiment to 20 experiments, or 10 experiment to 15 experiments.

In some embodiments, the machine learning-based classifier may be written in a classification framework. The classification framework may be, for example, PyTorch, BigDL, Caffe, Chainer, Deeplearning4j, Dlib, Intel Data Analytics Acceleration Library, Intel Math Kernel Library, Keras, MATLAB+Deep Learning Toolbox, Microsoft Cognitive Toolkit, Apache MXNet, Neural Designer, OpenNN, Palid ML, Apache SINGA, TensorFlow, Theano, Torch, or Wolfram Mathematica, etc.

In some embodiments, the machine learning-based classifier may have a variety of parameters. The variety of parameters may be, for example, learning rate, minibatch size, number of epochs to train for, momentum, learning weight decay, or neural network layers etc.

In some embodiments, the learning rate may be at least about 0.00001, 0.0001, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, or more. In some embodiments, the learning rate may be at most about 0.1, 0.09, 0.08, 0.07, 0.06, 0.05, 0.04, 0.03, 0.02, 0.01, 0.009, 0.008, 0.007, 0.006, 0.005, 0.004, 0.003, 0.002, 0.001, 0.0001, 0.00001, or less. In some embodiments, the learning rate may be from about 0.00001 to 0.1, 0.00001 to 0.05, 0.00001 to 0.01, 0.00001 to 0.005, 0.00001 to 0.0001, 0.001 to 0.1, 0.001 to 0.05, 0.001 to 0.01, 0.001 to 0.005, 0.01 to 0.1, or 0.01 to 0.05.

In some embodiments, the minibatch size may be at least about 16, 32, 64, 128, 256, 512, 1024 or more. In some embodiments, the minibatch size may be at most about 1024, 512, 256, 128, 64, 32, 16, or less. In some embodiments, the minibatch size may be from about 16 to 1024, 16 to 512, 16 to 256, 16 to 128, 16 to 64, 16 to 32, 32 to 1024, 32 to 512, 32 to 256, 32 to 128, 32 to 64, 64 to 1024, 64 to 512, 64 to 256, or 64 to 128.

In some embodiments, the neural network may comprise neural network layers. The neural network may have at least about 1, 2, 3, 4, 5, 6, 7, 8, 9, 10, 15, 20, 50, 100, 200, 500, 1000 or more neural network layers. The neural network may have at most about 1000, 500, 200, 100, 50, 20, 15, 10, 9, 8, 7, 6, 5, 4, 3, 2 or less neural network layers. In some embodiments, the neural network may have about 1 to 1000, 1 to 500, 1 to 100, 1 to 10, 1 to 5, 1 to 3, 3 to 1000, 3 to 500, 3 to 100, 3 to 10, 3 to 5, 5 to 500, 5 to 100, or 5 to 10 neural network layers.

In some embodiments, the number of epochs to train for may be at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 500, 1000, 10000, or more. In some embodiments, the number of epochs to train for may be at most about 10000, 1000, 500, 250, 200, 150, 100, 95, 90, 85, 80, 75, 70, 65, 60, 55, 50, 45, 40, 35, 30, 25, 19, 18, 17, 16, 15, 14, 13, 12, 11, 10, 9, 8, 7, 6, 5, 4, 3, 2 or less. In some embodiments, the number of epochs to train for may be from about 1 to 10000, 1 to 1000, 1 to 100, 1 to 25, 1 to 20, 1 to 15, 1 to 10, 1 to 5, 10 to 10000, 10 to 1000, 10 to 100, 10 to 25, 10 to 20, 10 to 15, 10 to 12, 20 to 10000, 20 to 1000, 20 to 100, or 20 to 25.

In some embodiments, the momentum may be at least about 0.1, 0.2, 0.3, 0.4, 0.5, 0.6, 0.7, 0.8, 0.9 or more. In some embodiments, the momentum may be at most about 0.9, 0.8, 0.7, 0.6, 0.5, 0.4, 0.3, 0.2, 0.1, or less. In some embodiments, the momentum may be from about 0.1 to 0.9, 0.1 to 0.8, 0.1 to 0.7, 0.1 to 0.6, 0.1 to 0.5, 0.1 to 0.4, 0.1 to 0.3, 0.1 to 0.2, 0.2 to 0.9, 0.2 to 0.8, 0.2 to 0.7, 0.2 to 0.6, 0.2 to 0.5, 0.2 to 0.4, 0.2 to 0.3, 0.5 to 0.9, 0.5 to 0.8, 0.5 to 0.7, or 0.5 to 0.6.

In some embodiments, learning weight decay may be at least about 0.00001, 0.0001, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, or more. In some embodiments, the learning weight decay may be at most about 0.1, 0.09, 0.08, 0.07, 0.06, 0.05, 0.04, 0.03, 0.02, 0.01, 0.009, 0.008, 0.007, 0.006, 0.005, 0.004, 0.003, 0.002, 0.001, 0.0001, 0.00001, or less. In some embodiments, the learning weight decay may be from about 0.00001 to 0.1, 0.00001 to 0.05, 0.00001 to 0.01, 0.00001 to 0.005, 0.00001 to 0.0001, 0.001 to 0.1, 0.001 to 0.05, 0.001 to 0.01, 0.001 to 0.005, 0.01 to 0.1, or 0.01 to 0.05.

In some embodiments, the machine learning-based classifier may use a loss function. The loss function may be, for example, regression losses, mean absolute error, mean bias error, hinge loss, adam optimizer and/or cross entropy.

In some embodiments, the machine learning-based classifier may segment images. The images may segment images into categories. The categories, may be, for example tiled wells, nuclei, general regions of a cell, pixel value, pre-defined dictionary, or pre-defined method, etc. In some cases, the machine learning-based classifier may segment images into categories of at least about 1, 2, 3, 4, 5, 6, 7, 8, 9, 10, 15, 20, 25, 50, 100, 150, 200, 250, 300, 350, 400, 450, 500, 1000, 10000, 100000, or more. The machine learning-based classifier may segment images into categories of at most about 100000, 10000, 1000, 500, 450, 400, 350, 300, 250, 200, 150, 100, 50, 25, 20, 15, 10, 9, 8, 7, 6, 5, 4, 3, 2, or less. The machine learning-based classifier may segment images into categories from about 1 to 100000, 1 to 10000, 1 to 1000, 1 to 500, 1 to 450, 1 to 400, 1 to 350, 1 to 300, 1 to 250, 1 to 200, 1 to 150, 1 to 100, 1 to 50, 1 to 25, 1 to 20, 1 to 15, 1 to 10, 1 to 9, 1 to 8, 1 to 7, 1 to 6, 1 to 5, 1 to 4, 1 to 3, 1 to 2, 3 to 100000, 3 to 10000, 3 to 1000, 3 to 500, 3 to 450, 3 to 400, 3 to 350, 3 to 300, 3 to 250, 3 to 200, 3 to 150, 3 to 100, 3 to 50, 3 to 25, 3 to 20, 3 to 15, 3 to 10, 3 to 9, 3 to 8, 3 to 7, 3 to 6, 3 to 5, or 3 to 4.

In some embodiments, the machine learning-based classifier may comprise a multi-class model. The multi-class model may comprise at least about 2, 3, 4, 5, 6, 7, 8, 9, 10, 15, 20, 25, 30, 35 40, 45, 50, 55, 60, 65, 70, 75, 80, 85, 90, 95, 100, 200, 500, 1000, 5000, 10000, 50000, 100000, or more different cell age groups. The multi-class model may comprise at most about 100000, 50000, 10000, 5000, 1000, 500, 200, 100, 95, 90, 85, 80, 75, 70, 65, 60, 55, 50, 45, 40, 35, 30, 25, 20, 15, 10, 9, 8, 7, 6, 5, 4, 3, 2, or less different cell age groups. The multi-class model may comprise from about 2 to 100000, 2 to 10000, 2 to 1000, 2 to 100, 2 to 50, 2 to 10, 2 to 9, 2 to 8, 2 to 7, 2 to 6, 2 to 5, 2 to 4, 2 to 3, 3 to 50, 3 to 10, 3 to 9, 3 to 8, 3 to 7, 3 to 6, 3 to 5, 3 to 4, 5 to 50, 3 to 5, 5 to 9, 5 to 8, 5 to 7, 5 to 6, 3 to 5, or 3 to 4 different cell age groups.

In some embodiments, the machine learning-based classifier may comprise a multi-class model that may classify a pixel of an image. The machine learning-based classifier may classify a pixel of an image into categories of at least about 1, 2, 3, 4, 5, 6, 7, 8, 9, 10, 15, 20, 25, 50, 100, 150, 200, 250, 300, 350, 400, 450, 500, 1000, 10000, 100000, or more. The machine learning-based classifier may classify a pixel of an image into categories of at most about 100000, 10000, 1000, 500, 450, 400, 350, 300, 250, 200, 150, 100, 50, 25, 20, 15, 10, 9, 8, 7, 6, 5, 4, 3, 2, or less. The machine learning-based classifier may classify a pixel of an image into categories from about 1 to 100000, 1 to 10000, 1 to 1000, 1 to 500, 1 to 450, 1 to 400, 1 to 350, 1 to 300, 1 to 250, 1 to 200, 1 to 150, 1 to 100, 1 to 50, 1 to 25, 1 to 20, 1 to 15, 1 to 10, 1 to 9, 1 to 8, 1 to 7, 1 to 6, 1 to 5, 1 to 4, 1 to 3, 1 to 2, 3 to 100000, 3 to 10000, 3 to 1000, 3 to 500, 3 to 450, 3 to 400, 3 to 350, 3 to 300, 3 to 250, 3 to 200, 3 to 150, 3 to 100, 3 to 50, 3 to 25, 3 to 20, 3 to 15, 3 to 10, 3 to 9, 3 to 8, 3 to 7, 3 to 6, 3 to 5, or 3 to 4.

The machine learning-based classifier may classify a pixel of an image according to a pre-defined dictionary. The pre-defined dictionary may classify a pixel as a good foreground, bad foreground, and/or background. In some cases, the good foreground may for example, represent a nuclei and the bad background may for example, represent binucleated nuclei. In some cases, the good foreground may for example, represent a single cell and the bad background may for example, represent two cells. In some cases, the machine learning-based classifier may classify a pixel of an image based on its pixel value and color space/model as described elsewhere herein.

In some embodiments, the machine learning-based classifier may output image files. The machine learning-based classifier may output a binary mask image and/or an overlay of a microscopy image with a binary mask.

In another aspect, the present disclosure provides a method for cell age classification. The method may comprise processing a plurality of images of a plurality of cells to generate a plurality of enhanced cell images.

In some embodiments, the method may further comprise applying a machine learning-based classifier to classify the plurality of enhanced cell images according to a biological age of each of the plurality of cells. In some embodiments, the biological ages of the plurality of cells may be at least about 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, 12 months, 13 months, 14 months, 15 months, 16 months, 17 months, 18 months, 19 months, 20 months, 21 months 22 months, 23 months, 24 months, 25 months, 26 months, 27 months, 28 months, 29 months 30 months, 31 months, 32 months, 33 months, 34 months, 35 months, 3 years, 4 years, 5 years, 6 years, 7 years, 8 years, 9 years, 10 years or more. The biological ages of the plurality of cells may be at most about 10 years, 5 years, 4 years, 3 years, 35 months, 34 months, 33 months, 32 months, 31 months, 30 months, 29 months, 28 months, 27 months, 26 months, 25 months, 24 months, 23 months, 22 months, 21 months, 20 months, 19 months, 18 months, 17 months, 16 months, 15 months, 14 months, 13 months, 12 months, 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, or less. The biological ages of the plurality of cells may be from about 1 day to 10 years, 1 week to 5 years, 1 month to 2 years, 1 month to 24 months, 1 month to 23 months, 1 month to 22 months, 1 month to 21 months, 1 month to 20 months, 1 month to 19 months, 1 month to 18 months, 1 month to 17 months, 1 month to 16 months, 1 month to 15 months, 1 month to 14 months, 1 month to 13 months, 1 month to 12 months, 1 month to 11 months, 1 month to 10 months, 1 month to 9 months, 1 month to 8 months, 1 month to 7 months, 1 month to 6 months, 1 month to 5 months, 1 month to 4 months, 1 month to 3 months, 1 month to 2 months, 6 month to 2 years, 6 month to 24 months, 6 month to 23 months, 6 month to 22 months, 6 month to 21 months, 6 month to 20 months, 6 month to 19 months, 6 month to 18 months, 6 month to 17 months, 6 month to 16 months, 6 month to 15 months, 6 month to 14 months, 6 month to 13 months, 6 month to 12 months, 6 month to 11 months, 6 month to 10 months, 6 month to 9 months, 6 month to 8 months, 6 month to 7 months, 12 month to 2 years, 12 month to 24 months, 12 month to 23 months, 12 month to 22 months, 12 month to 21 months, 12 month to 20 months, 12 month to 19 months, 12 month to 18 months, 12 month to 17 months, 12 month to 16 months, 12 month to 15 months, 12 month to 14 months, or 12 month to 13 months.

The machine learning-based classifier may comprise a deep neural network. Examples of deep neural networks are described elsewhere herein. The deep neural network may comprise a convolutional neural network (CNN). Examples of CNNs are described elsewhere herein. The machine learning-based classifier may comprise a regression-based learning algorithm, linear or non-linear algorithms, feed-forward neural network, generative adversarial network (GAN), or deep residual networks. More examples of classifiers are described elsewhere herein. In some embodiments, the machine learning-based classifier may have a variety of parameters as described elsewhere herein.

The machine learning-based classifier may be configured to classify the plurality of enhanced cell images based on a plurality of cell age groups. The plurality of cell age groups may comprise at least about 2, 3, 4, 5, 6, 7, 8, 9, 10, 15, 20, 25, 30, 35 40, 45, 50, 55, 60, 65, 70, 75, 80, 85, 90, 95, 100, 200, 500, 1000, 5000, 10000, 50000, 100000, or more different cell age groups. The plurality of cell age groups may comprise at most about 100000, 50000, 10000, 5000, 1000, 500, 200, 100, 95, 90, 85, 80, 75, 70, 65, 60, 55, 50, 45, 40, 35, 30, 25, 20, 15, 10, 9, 8, 7, 6, 5, 4, 3, 2, or less different cell age groups. The plurality of cell age groups may be from about 2 to 100000, 2 to 10000, 2 to 1000, 2 to 100, 2 to 50, 2 to 10, 2 to 9, 2 to 8, 2 to 7, 2 to 6, 2 to 5, 2 to 4, 2 to 3, 3 to 50, 3 to 10, 3 to 9, 3 to 8, 3 to 7, 3 to 6, 3 to 5, 3 to 4, 5 to 50, 3 to 5, 5 to 9, 5 to 8, 5 to 7, 5 to 6, 3 to 5, or 3 to 4 different cell age groups.

In some embodiments, the plurality of cell age groups may be separated by an interval of at least about 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, 12 months, 13 months, 14 months, 15 months, 16 months, 17 months, 18 months, 19 months, 20 months, 21 months 22 months, 23 months, 24 months, 25 months, 26 months, 27 months, 28 months, 29 months 30 months, 31 months, 32 months, 33 months, 34 months, 35 months, 3 years, 4 years, 5 years, 6 years, 7 years, 8 years, 9 years, 10 years or more. The plurality of cell age groups may be separated by an interval of at most about 10 years, 5 years, 4 years, 3 years, 35 months, 34 months, 33 months, 32 months, 31 months, 30 months, 29 months, 28 months, 27 months, 26 months, 25 months, 24 months, 23 months, 22 months, 21 months, 20 months, 19 months, 18 months, 17 months, 16 months, 15 months, 14 months, 13 months, 12 months, 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, or less. The plurality of cell age groups may be separated by an interval of about 1 day to 10 years, 1 week to 5 years, 1 month to 2 years, 1 month to 24 months, 1 month to 23 months, 1 month to 22 months, 1 month to 21 months, 1 month to 20 months, 1 month to 19 months, 1 month to 18 months, 1 month to 17 months, 1 month to 16 months, 1 month to 15 months, 1 month to 14 months, 1 month to 13 months, 1 month to 12 months, 1 month to 11 months, 1 month to 10 months, 1 month to 9 months, 1 month to 8 months, 1 month to 7 months, 1 month to 6 months, 1 month to 5 months, 1 month to 4 months, 1 month to 3 months, 1 month to 2 months, 6 month to 2 years, 6 month to 24 months, 6 month to 23 months, 6 month to 22 months, 6 month to 21 months, 6 month to 20 months, 6 month to 19 months, 6 month to 18 months, 6 month to 17 months, 6 month to 16 months, 6 month to 15 months, 6 month to 14 months, 6 month to 13 months, 6 month to 12 months, 6 month to 11 months, 6 month to 10 months, 6 month to 9 months, 6 month to 8 months, 6 month to 7 months, 12 month to 2 years, 12 month to 24 months, 12 month to 23 months, 12 month to 22 months, 12 month to 21 months, 12 month to 20 months, 12 month to 19 months, 12 month to 18 months, 12 month to 17 months, 12 month to 16 months, 12 month to 15 months, 12 month to 14 months, or 12 month to 13 months

The machine learning-based classifier may be trained using a set of images of cells of different known chronological ages. In some embodiments, the plurality of enhanced cell images may be classified according to the biological age and a known chronological age of each of the plurality of cells. In some embodiments, the biological age may be a measured or apparent age of each of the plurality of cells based at least on cell morphology or function. In some embodiments, each of the plurality of enhanced cell images may comprise at least (1) a first image region focusing on a nucleus of the cell, and optionally (2) a second image region focusing on a general region of the cell. The general region of the cell may comprise a cytoplasm of the cell. In some cases, the image may focus on other general regions of the cell as well, for example, the nucleolus, nuclear membrane, vacuole, mitochondrion, golgi body, ribosomes, smooth endoplasmic reticulum, rough endoplasmic reticulum, cytoplasm, centrosome, lysosome, chloroplast, amlyoplast, centriole, intermediate filaments, plasma membrane, vesicle, plasmid, or cell coat, etc.

In some embodiments, the machine learning-based classifier may be configured to automatically classify the plurality of enhanced cell images. The machine learning-based classifier may use a self-organizing artificial neural network architecture. The machine learning-based classifier may use a deep neural network as described elsewhere herein. The machine learning-based classifier may not require previous knowledge on the domains to be classified. The machine learning-based classifier may have stages of feature extraction, classification, labeling, and indexing of the plurality of enhanced cells images for searching purposes.

In some embodiments, the plurality of images may comprise at least about 5 images, 10 images, 50 images, 100 images, 500 images, 1000 images, 2000 images, 3000 images, 4000 images, 5000 images, 6000 images, 7000 images, 8000 images, 9000 images, 10000 images, 11000 images, 12000 images, 13000 images, 14000 images, 15000 images, 16000 images, 17000 images, 18000 images, 19000 images, 20000 images, 25000 images, 30000 images, 40000 images, 50000 images, 60000 images, 70000 images, 80000 images, 90000 images, 100000 images, 1000000 images, 10000000 images, 100000000 images, 1000000000 images, 10000000000 images or more of different cells. The plurality of images may comprise at most about 10000000000 images, 1000000000 images, 100000000 images, 10000000 images, 1000000 images, 100000 images, 90000 images, 80000 images, 70000 images, 60000 images, 50000 images, 40000 images, 30000 images, 25000 images, 20000 images, 19000 images, 18000 images, 17000 images, 16000 images, 15000 images, 14000 images, 13000 images, 12000 images, 11000 images, 10000 images, 9000 images, 8000 images, 7000 images, 6000 images, 5000 images, 3000 images, 2000 images, 1000 images, 500 images, 100 images, 50 images, 10 images, 5 images, or less. The plurality of images may be from about 5 images to 10000000000 images, 50 images to 100000000 images, 500 images to 1000000 images, 5000 images to 100000 images, 10000 images to 50000 images, 10000 images to 30000 images, or 10000 images to 20000 images of different cells.

The machine learning-based classifier may be configured to classify the plurality of enhanced cell images in at least about 1 microsecond, 1 millisecond, 10 milliseconds, 50 milliseconds, 100 milliseconds, 200 milliseconds, 300 milliseconds, 400 milliseconds, 500 milliseconds, 600 milliseconds, 700 milliseconds, 800 milliseconds, 900 milliseconds, 1 second, 5 seconds, 10 seconds, 15 seconds, 20 seconds, 25 seconds, 30 seconds, 35 seconds, 40 seconds, 45 seconds, 50 seconds, 55 seconds, 1 minute (min), 2 min, 3 min, 4 min, 5 min, 6 min, 7 min, 8 min, 9 min, 10 min, 15 min, 20 min, 25 min, 30 min, 35 min, 40 min, 45 min, 50 min, 55 min, 1 hour (hr), 2 hrs, 3 hrs, 4 hrs, 5 hrs, 6 hrs, 12 hrs, 24 hrs, or more. The machine learning-based classifier may be configured to classify the plurality of enhanced cell images in at most about 24 hrs, 12 hrs, 6 hrs, 5 hrs, 4 hrs, 3 hrs, 2 hrs, 1 hr, 55 min, 50 min, 45 min, 40 min, 35 min, 30 min, 25 min, 20 min, 15 min, 10 min, 9 min, 8 min, 7 min, 6 min, 5 min, 4 min, 3 min, 2 min, 1 min, 55 seconds, 50 seconds, 45 seconds, 40 seconds, 35 seconds, 30 seconds, 25 seconds, 20 seconds, 15 seconds, 10 seconds, 5 seconds, 1 second, 900 milliseconds, 800 milliseconds, 700 milliseconds, 600 milliseconds, 500 milliseconds, 400 milliseconds, 300 milliseconds, 200 milliseconds, 100 milliseconds, 50 milliseconds, 10 milliseconds, 1 millisecond, 1 microsecond, or less. The machine learning-based classifier may be configured to classify the plurality of enhanced cell images from about 1 microsecond to 24 hrs, 1 millisecond to 1 hr, 10 milliseconds to 30 min, 100 millisecond to 10 min, 500 millisecond to 5 min, 1 second to 4 min, 10 sec to 3 min, 30 sec to 2 min, or 45 sec to 1 min.

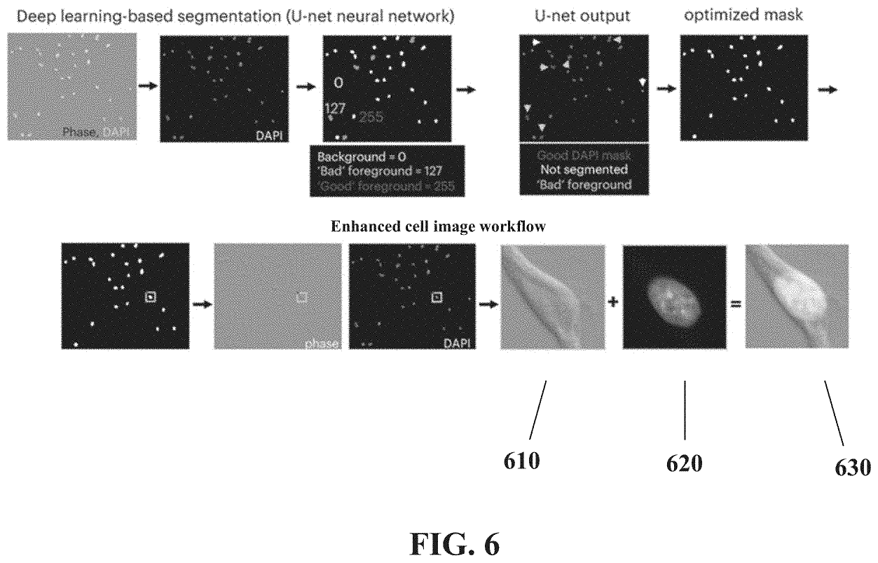

FIG. 6 shows deep learning-based classification and quality control filtering to create enhanced cell images, in accordance with embodiments of the present disclosure. The neural network U-net may be used to segment nuclei from the microscopy images. The cell images from the microscopy experiment are classified by a 3-class classifier and assigned pixel values. The neural network U-net may output an image that may illustrate good DAPI masks, bad foreground, and not segmented components. The image may be used to produce an optimized mask that may be used to produce the enhanced cell image. The optimized mask may then be viewed according to its phase and DAPI components and focused onto the nuclear region of the cell 620 and combined to produce the enhanced nuclear region of the cell 630 (i.e enhanced cell image). The focused nuclear region of the cell may be concatenated as described elsewhere herein.

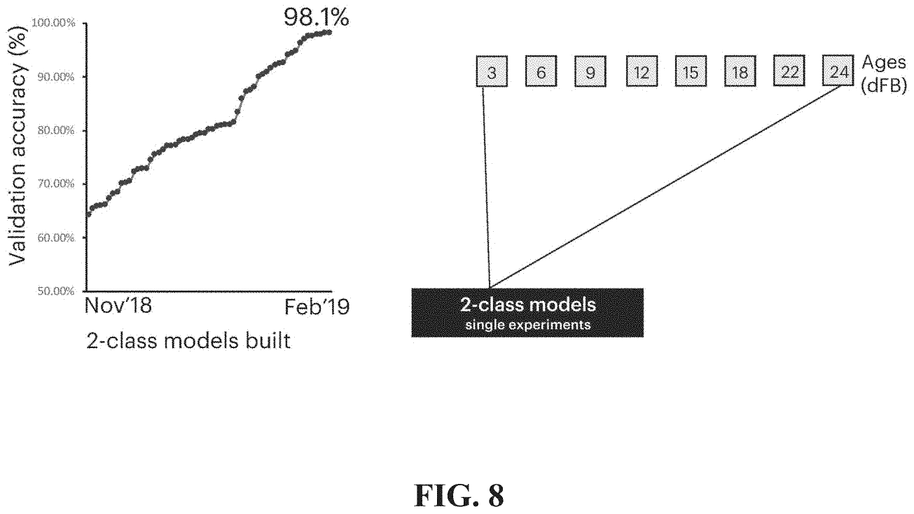

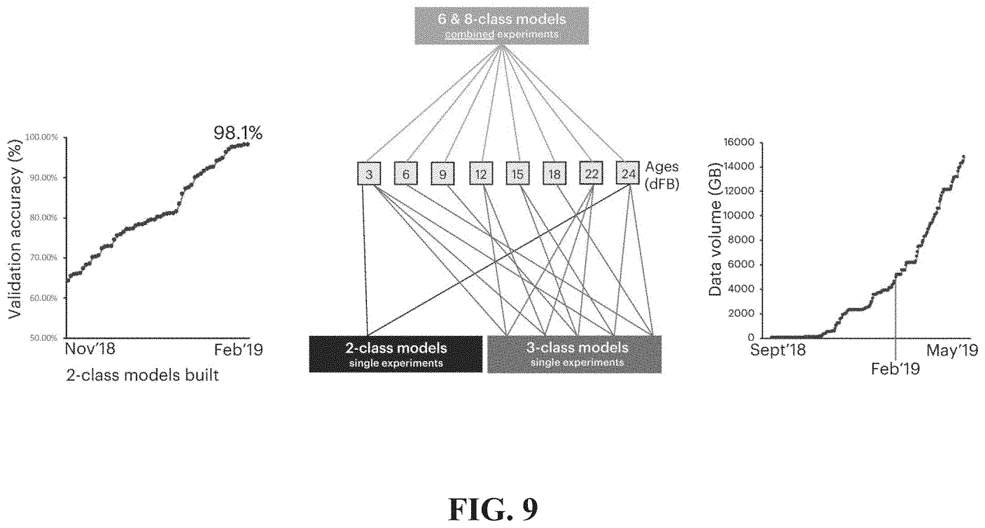

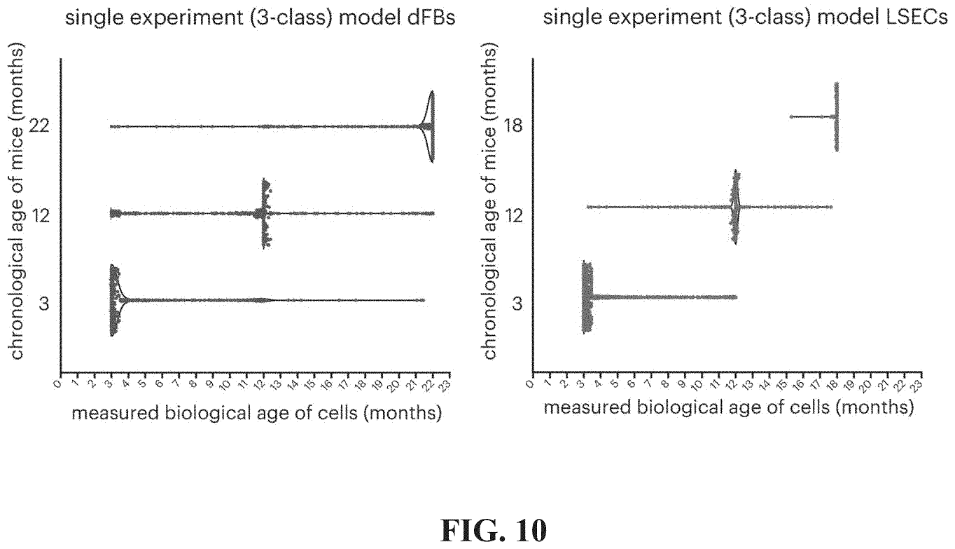

FIG. 8 shows age validation, in accordance with embodiments of the present disclosure. The deep learning model and machine learning-based classifier may accurately classify dFB cells when a 2-class model is employed with cell ages varying from about 3 to 24 months. The validation accuracy was increased to 98.1% over the course of training the deep learning model. FIG. 9 shows age classification with a varied of ages, in accordance with embodiments of the present disclosure. 3-class models, 6-class models, and 8-class models may be employed with cell ages varying from about 3 to 24 months. FIG. 10 shows measurements of biological age of primary cells from different tissues, in accordance with embodiments of the present disclosure. 3-class models may be employed on dFBs and LSECs. The deep learning model and machine learning-based classifier may be able to validate the measured biological age of the cells with the chronological age of the mice.

In some embodiments, the machine learning-based classifier may be configured to classify the plurality of enhanced cell images at an accuracy of at least 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 996%, 97%, 98%, 99% or more. The machine learning-based classifier may be configured to classify the plurality of enhanced cell images at an accuracy of at most 99%, 98%, 97% 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50% or less. The machine learning-based classifier may be configured to classify the plurality of enhanced cell images at an accuracy from about 50% to 99%, 50% to 95%, 50% to 90%, 50% to 85%, 50% to 80%, 50% to 75%, 50% to 70%, 50% to 65%, 50% to 60%, 50% to 55%, 60% to 99%, 60% to 95%, 60% to 90%, 60% to 85%, 60% to 80%, 60% to 75%, 60% to 70%, 60% to 65%, 66% to 99%, 66% to 95%, 66% to 90%, 66% to 85%, 66% to 80%, 66% to 75%, 66% to 70%, 70% to 99%, 70% to 95%, 70% to 90%, 70% to 85%, 70% to 80%, 70% to 75%, 75% to 99%, 75% to 95%, 75% to 90%, 75% to 85%, 75% to 80%, 80% to 99%, 80% to 95%, 80% to 90%, 80% to 85%, 85% to 99%, 85% to 95%, 85% to 90%, 90% to 99%, 90% to 95%, or 59% to 99%.

In some embodiments, the machine learning-based classifier may utilize a reconstructed phase image to extract features (e.g., morphological cell changes, age-dependent phenotypes as described elsewhere herein). The features may pertain to the entire cell. The features may pertain to the nucleus of the cell. The features may pertain to the sub-nucleus.

In some cases, the machine learning-based classifier may need to extract and draw relationships between features as conventional statistical techniques may not be sufficient. In some cases, machine learning algorithms may be used in conjunction with conventional statistical techniques. In some cases, conventional statistical techniques may provide the machine learning algorithm with preprocessed features. In some embodiments, the features may be classified into any number of categories.

In some embodiments, the machine learning-based classifier may prioritize certain features. The machine learning algorithm may prioritize features that may be more relevant for age-dependent phenotypes and/or morphological changes. The feature may be more relevant for detecting age-dependent phenotypes and/or morphological changes if the feature is classified more often than another feature. In some cases, the features may be prioritized using a weighting system. In some cases, the features may be prioritized on probability statistics based on the frequency and/or quantity of occurrence of the feature. The machine learning algorithm may prioritize features with the aid of a human and/or computer system.

In some cases, the machine learning-based classifier may prioritize certain features to reduce calculation costs, save processing power, save processing time, increase reliability, or decrease random access memory usage, etc.

In some embodiments, any number of features may be classified by the machine learning-based classifier. The machine learning-based classifier may classify at least about 3, 4, 5, 6, 7, 8, 9, 10, 15, 20, 25, 50, 100, 500, 1000, 10000 or more features. In some cases, the plurality of features may include between about 3 features to 10000 features. In some cases, the plurality of features may include between about 10 features to 1000 features. In some cases, the plurality of features may include between about 50 features to 500 features.

In some embodiments, the machine learning algorithm may prioritize certain features. The machine learning algorithm may prioritize features that may be more relevant for determining the biological age of one or more cells. The feature may be more relevant for determining the biological age of one or more cells if the feature is classified more often than another feature. In some cases, the features may be prioritized using a weighting system. In some cases, the features may be prioritized on probability statistics based on the frequency and/or quantity of occurrence of the feature. The machine learning algorithm may prioritize features with the aid of a human and/or computer system. In some embodiments, one or more of the features may be used with machine learning or conventional statistical techniques to determine if a segment is likely to contain artifacts.

In some cases, the machine learning algorithm may prioritize certain features to reduce calculation costs, save processing power, save processing time, increase reliability, or decrease random access memory usage, etc.

In some embodiments, processing the plurality of images of the plurality of cells may further comprise at least one of the following: size filtering, background subtraction, elimination of imaging artifacts, cropping, magnification, resizing, rescaling, and color, contrast, brightness adjustment, or object segmentation. Examples of such processing are described elsewhere herein.

In another aspect, the disclosure provides a non-transitory computer readable-medium comprising machine-executable instructions that, upon execution by one or more processors, implements a method for cell age classification. The method may comprise processing a plurality of images of a plurality of cells to generate a plurality of enhanced cell images as described elsewhere herein. In some embodiments, the method may further comprise a machine learning-based classifier to classify the plurality of enhanced cell images according to a biological age of each of the plurality of cells as described elsewhere herein.

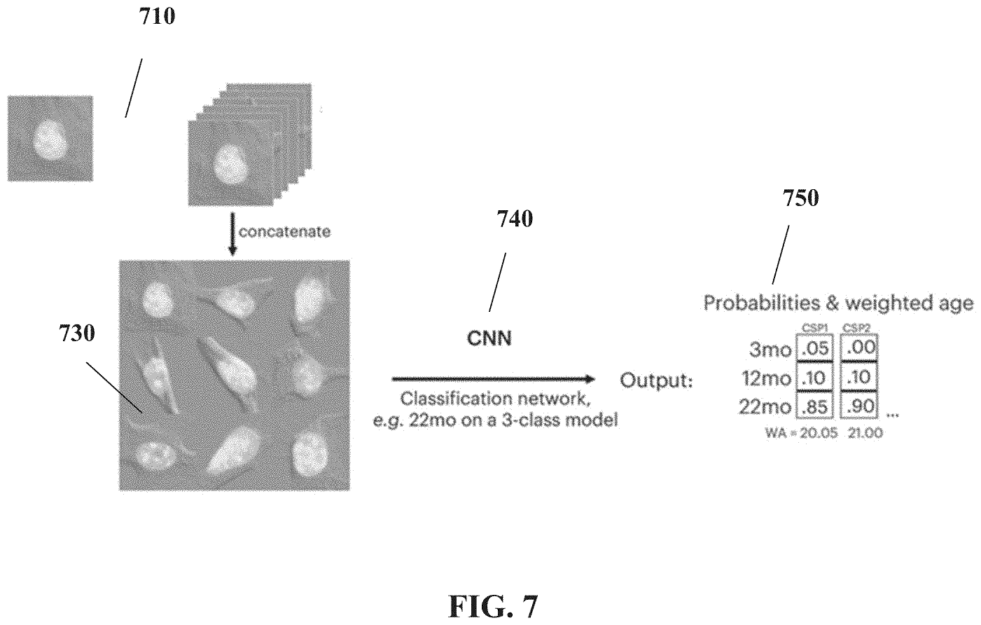

In another aspect, the present disclosure provides a method of improving cell age classification. In some embodiments, the method comprises concatenating a plurality of enhanced cell images into an image array. FIG. 7 shows concatenated enhanced cell images that may increase accuracy of age classification, in accordance with embodiments of the present disclosure. The enhanced images 710 are concatenated to form concatenated enhanced images 730. These concatenated enhanced cell images may be supplied to a convolutional neural network 740 (CNN), like ResNet18, and may output 750 the probabilities and weighted age of a plurality of cells from the concatenated enhanced images. The concatenated enhanced cell images may be supplied to the neural network as a single data point. The concatenated enhanced cell images may also reduce the computational time when analyzing a defined number of cells. For example, in an analysis of 1 million cells, 1 million cells may generate, for example, ˜20,000 7×7 concatenated enhanced cell images (i.e., concatenated smart patches), ˜40,000 5×5 concatenated enhanced cell images, or 111,000 3×3 concatenated enhanced cell images. As a result, the computational time to analyze 1 million cells is less when the data is structured as 7×7 concatenated enhanced cell images instead of 5×5 or 3×3.

The method may concatenate at least about 2 images, 3, images, 4 images, 5 images, 6 images, 7 images, 8 images, 9 images, 10 images, 11 images, 12 images, 13 images, 14 images, 15 images, 16 images, 17 images, 18 images, 19 images, 20 images, 21 images, 22 images, 23 images, 24 images, 25 images, 26 images, 27 images, 28 images, 29 images, 30 images, 35 images, 40 images, 50 images, 60 images, 70 images, 80 images, 90 images, 100 images, 110 images, 120 images, 130 images, 140 images, 150 images, 200 images, 300 images, 400 images, 500 images, 1000 images, 2000 images, 3000 images, 4000 images, 5000 images, 6000 images, 7000 images, 8000 images, 9000 images, 10000 images, 11000 images, 12000 images, 13000 images, 14000 images, 15000 images, 16000 images, 17000 images, 18000 images, 19000 images, 20000 images, 25000 images, 30000 images, 40000 images, 50000 images, 60000 images, 70000 images, 80000 images, 90000 images, 100000 images, 1000000 images, 10000000 images, 100000000 images, 1000000000 images, 10000000000 images or more. The method may concatenate at most about 10000000000 images, 1000000000 images, 100000000 images, 10000000 images, 1000000 images, 100000 images, 90000 images, 80000 images, 70000 images, 60000 images, 50000 images, 40000 images, 30000 images, 25000 images, 20000 images, 19000 images, 18000 images, 17000 images, 16000 images, 15000 images, 14000 images, 13000 images, 12000 images, 11000 images, 10000 images, 9000 images, 8000 images, 7000 images, 6000 images, 5000 images, 3000 images, 2000 images, 1000 images, 500 images, 400 images, 300 images, 200 images, 150 images, 100 images, 90 images, 80 images, 70 images, 60 images, 50 images, 40 images, 35 images, 30 images, 29 images, 28 images, 27 images, 26 images, 25 images, 24 images, 23 images, 22 images, 21 images, 20 images, 19 images, 18 images, 17 images, 16 images, 15 images, 14 images, 13 images, 12 images, 11 images, 10 images, 9 images, 8 images, 7 images, 6 images, 5 images, 4 images, 3 images, 2 images or less. The method may concatenate from about 2 images to 10000000000 images, 10 images to 100000000 images, 500 images to 1000000 images, 5000 images to 100000 images, 10000 images to 50000 images, 10000 images to 30000 images, or 10000 images to 20000 images, 2 to 200, 2 to 100, 2 to 50, 2 to 25, 2 to 20, 2 to 15, 2 to 10, 2 to 9, 2 to 8, 2 to 7, 2 to 6, 2 to 5, 2 to 4, 2 to 3, 3 to 200, 3 to 100, 3 to 50, 3 to 25, 3 to 20, 3 to 15, 3 to 10, 3 to 9, 3 to 8, 3 to 7, 3 to 6, 3 to 5, 3 to 4, 5 to 200, 5 to 100, 5 to 50, 5 to 25, 5 to 20, 5 to 15, 5 to 10, 5 to 9, 5 to 8, 5 to 7, 5 to 6, 10 to 200, 10 to 100, 10 to 50, 10 to 25, 10 to 20, 10 to 15, 10 to 14, 10 to 13, 10 to 12, or 10 to 11.

In some embodiments, concatenating a plurality of enhanced cell images (e.g., smart patches) may be random, not random, or a combination of random and not random. In some embodiments, the concatenation of a plurality of enhanced cell images may be random. In some embodiments, randomly orientating the smart patches during the generation of the concatenated image may remove potential biases and/or artifacts in the training of a neural network. For example, the phase contrast images may have an apparent feature (e.g., a shadow) that may create bias and/or be an artifact in the training of the neural network. Randomly orientating the smart patches may reduce the potential bias of the shadow during the training of the neural network. The plurality of enhanced cell images may be concatenated into an image array as described elsewhere herein. The plurality of enhanced cell images may be from different experiments or the same experiment as described elsewhere herein.

The plurality of enhanced cell images may be associated with a plurality of cells of a same or similar biological age as described elsewhere herein. In some embodiments, the method may use the machine learning-based classifier to determine an age group of the plurality of cells as described elsewhere herein.

In some embodiments, the method may provide the image array as a data point into a machine learning-based classifier. The image array may comprise a square array of the plurality of enhanced cell images. The square array may comprise an n by n array of the enhanced cell images. In some embodiments, the image array may comprise a rectangular array of the plurality of enhanced cell images. The rectangular array may comprise an m by n array of the enhanced cell images. In some embodiments, m and n may be different integers. In some cases, n or m may be at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 3000, 4000, 5000, 6000, 7000, 8000, 9000, 10000, 12500, 15000, 20000, 30000, 40000, 50000, 100000, 10000000, 100000000, 1000000000, 10000000000, 100000000000, or more. In some cases, n or m may be at most about 100000000000, 10000000000, 1000000000, 100000000, 10000000, 100000, 50000, 40000, 30000, 20000, 15000, 12500, 10000, 9000, 8000, 7000, 6000, 5000, 4000, 3000, 2000, 1900, 1800, 1700, 1600, 1500, 1400, 1300, 1200, 1100, 1000, 950, 900, 850, 800, 750, 700, 650, 600, 550, 500, 450, 400, 350, 300, 250, 200, 180, 160, 140, 120, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, or less. In some cases, n or m may be from about 1 to 100000000000, 1 to 10000000, 1 to 100000, 1 to 1000, 1 to 500, 1 to 250, 1 to 200, 1 to 150, 1 to 100, 1 to 50, 1 to 25, 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 5 to 100000000000, 5 to 10000000, 5 to 100000, 5 to 1000, 5 to 500, 5 to 250, 5 to 200, 5 to 150, 5 to 100, 5 to 50, 5 to 25, 5 to 20, 5 to 19, 5 to 18, 5 to 17, 5 to 16, 5 to 15, 5 to 14, 5 to 13, 5 to 12, 5 to 11, 5 to 10, 5 to 9, 5 to 8, 5 to 7, 5 to 6, 10 to 100000000000, 10 to 10000000, 10 to 100000, 10 to 1000, 10 to 500, 10 to 250, 10 to 200, 10 to 150, 10 to 100, 10 to 50, 10 to 25, 10 to 20, 10 to 19, 10 to 18, 10 to 17, 10 to 16, 10 to 15, 10 to 14, 10 to 13, 10 to 12, 10 to 11, 100 to 100000000000, 100 to 10000000, 100 to 100000, 100 to 1000, 100 to 500, 100 to 250, 100 to 200, 100 to 150, 150 to 100000000000, 150 to 10000000, 150 to 100000, 150 to 1000, 150 to 500, 150 to 250, or 150 to 200.

In some cases, a concatenated enhanced cell image may have dimensions of q by l by r where q and l as described elsewhere herein and r may be at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 3000, 4000, 5000, 6000, 7000, 8000, 9000, 10000, 12500, 15000, 20000, 30000, 40000, 50000, 100000, 10000000, 100000000, 1000000000, 10000000000, 100000000000, or more. In some cases, r may be at most about 100000000000, 10000000000, 1000000000, 100000000, 10000000, 100000, 50000, 40000, 30000, 20000, 15000, 12500, 10000, 9000, 8000, 7000, 6000, 5000, 4000, 3000, 2000, 1900, 1800, 1700, 1600, 1500, 1400, 1300, 1200, 1100, 1000, 950, 900, 850, 800, 750, 700, 650, 600, 550, 500, 450, 400, 350, 300, 250, 200, 180, 160, 140, 120, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, or less. In some cases, r may be from about 1 to 100000000000, 1 to 10000000, 1 to 100000, 1 to 1000, 1 to 500, 1 to 250, 1 to 200, 1 to 150, 1 to 100, 1 to 50, 1 to 25, 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 5 to 100000000000, 5 to 10000000, 5 to 100000, 5 to 1000, 5 to 500, 5 to 250, 5 to 200, 5 to 150, 5 to 100, 5 to 50, 5 to 25, 5 to 20, 5 to 19, 5 to 18, 5 to 17, 5 to 16, 5 to 15, 5 to 14, 5 to 13, 5 to 12, 5 to 11, 5 to 10, 5 to 9, 5 to 8, 5 to 7, 5 to 6, 10 to 100000000000, 10 to 10000000, 10 to 100000, 10 to 1000, 10 to 500, 10 to 250, 10 to 200, 10 to 150, 10 to 100, 10 to 50, 10 to 25, 10 to 20, 10 to 19, 10 to 18, 10 to 17, 10 to 16, 10 to 15, 10 to 14, 10 to 13, 10 to 12, 10 to 11, 100 to 100000000000, 100 to 10000000, 100 to 100000, 100 to 1000, 100 to 500, 100 to 250, 100 to 200, 100 to 150, 150 to 100000000000, 150 to 10000000, 150 to 100000, 150 to 1000, 150 to 500, 150 to 250, or 150 to 200.

In some embodiments, the method may provide the image array as the data point into the machine learning-based classifier to enhance accuracy in determining the age group of the plurality of cells. The machine learning-based classifier may enhance accuracy of at least 1%, 5%, 10%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 996%, 97%, 98%, 99% or more. The machine learning-based classifier may be configured to classify the plurality of enhanced cell images at an accuracy of at 99%, 98%, 97% 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 10%, 5%, 1% or less. The machine learning-based classifier may enhance accuracy from about 1% to 99%, 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 10%, 1% to 5%, 5% to 99%, 5% to 95%, 5% to 90%, 5% to 85%, 5% to 80%, 5% to 75%, 5% to 70%, 5% to 65%, 5% to 60%, 5% to 55%, 5% to 50%, 5% to 45%, 5% to 40%, 5% to 35%, 5% to 30%, 5% to 25%, 5% to 20%, 5% to 10%, 10% to 99%, 10% to 95%, 10% to 90%, 10% to 85%, 10% to 80%, 10% to 75%, 10% to 70%, 10% to 65%, 10% to 60%, 10% to 55%, 10% to 50%, 10% to 45%, 10% to 40%, 10% to 35%, 10% to 30%, 10% to 25%, 10% to 20%, 5% to 10%, 20% to 99%, 20% to 95%, 20% to 90%, 20% to 85%, 20% to 80%, 20% to 75%, 20% to 70%, 20% to 65%, 20% to 60%, 20% to 55%, 20% to 50%, 20% to 45%, 20% to 40%, 20% to 35%, 20% to 30%, 20% to 25%, 30% to 99%, 30% to 95%, 30% to 90%, 30% to 85%, 30% to 80%, 30% to 75%, 30% to 70%, 30% to 65%, 30% to 60%, 30% to 55%, 30% to 50%, 30% to 45%, 30% to 40%, 30% to 35%, 50% to 99%, 50% to 95%, 50% to 90%, 50% to 85%, 50% to 80%, 50% to 75%, 50% to 70%, 50% to 65%, 50% to 60%, 50% to 55%, 60% to 99%, 60% to 95%, 60% to 90%, 60% to 85%, 60% to 80%, 60% to 75%, 60% to 70%, 60% to 65%, 66% to 99%, 66% to 95%, 66% to 90%, 66% to 85%, 66% to 80%, 66% to 75%, 66% to 70%, 70% to 99%, 70% to 95%, 70% to 90%, 70% to 85%, 70% to 80%, 70% to 75%, 75% to 99%, 75% to 95%, 75% to 90%, 75% to 85%, 75% to 80%, 80% to 99%, 80% to 95%, 80% to 90%, 80% to 85%, 85% to 99%, 85% to 95%, 85% to 90%, 90% to 99%, 90% to 95%, or 59% to 99%.

In some embodiments, the plurality of enhanced cell images may be pooled from a plurality of different test wells or samples to reduce or eliminate well-to-well variability. The plurality of enhanced cell images be of a well plate that may have at least about 1 well, 2 wells, 4 wells, 8 wells, 16 wells, 24 wells, 32 wells, 40 wells, 48 wells, 56 wells, 64 wells, 72 wells, 80 wells, 88 wells, 96 wells, 100 wells, 384 wells, 1536 wells, or more. The plurality of enhanced cell images may be of a well plate that may have at most about 1536 wells, 384 wells, 100 wells, 96 wells, 88 wells, 80 wells, 72 wells, 64 wells, 56 wells, 48 wells, 40 wells, 32 wells, 24 wells, 16 wells, 8 wells, 4 wells, 2 wells, or less. The plurality of enhanced cell images may be of a well plate that may be from about 1 well to 1536 wells, 8 wells to 384 wells, or 24 wells to 96 wells.

The plurality of samples may be at least about 1 sample, 2 samples, 4 samples, 8 samples, 16 samples, 24 samples, 32 samples, 40 samples, 48 samples, 56 samples, 64 samples, 72 samples, 80 samples, 88 samples, 96 samples, 100 samples, 384 samples, 1536 samples, or more. The plurality of samples may be at most about 1536 samples, 384 samples, 100 samples, 96 samples, 88 samples, 80 samples, 72 samples, 64 samples, 56 samples, 48 samples, 40 samples, 32 samples, 24 samples, 16 samples, 8 samples, 4 samples, 2 samples, or less. The plurality of samples may from about 1 sample to 1536 samples, 8 samples to 384 samples, or 24 samples to 96 samples.

In some embodiments, the machine learning-based classifier may be configured to determine the age group of the plurality of cells using a multi-class classification model as described elsewhere herein. The multi-class classification model may comprise a plurality of cell age groups as described elsewhere herein. The plurality of cell age groups may comprise at different cell age groups as described elsewhere herein. The at least three different cell age groups may be spaced apart by an interval as described elsewhere herein.

The machine learning-based classifier may be configured to determine a probability of the plurality of cells being classified within each of the plurality of cell age groups. The machine learning-based classifier may be configured to determine the age group of the plurality of cells by weighing the probabilities of the plurality of cells across the plurality of cell age groups.

In some embodiments, the machine learning-based classifier comprises a deep neural network. Examples of deep neural networks are described elsewhere herein. The deep neural network may comprise a convolutional neural network (CNN). Examples of CNNs are described elsewhere herein. In some embodiments, the machine learning-based classifier may comprise a regression-based learning algorithm, linear or non-linear algorithms, feed-forward neural network, generative adversarial network (GAN), or deep residual networks. More examples of classifiers are described elsewhere herein. In some embodiments, the machine learning-based classifier may have a variety of parameters as described elsewhere herein.

In some embodiments, each of the plurality of enhanced cell images may comprise at least (1) a first image region focusing on a nucleus of the cell, and optionally (2) a second image region focusing on a general region of the cell. The general region of the cell may comprise a cytoplasm of the cell. Other regions of the cell may be as described elsewhere herein.

In another aspect, the present disclosure provides a non-transitory computer readable-medium comprising machine-executable instructions that, upon execution by one or more processors, implements a method for improving cell age classification. The method may comprise concatenating a plurality of enhanced cell images into an image array as described elsewhere herein. In some embodiments, the plurality of enhanced cell images may be associated with a plurality of cells having a same or similar age group as described elsewhere herein. In some embodiments, the method may provide the image array as a data point into a machine learning-based classifier as described elsewhere herein. In some embodiments, the method may use the machine learning-based classifier to determine the age group of the plurality of cells as described elsewhere herein.

### IV. Therapeutics and Drug Discovery

In an aspect, the present disclosure provides a method for drug screening. The method may comprise contacting one or more cells of a known chronological age with one or more drug candidates. In some cases, the method may comprise contacting one or more cells of a disease or disorder state with one or more drug candidates. In some cases, the disease or disorder state may be known or unknown. The cells may include any type of cells as described elsewhere herein. The one or more drug candidates may be used to research the effects on aging as described elsewhere herein. A known chronological age of the one or more cells may be defined as the amount of time the one or more cells has been alive.

In some embodiments, the one or more cells may comprise a plurality of cells of different chronological ages. The different chronological ages may be on an order ranging from days, weeks, months, or years. In some cases, the chronological age may be at least about 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, 12 months, 13 months, 14 months, 15 months, 16 months, 17 months, 18 months, 19 months, 20 months, 21 months 22 months, 23 months, 24 months, 25 months, 26 months, 27 months, 28 months, 29 months 30 months, 31 months, 32 months, 33 months, 34 months, 35 months, 3 years, 4 years, 5 years, 6 years, 7 years, 8 years, 9 years, 10 years, 15 years, 20 years, 25 years, 30 years, 35 years, 40 years, 45 years, 50 years, 55 years, 60 years, 65 years, 70 years, 75 years, 80 years, 85 years, 90 years, 95 years, 100 years, 105 years, 110 years, 115 years, or more. In some cases, the chronological age may be at most about 115 years, 110 years, 105 years, 100 years, 95 years, 90 years, 85 years, 80 years, 75 years, 70 years, 65 years, 60 years, 55 years, 50 years, 45 years, 40 years, 35 years, 30 years, 25 years, 20 years, 15 years, 10 years, 5 years, 4 years, 3 years, 35 months, 34 months, 33 months, 32 months, 31 months, 30 months, 29 months, 28 months, 27 months, 26 months, 25 months, 24 months, 23 months, 22 months, 21 months, 20 months, 19 months, 18 months, 17 months, 16 months, 15 months, 14 months, 13 months, 12 months, 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, or less. In some cases, the chronological age may be from about 1 day to 115 years, 1 week to 50 years, 2 weeks to 7 years, 3 weeks to 7 years, 5 weeks to 7 years, 6 weeks to 7 years, 7 weeks to 7 years, 8 weeks to 7 years, 9 weeks to 7 years, 10 weeks to 7 years, 11 weeks to 7 years, 12 weeks to 7 years, 13 weeks to 7 years, 14 weeks to 7 years, 15 weeks to 7 years, 16 weeks to 7 years, 17 weeks to 7 years, 18 weeks to 7 years, 19 weeks to 7 years, 20 weeks to 7 years, 21 weeks to 7 years, 22 weeks to 7 years, 23 weeks to 7 years, 24 weeks to 7 years, 25 weeks to 7 years, 26 weeks to 7 years, 27 weeks to 7 years, 28 weeks to 7 weeks, 29 weeks to 7 years, 29 weeks to 7 years, 30 weeks to 7 years, 31 weeks to 7 years, 32 weeks to 7 years, 33 weeks to 7 years, 34 weeks to 7 years, 35 weeks to 7 years, 36 weeks to 7 years, 37 weeks to 7 years, 38 weeks to 7 years, 39 weeks to 7 years, 40 weeks to 7 years, 41 weeks to 7 years, 42 weeks to 7 years, 43 weeks to 7 years, 44 weeks to 7 years, 45 weeks to 7 years, 46 weeks to 7 years, 47 weeks to 7 years, 48 weeks to 7 years, 49 weeks to 7 years, 50 weeks to 7 years, 51 weeks to 7 years, 52 weeks to 7 years, 1 year to 7 years, 2 years to 7 years, 3 years to 7 years, 4 years to 7 years, 5 years to 7 years, or 6 years to 7 years.

In some embodiments, the one or more cells may comprise epithelial cells, neurons, fibroblast cells, stem or progenitor cells, endothelial cells, muscle cells, astrocytes, vascular smooth muscle cells, vascular endothelial cells, cardiomyocytes, glial cells, blood cells, contractile cells, secretory cells, adipocytes, or hepatocytes, etc. The cell morphology may comprise the cell shape, size, arrangement, form, or structure, etc. The cell function may comprise providing structure, provide support, facilitate growth, allow passive transport, allow active transport, produce energy, create metabolic reactions, aid in reproduction, transport nutrients, specialized functions, etc.

In some embodiments, the method may also comprise obtaining one or more images of the one or more cells at a time after the cells have been contacted with the one or more drug candidates. The images of the one or more cells may be obtained with a microscope. The microscopy used to image a cell, may be, for example, light microscopy, fluorescence microscopy, confocal microscopy, or other advance techniques. Light microscopy may be, for example, bright field microscopy, dark field microscopy, phase contrast microscopy, or differential interference contrast (DIC) microscopy, etc. Fluorescence microscopy may be, for example, widefield microscopy, etc. Confocal microscopy may be, for example, laser-scan confocal, spinning disk, multiphoton microscopy, total reflection fluorescence microscopy, forster resonance energy transfer (FRET) microscopy, or fluorescence lifetime imaging microscopy, etc. Advanced techniques may be, for example, bioluminescence resonance energy transfer, fluorescence recovery after photo-bleaching, fluorescence correlation spectroscopy, single particle tracking, SPT photoactivated localization microscopy, or light sheet microscopy, etc. The one or more images may be modified, augmented, enhanced, etc. as described elsewhere herein.

The one or more images may be obtained at a predefined point in time after the cells have been contacted with the one or more drug candidates. The predefined point in time may range from seconds, minutes, hours, days, or weeks, etc. In some cases, the predefined point in time may be at least about 1 second, 10 seconds, 20 seconds, 30 seconds, 40 seconds, 50 seconds, 1 minute (min), 2 min, 3 min, 4 min, 5 min, 6 min, 7 min, 8 min, 9 min, 10 min, 20 min, 30 min, 40 min, 50 min, 1 hour (hr), 2 hrs, 3 hrs, 4 hrs, 5 hrs, 6 hrs, 7 hrs, 8 hrs, 9 hrs, 10 hrs, 11 hrs, 12 hrs, 13 hrs, 14 hrs, 15 hrs, 16 hrs, 17 hrs, 18 hrs, 19 hrs, 20 hrs, 21 hrs, 22 hrs, 23 hrs, 24 hrs, 1 day, 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, or more. In some cases, the predefined point in time may be at most about 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, 1 day, 24 hrs, 23 hrs, 22 hrs, 21 hrs, 20 hrs, 19 hrs, 18 hrs, 17 hrs, 16 hrs, 15 hrs, 14 hrs, 13 hrs, 12 hrs, 11 hrs, 10 hrs, 9 hrs, 8 hrs, 7 hrs, 6 hrs, 5 hrs, 4 hrs, 3 hrs, 2 hrs, 1 hr, 50 min, 40 min, 30 min, 20 min, 10 min, 9 min, 8 min, 7 min, 6 min, 5 min, 4 min, 3 min, 2 min, 1 min, 50 seconds, 40 seconds, 30 seconds, 20 seconds, 10 seconds, or less. In some cases, the predefined point in time may be from about 1 second to 52 weeks, 1 second to 26 weeks, 1 second to 13 weeks, 1 second to 6 weeks, 1 second to 1 week, 1 second to 3 days, 1 second to 1 day, 1 second to 23 hrs, 1 second to 12 hrs, 1 second to 6 hrs, 1 second to 1 hr, 1 second to 30 minutes, 1 second to 10 minutes, 1 second to 1 minute, 1 second to 30 seconds, 1 second to 15 seconds, 1 second to 10 seconds, 1 second to 5 seconds, 1 min to 52 weeks, 1 min to 26 weeks, 1 min to 13 weeks, 1 min to 6 weeks, 1 min to 1 week, 1 min to 3 days, 1 min to 1 day, 1 min to 23 hrs, 1 min to 12 hrs, 1 min to 6 hrs, 1 min to 1 hr, 1 min to 30 minutes, 1 min to 10 minutes, 60 min to 52 weeks, 60 min to 26 weeks, 60 min to 13 weeks, 60 min to 6 weeks, 60 min to 1 week, 60 min to 3 days, 60 min to 1 day, 60 min to 23 hrs, 60 min to 12 hrs, 60 min to 6 hrs, 60 min to 2 hr, 3 hours to 52 weeks, 3 hours to 26 weeks, 3 hours to 13 weeks, 3 hours to 6 weeks, 3 hours to 1 week, 3 hours to 3 days, 3 hours to 1 day, 3 hours to 23 hrs, 3 hours to 12 hrs, 3 hours to 6 hrs, 24 hours to 52 weeks, 24 hours to 26 weeks, 24 hours to 13 weeks, 24 hours to 6 weeks, 24 hours to 1 week, 24 hours to 3 days, 1 week to 52 weeks, 1 week to 26 weeks, 1 week to 13 weeks, or 1 week to 6 weeks.

In some embodiments, the method may further comprise comparing the biological age of the one or more cells with the known chronological age, to determine if the one or more drug candidates have an effect on the cell morphology or function as described elsewhere herein. In some cases, the drug candidate(s) may comprise one or more therapeutic candidates that are designed to modify one or more age-dependent phenotypes. The drug candidates may comprise small molecules, GRAS molecules, FDA/EMA approved compounds, biologics, aptamers, viral particles, nucleic acids, peptide mimetics, peptides, monoclonal antibodies, proteins, fractions from cell-conditioned media, fractions from plasma, serum, or any combination thereof.

Accordingly, in those cases, the method may further comprise contacting each of the one or more cells with a different therapeutic candidate. Examples of age-dependent phenotypes (e.g., features) may include, but are not limited to, size of chromosomes, size of nucleus, size of cell, nuclear shape, nuclear and or cytoplasmic granularity, pixel intensity, texture, and nucleoli number and appearance, or subcellular structures including mitochondria, lysosomes, endomembranes, actin, cell membrane, microtubules, endoplasmic reticulum, or shape of cell, etc.

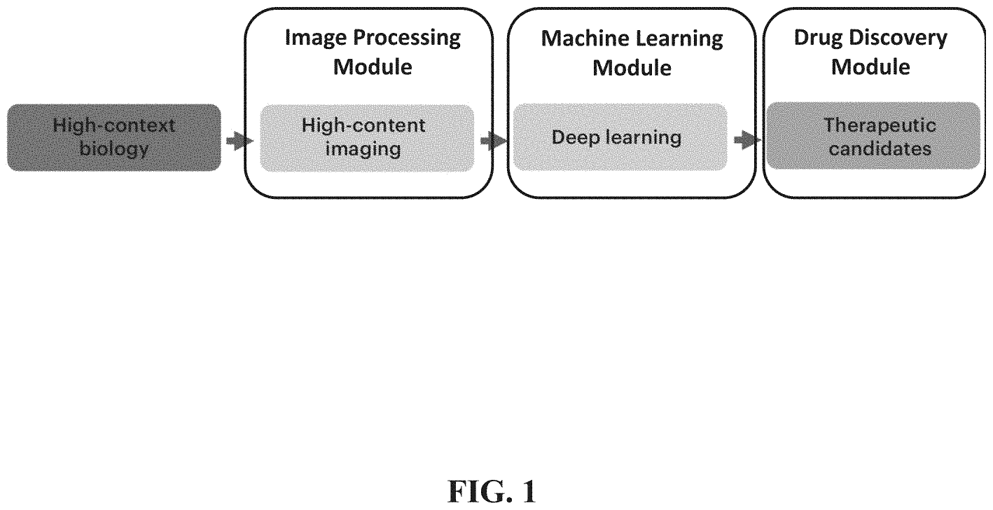

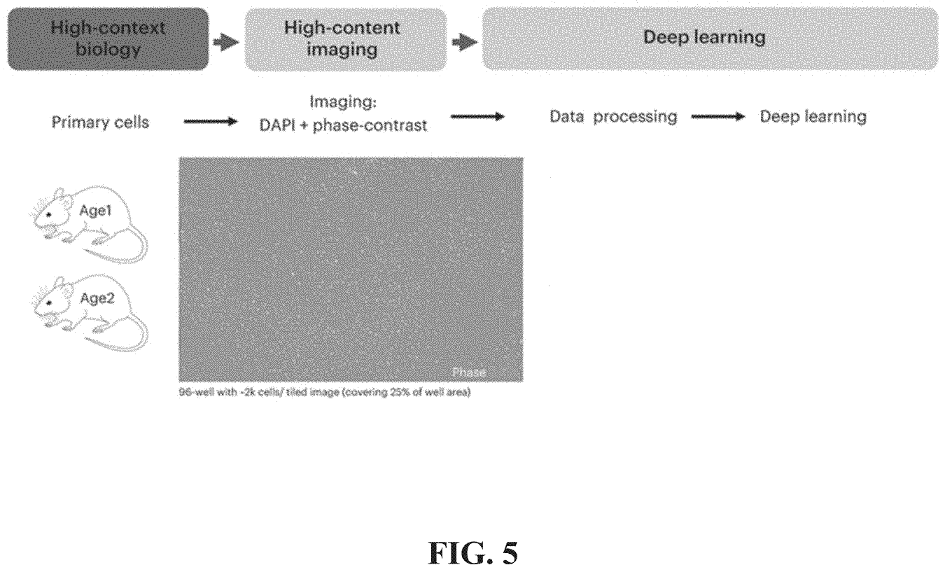

FIG. 1 and FIG. 5 shows the workflow of methods described herein that enables all steps from cell isolation to classification to therapeutic candidates via drug screening, in accordance with embodiments of the present disclosure. The plurality of cells may be obtained from mice of different ages. These cells may be stained with DAPI and a phase-contrast image (i.e. enhanced cell image) may be produced. From there, the images are processed and then supplied to a deep learning model as described elsewhere herein.

In some embodiments, the method may further comprise determining an extent or rate of accelerated aging if the one or more cells are determined to have undergone the accelerated aging, based on changes to the one or more age-dependent phenotypes. The changes may include, for example, nuclear size, shape, texture, or change in texture of peri-nuclear cytoplasm or of components of the cell present in the peri-nuclear cytoplasm, etc. The changes may be observable by, for example, computational analysis, microscopy, or described elsewhere herein, etc. In some embodiments, the method may further comprise determining an aging effect attributable to the one or more drug candidates that may be causing the accelerated aging. The aging effect may include a rate of aging, extent of aging, severity of aging, effects on cell morphology or function caused by the accelerated aging, shortened lifespan or cell viability, etc. The aging effect may include cells that appear to have a measured age that may be greater than their chronological age The extent of aging effect may be at least about 1 day, 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, 12 months, 13 months, 14 months, 15 months, 16 months, 17 months, 18 months, 19 months, 20 months, 21 months 22 months, 23 months, 24 months, 25 months, 26 months, 27 months, 28 months, 29 months 30 months, 31 months, 32 months, 33 months, 34 months, 35 months, 3 years, 4 years, 5 years, 6 years, 7 years, 8 years, 9 years, 10 years or more. The extent of accelerated aging may be at most 10 years, 5 years, 4 years, 3 years, 35 months, 34 months, 33 months, 32 months, 31 months, 30 months, 29 months, 28 months, 27 months, 26 months, 25 months, 24 months, 23 months, 22 months, 21 months, 20 months, 19 months, 18 months, 17 months, 16 months, 15 months, 14 months, 13 months, 12 months, 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, or less. The extent of accelerated aging may be from about 1 day to 10 years, 1 week to 5 years, 1 month to 2 years, 1 month to 24 months, 1 month to 23 months, 1 month to 22 months, 1 month to 21 months, 1 month to 20 months, 1 month to 19 months, 1 month to 18 months, 1 month to 17 months, 1 month to 16 months, 1 month to 15 months, 1 month to 14 months, 1 month to 13 months, 1 month to 12 months, 1 month to 11 months, 1 month to 10 months, 1 month to 9 months, 1 month to 8 months, 1 month to 7 months, 1 month to 6 months, 1 month to 5 months, 1 month to 4 months, 1 month to 3 months, 1 month to 2 months, 6 month to 2 years, 6 month to 24 months, 6 month to 23 months, 6 month to 22 months, 6 month to 21 months, 6 month to 20 months, 6 month to 19 months, 6 month to 18 months, 6 month to 17 months, 6 month to 16 months, 6 month to 15 months, 6 month to 14 months, 6 month to 13 months, 6 month to 12 months, 6 month to 11 months, 6 month to 10 months, 6 month to 9 months, 6 month to 8 months, 6 month to 7 months, 12 month to 2 years, 12 month to 24 months, 12 month to 23 months, 12 month to 22 months, 12 month to 21 months, 12 month to 20 months, 12 month to 19 months, 12 month to 18 months, 12 month to 17 months, 12 month to 16 months, 12 month to 15 months, 12 month to 14 months, or 12 month to 13 months.

In some embodiments, the method may further comprise determining an extent or rate of delay in natural aging if the one or more cells are determined to have experienced the delay in natural aging, based on changes to the one or more age-dependent phenotypes. The changes may as described elsewhere herein. The method may further comprise determining a rejuvenation effect attributable to the one or more drug candidates that may be causing the delay in natural aging. The rejuvenation effect may include a decrease rate of aging, extent of aging, decreased severity of aging, effects on cell morphology or function caused by the decreased aging, increased lifespan or cell viability, etc. The rejuvenation effect may comprise cells that appear to have a measured age that may be less than the chronological age of the cells. For example, the chronological age of a cell may be 6 months, after contact with one or more drug candidates, the age of the cell may appear to be 3 months, this may be a rejuvenation effect of 3 months. The extent of rejuvenation effect may be at least about 1 day, 1 day, 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 11 weeks, 12 weeks, 13 weeks, 14 weeks, 15 weeks, 16 weeks, 17 weeks, 18 weeks, 19 weeks, 20 weeks, 21 weeks, 22 weeks, 23 weeks, 24 weeks, 25 weeks, 26 weeks, 27 weeks, 28 weeks, 29 weeks, 30 weeks, 31 weeks, 32 weeks, 33 weeks, 34 weeks, 35 weeks, 36 weeks, 37 weeks, 38 weeks, 39 weeks, 40 weeks, 41 weeks, 42 weeks, 43 weeks, 44 weeks, 45 weeks, 46 weeks, 47 weeks, 48 weeks, 49 weeks, 50 weeks, 51 weeks, 52 weeks, 12 months, 13 months, 14 months, 15 months, 16 months, 17 months, 18 months, 19 months, 20 months, 21 months 22 months, 23 months, 24 months, 25 months, 26 months, 27 months, 28 months, 29 months 30 months, 31 months, 32 months, 33 months, 34 months, 35 months, 3 years, 4 years, 5 years, 6 years, 7 years, 8 years, 9 years, 10 years or more. The extent of delay in natural aging may be at most 10 years, 5 years, 4 years, 3 years, 35 months, 34 months, 33 months, 32 months, 31 months, 30 months, 29 months, 28 months, 27 months, 26 months, 25 months, 24 months, 23 months, 22 months, 21 months, 20 months, 19 months, 18 months, 17 months, 16 months, 15 months, 14 months, 13 months, 12 months, 52 weeks, 51 weeks, 50 weeks, 49 weeks, 48 weeks, 47 weeks, 46 weeks, 45 weeks, 44 weeks, 43 weeks, 42 weeks, 41 weeks, 40 weeks, 39 weeks, 38 weeks, 37 weeks, 36 weeks, 35 weeks, 34 weeks, 33 weeks, 32 weeks, 31 weeks, 30 weeks, 29 weeks, 28 weeks, 27 weeks, 26 weeks, 25 weeks, 24 weeks, 23 weeks, 22 weeks, 21 weeks, 20 weeks, 19 weeks, 18 weeks, 17 weeks, 16 weeks, 15 weeks, 14 weeks, 13 weeks, 12 weeks, 11 weeks, 10 weeks, 9 weeks, 8 weeks, 7 weeks, 6 weeks, 5 weeks, 4 weeks, 3 weeks, 2 weeks, 1 week, 6 days, 5 days, 4 days, 3 days, 2 days, or less. The extent of delay in natural aging may be from about 1 day to 10 years, 1 week to 5 years, 1 month to 2 years, 1 month to 24 months, 1 month to 23 months, 1 month to 22 months, 1 month to 21 months, 1 month to 20 months, 1 month to 19 months, 1 month to 18 months, 1 month to 17 months, 1 month to 16 months, 1 month to 15 months, 1 month to 14 months, 1 month to 13 months, 1 month to 12 months, 1 month to 11 months, 1 month to 10 months, 1 month to 9 months, 1 month to 8 months, 1 month to 7 months, 1 month to 6 months, 1 month to 5 months, 1 month to 4 months, 1 month to 3 months, 1 month to 2 months, 6 month to 2 years, 6 month to 24 months, 6 month to 23 months, 6 month to 22 months, 6 month to 21 months, 6 month to 20 months, 6 month to 19 months, 6 month to 18 months, 6 month to 17 months, 6 month to 16 months, 6 month to 15 months, 6 month to 14 months, 6 month to 13 months, 6 month to 12 months, 6 month to 11 months, 6 month to 10 months, 6 month to 9 months, 6 month to 8 months, 6 month to 7 months, 12 month to 2 years, 12 month to 24 months, 12 month to 23 months, 12 month to 22 months, 12 month to 21 months, 12 month to 20 months, 12 month to 19 months, 12 month to 18 months, 12 month to 17 months, 12 month to 16 months, 12 month to 15 months, 12 month to 14 months, or 12 month to 13 months.

The method for drug screening may further comprise contacting the one or more cells with one or more labels. The labels may comprise fluorophores or antibodies. The fluorophores may comprise (or may be selected from the group consisting of) 4′,6-diamidino-2-phenylindole (DAPI), fluorescein, 5-carboxyfluorescein, 2′7′-dimethoxy-4′5′-dichloro-6-carboxyfluorescein, rhodamine, 6-carboxyrhodamine (R6G), N,N,N′,N′-tetramethyl-6-carboxyrhodamine, 6-carboxy-X-rhodamine, 4-acetamido-4′-isothiocyanato-stilbene-2,2′ disulfonic acid, acridine, acridine isothiocyanate, 5-(2′-aminoethyl)amino-naphthalene1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide; anthranilamide, Brilliant Yellow, coumarin, 7-amino-4-methylcoumarin, 7-amino-4-trifluoromethylcoumarin, cyanosine, 5′,5″-dibromopyrogallol-sulfonephthalein (Bromopyrogallol Red), 7-diethylamino-3-(4′-isothiocyanatophenyl)-4-methylcoumarin, diethylenetraimine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-dimethylaminophenylazophenyl-4′-isothiocyanate (DABITC), eosin, eosin isothiocyanate, erythrosine, erythrosine B, erythrosine isothiocyanate, ethidium, dichlorotriazin-2-yl)aminofluorescein (DTAF), fluorescein, fluorescein isothiocyanate, QFITC (XRITC), fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene, pyrene butyrate, succinimidyl 1-pyrene butyrate, Reactive Red 4 (Cibacron Brilliant Red 3B-A), lissamine rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101, tetramethyl rhodamine, tetramethyl rhodamine isothiocyanate (TRITC), riboflavin, rosolic acid, terbium chelate derivatives, Hoescht 33342, Hoescht 33258, Hoescht 34580, Propidium iodine, and DRAQ5.

In some embodiments, the method may comprise contacting one or more cells of a known chronological age with one or more drug candidates. In some embodiments, the method may further comprise comparing the biological age of the one or more cells with the known chronological age, to determine if the one or more drug candidates have an effect on the cell morphology or function. The one or more drug candidates may be used to research the effects on aging as described elsewhere herein. In some cases, the drug candidate(s) may comprise one or more therapeutic candidates that are designed to modify one or more age-dependent phenotypes. The drug candidates may comprise small molecules, GRAS molecules, FDA/EMA approved compounds, biologics, aptamers, viral particles, nucleic acids, peptide mimetics, peptides, monoclonal antibodies, proteins, fractions from cell-conditioned media, fractions from plasma, serum, or any combination thereof.

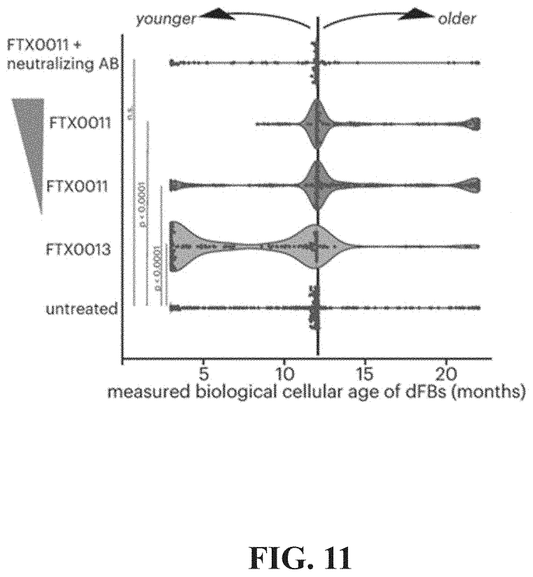

FIG. 11 shows measurements of change in biological age after treatment with drug candidates, in accordance with embodiments of the present disclosure. For example, the plurality of cells may be treated with peptides FTX0013 and FTX0011 and the biological age may be measured to view the effect on cell age. The plurality of cells that contacted with FTX0011 showed a subset of cells that were younger than the standard untreated plurality of cells. The plurality of cells that contacted with FTX0013 showed a subset of cells that were older and younger than the standard untreated plurality of cells. When the concentration of FTX0013 was increased, the plurality of cells had a subset of cells that were older than the than the standard untreated plurality of cells. When the plurality of cells was in the presence of a neutralizing antibody and FTX0011, the measured biological cell age was similar to the untreated plurality of cells.

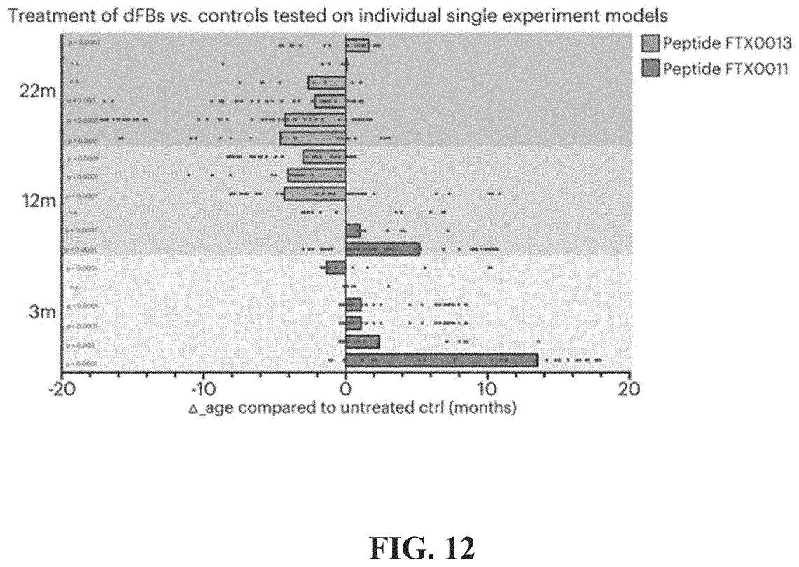

FIG. 12 shows measurements in change of biological age across experiments, in accordance with embodiments of the present disclosure. The plurality of cells (i.e. dFB cells) were compared to controls for single experiment age models. The plurality of cells may be contacted with a drug candidate (i.e peptide FTX0011) from 12 months, the measured age of the plurality of cells was generally greater than the control. When the plurality of cells were contacted with a drug candidate (i.e peptide FTX0013) from 12 months, the measured age of the plurality of cells was younger than the control. When the plurality of cells were contacted with a drug candidate (i.e peptide FTX0011) from 3 months, the measured age of the plurality of cells was greater than the control. When the plurality of cells were contacted with a drug candidate (i.e peptide FTX0013) from 22 months, the measured age of the plurality of cells was generally younger than the control.

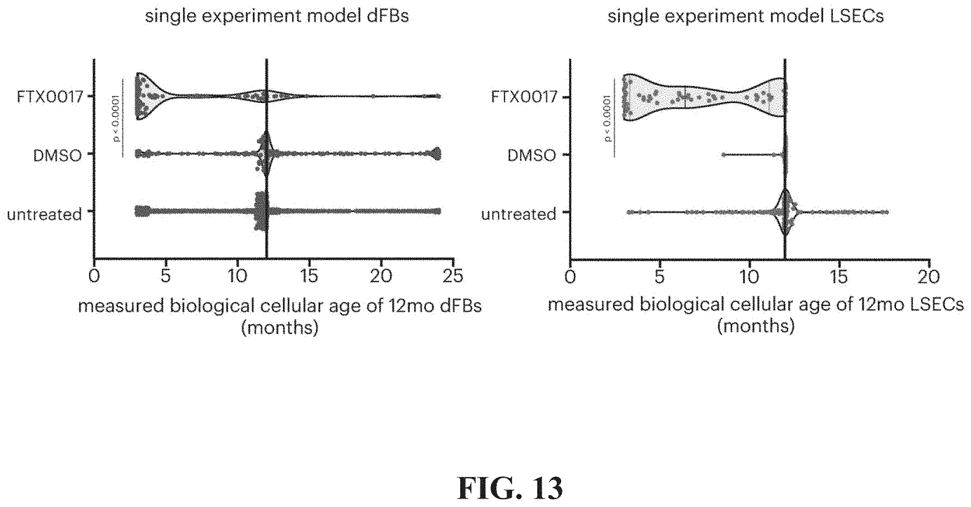

FIG. 13 shows treatment with small molecules FTX0017 exerts rejuvenating effect in two cell types, in accordance with embodiments of the present disclosure. The plurality of cells (e.g. dFB and LSCE) of 12 months were treated with a drug candidate (FTX0017). The measured age of the plurality of cells were younger than the untreated plurality of cells.

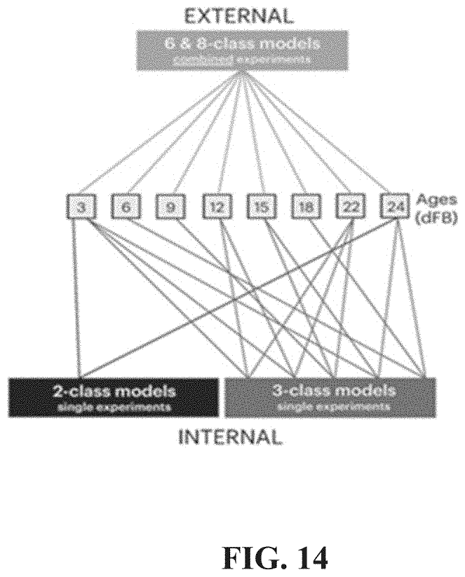

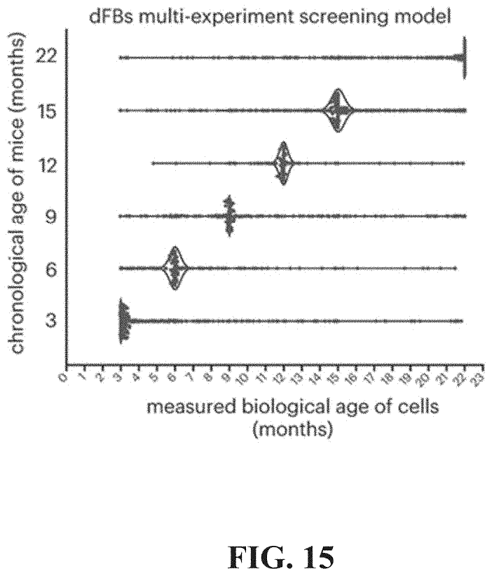

FIG. 14 shows applying methods as a drug discovery screening tool, in accordance with embodiments of the present disclosure. Experiments may be combined in order to develop larger class models from a variety of different ages. This may allow for increased throughput for drug discovery screening. FIG. 15 shows methods developed as a multi-class, multi-experiment model to encompass biological heterogeneity, in accordance with embodiments of the present disclosure. 13 combined experiments encompassing 33 mice of 6 different ages (3 months, 6 months, 9 months, 12 months, 15 months, 22 months) illustrated that the developed deep learning model classified measured biological age of the dFB cells as substantially similar to the chronological age of the mice.

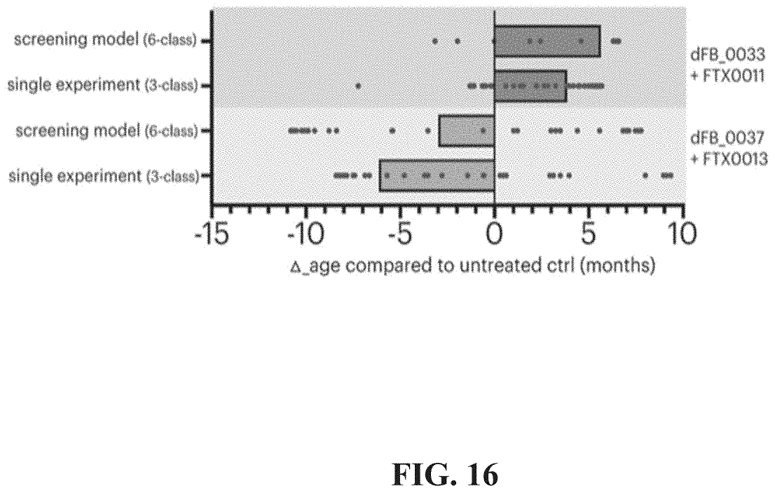

FIG. 16 shows methods as efficient screening tool, in accordance with embodiments of the present disclosure. In a multi-class model with 6 ages (i.e. 6-class model) from multiple experiments or 3 ages (i.e. 3-class model) from a single experiment, when dFB cells were treated with FTX0011, the plurality of cells showed an increase in age in comparison to untreated cells. In a multi-class model with 6 ages (i.e. 6-class model) from multiple experiments or 3 ages (i.e. 3-class model) from a single experiment, when dFB cells were treated with FTX0013, the plurality of cells showed decrease in age in comparison to untreated cells. These results may illustrate treatment effects remain consistent on external multi-class models.

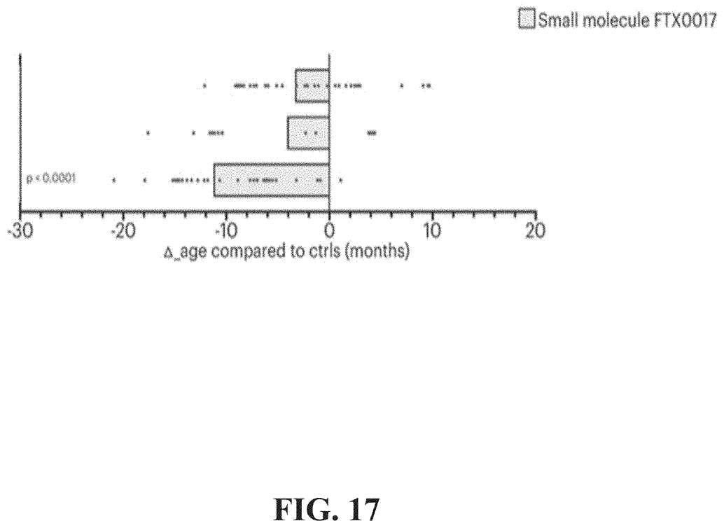

FIG. 17 shows treatment with small molecule FTX0017 in three independent experiments, in accordance with embodiments of the present disclosure. Experiments illustrated that the plurality of cells when treated with FTX0017, was measured to appear younger than the age of the control plurality of cells three independent experiments. As more data is obtained, the screening model may be refined further.

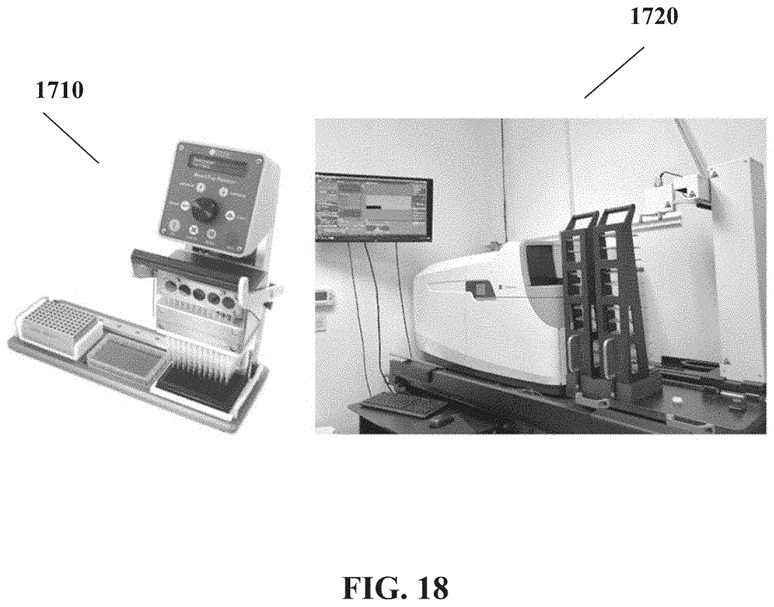

FIG. 18 shows set up for small molecule screening, in accordance with embodiments of the present disclosure. The samples may be prepared for high throughput screening to identify small molecules and biologics and their effects on assays as described elsewhere herein. The deep learning model and methods as described elsewhere herein may be coupled with a setup (1710) and microscope (1720).

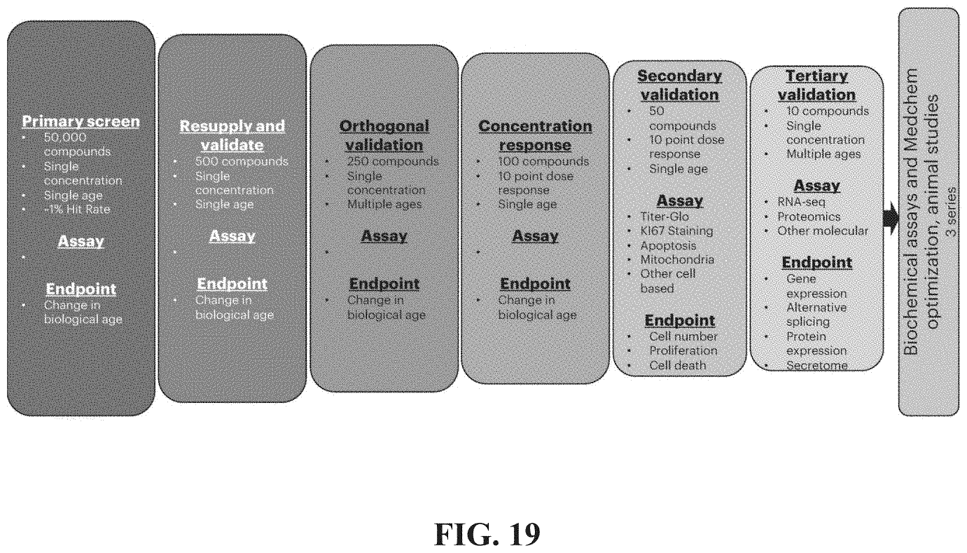

FIG. 19 shows screening funnel, in accordance with embodiments of the present disclosure. In the primary screen, 50000 or more drug candidates may be contacted with a plurality of cells of a single age and the change in biological age may be measured using the methods described elsewhere herein. From the set of compounds, a subset of compounds may be selected and the results validated. From the set or subset, a further subset of drug candidates may be selected. These drug candidates may then be contacted with a plurality of cells from multiple age groups and the change in biological age may be measured using the methods described elsewhere herein. A subset of these drug candidates may be selected, the concentration may be changed and contacted with a plurality of cells and the change in biological age may be measured using the methods described elsewhere herein. A subset of these drug candidates may then be selected and then validated. An assay may be performed with the drug candidates to determine concentration and/or potency of a substance by the effect on plurality of cells or tissues, for example, titer-glo, KI67 staining, apoptosis, mitochondria, and other cell-based assays. The assays may provide information regarding to the cell number, proliferation, and cell death. A subset of these drug candidates may be selected and revalidated across a plurality of cells with different age groups. The drug candidates may be contacted with an assay, for example, RNA-sequence, proteomics, and other molecular systems. The assays may provide information regarding to gene expression, alternative splicing, protein expression, or secretome, etc. These drug candidates may be further optimized and used for animal studies and human studies.

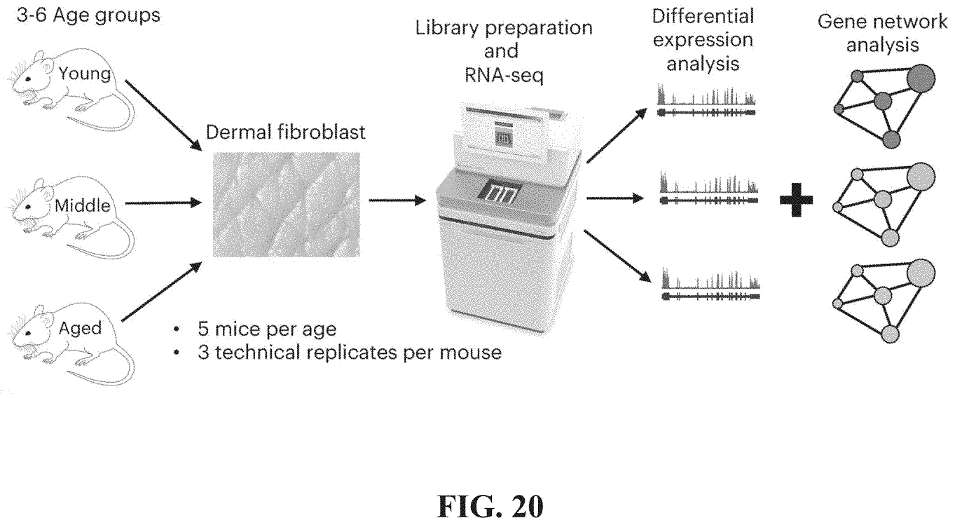

FIG. 20 shows molecular signatures of aging, in accordance with embodiments of the present disclosure. Plurality of cells from different aged mice may be harvested with 5 mice from each group. The plurality of cells may be RNA-sequenced and may be stored into an accessible library database. The library database of the RNA-sequences may be used to provide information for differential expression analysis and gene network analysis of the plurality of cells on a variety of plurality of cells from different age groups.

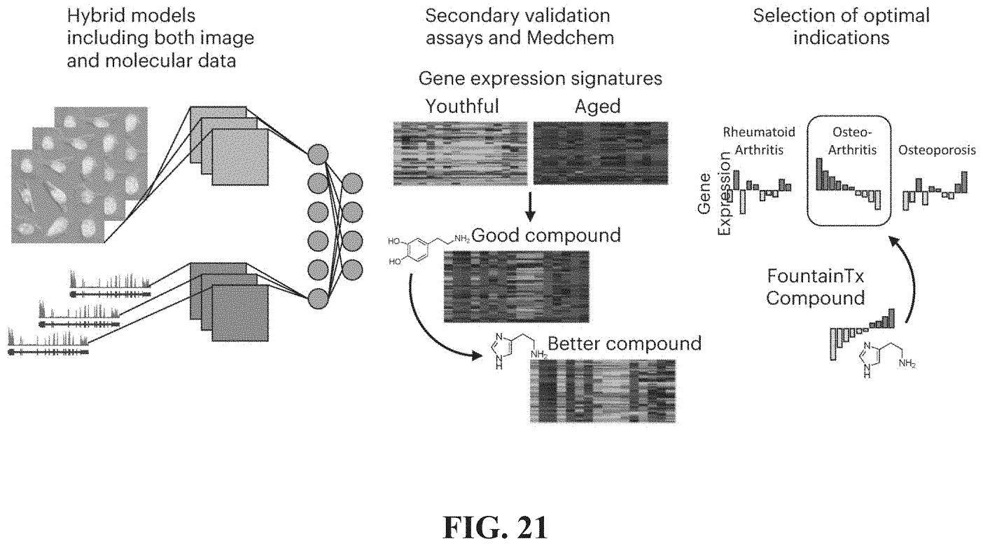

FIG. 21 shows advantages of supplementing methods with molecular data, in accordance with embodiments of the present disclosure. Hybrid models may include both plurality of enhanced images using the methods described elsewhere herein with molecular data (e.g. differential expression analysis, gene network analysis, etc). The plurality of cells may have different gene expression signatures in accordance to the age of the plurality of cells. The plurality of cells may be contacted with drug candidates and the plurality of cells may have different gene expression signatures. The gene expression signatures of the plurality of cells after contact with a drug candidate may indicate the effectiveness of a drug and may allow the user to rank/classify drug candidates and select optimal indications to treat.

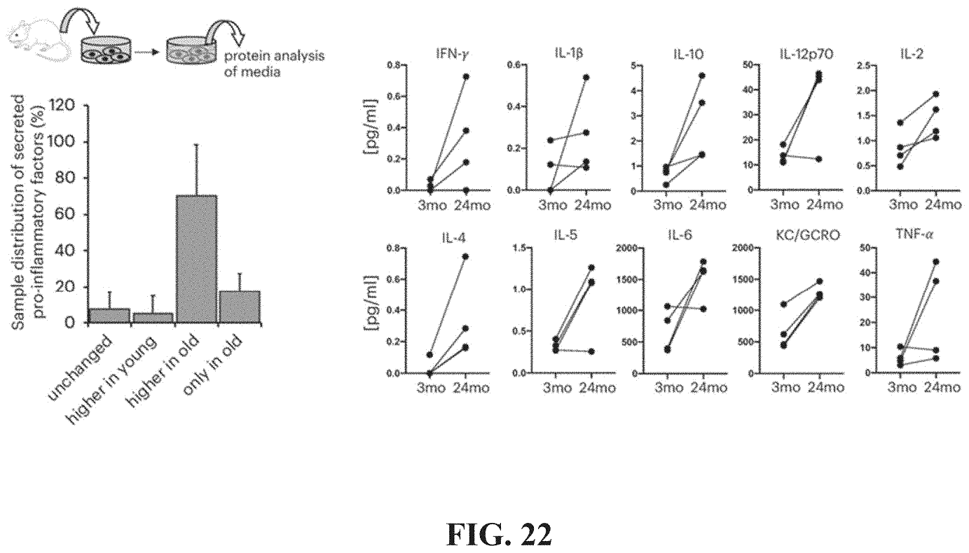

FIG. 22 shows strategy for target identification for directed drug development and hit validation. 3-month and 24-month old plurality of cells were analyzed and the majority of analyzed pro-inflammatory cytokines may be secreted at higher concentrations in plurality of cells that are older. The sample distribution of secreted pro-inflammatory factors as a percentage were illustrated to be higher in plurality of cells that were older.

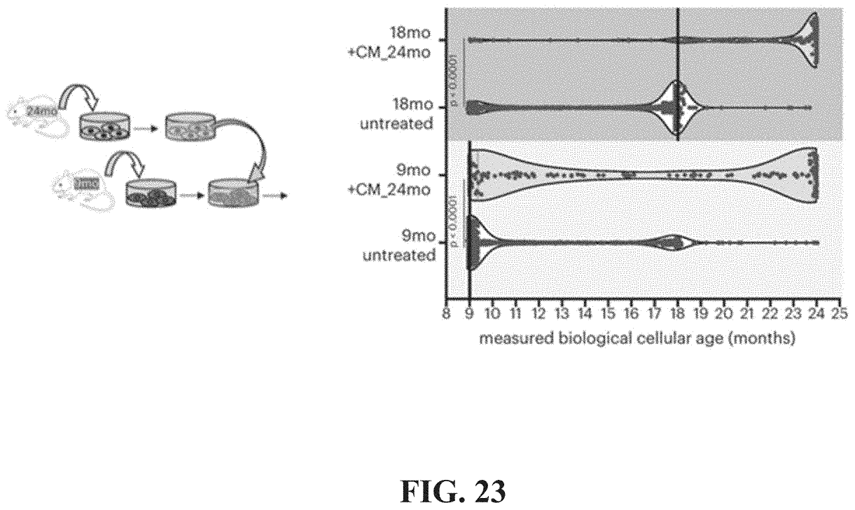

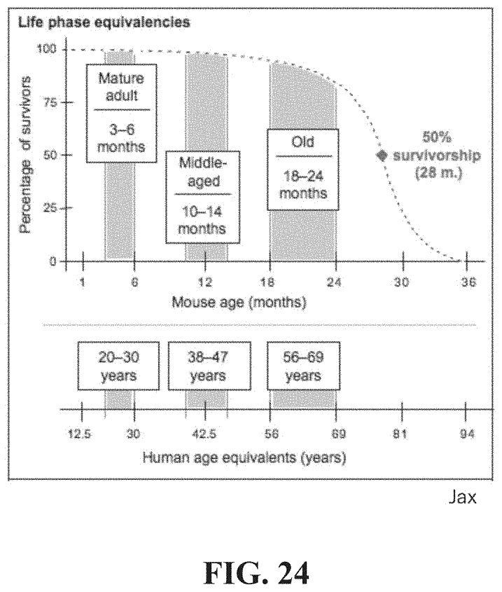

FIG. 23 shows old cells secrete factors that increase biological age of cells, in accordance with embodiments of the present disclosure. Conditioned media from a plurality of cells of 24 months of age may be used as media for a plurality of cells of 9 months of age. The plurality of cells of 9 months of age had a greater quantity of plurality of cells that had a measured age that was greater than the untreated 9 months of age plurality of cells. Conditioned media from a plurality of cells of 24 months of age may be used as media for a plurality of cells of 18 months of age. The plurality of cells of 18 months of age had a greater quantity of plurality of cells that had a measured age that was greater than the untreated 18 months of age plurality of cells.

### V. Computer Systems

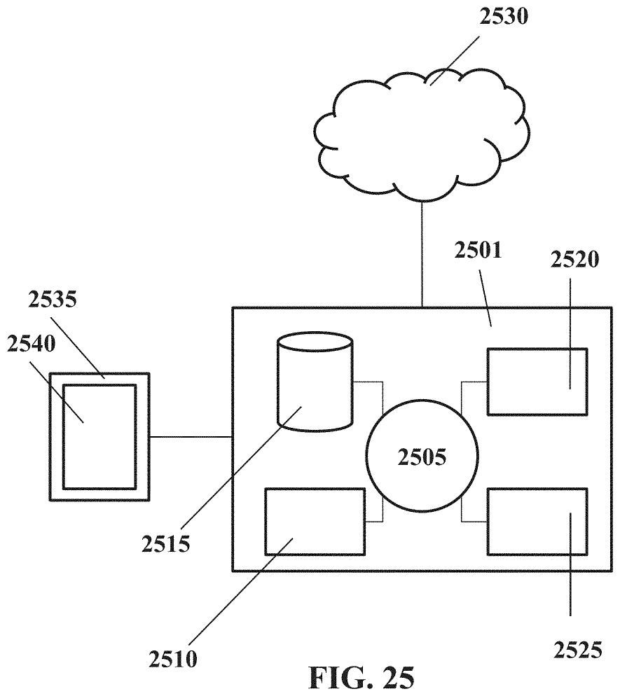

The present disclosure provides computer systems that are programmed to implement methods of the disclosure, including producing enhanced cell images, concatenating enhanced cell images, classifying plurality of cells by age, training and applying deep learning models and machine learning-based classifiers, drug candidate discovery, etc. FIG. 25 shows a computer system 2501 that is programmed or otherwise configured to classify and produce enhanced cell images for cell age prediction. The computer system 2501 can regulate various aspects of microscopy, deep learning models and machine learning-based classifiers, producing cell enhanced images, concatenating and classifying cell enhanced images, drug candidate discovery, of the present disclosure, such as, for example, microscopy parameters, deep learning and machine learning parameters, concatenation of enhanced cell images methods, etc. The computer system 2501 can be an electronic device of a user or a computer system that is remotely located with respect to the electronic device. The electronic device can be a mobile electronic device.

The computer system 2501 includes a central processing unit (CPU, also “processor” and “computer processor” herein) 2505, which can be a single core or multi core processor, or a plurality of processors for parallel processing. The computer system 2501 also includes memory or memory location 2510 (e.g., random-access memory, read-only memory, flash memory), electronic storage unit 2515 (e.g., hard disk), communication interface 2520 (e.g., network adapter) for communicating with one or more other systems, and peripheral devices 2525, such as cache, other memory, data storage and/or electronic display adapters. The memory 2510, storage unit 2515, interface 2520 and peripheral devices 2525 are in communication with the CPU 2505 through a communication bus (solid lines), such as a motherboard. The storage unit 2515 can be a data storage unit (or data repository) for storing data. The computer system 2501 can be operatively coupled to a computer network (“network”) 2530 with the aid of the communication interface 2520. The network 2530 can be the Internet, an internet and/or extranet, or an intranet and/or extranet that is in communication with the Internet. The network 2530 in some cases is a telecommunication and/or data network. The network 2530 can include one or more computer servers, which can enable distributed computing, such as cloud computing. The network 2530, in some cases with the aid of the computer system 2501, can implement a peer-to-peer network, which may enable devices coupled to the computer system 2501 to behave as a client or a server.

The CPU 2505 can execute a sequence of machine-readable instructions, which can be embodied in a program or software. The instructions may be stored in a memory location, such as the memory 2510. The instructions can be directed to the CPU 2505, which can subsequently program or otherwise configure the CPU 2505 to implement methods of the present disclosure. Examples of operations performed by the CPU 2505 can include fetch, decode, execute, and writeback.

The CPU 2505 can be part of a circuit, such as an integrated circuit. One or more other components of the system 2501 can be included in the circuit. In some cases, the circuit is an application specific integrated circuit (ASIC).

The storage unit 2515 can store files, such as drivers, libraries and saved programs. The storage unit 2515 can store user data, e.g., user preferences and user programs. The computer system 2501 in some cases can include one or more additional data storage units that are external to the computer system 2501, such as located on a remote server that is in communication with the computer system 2501 through an intranet or the Internet.

The computer system 2501 can communicate with one or more remote computer systems through the network 2530. For instance, the computer system 2501 can communicate with a remote computer system of a user (e.g., microscopy device manager, deep learning model manager, machine learning-based classifier manager, drug candidate manager, data input, data output, etc). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2501 via the network 2530.

Methods as described herein can be implemented by way of machine (e.g., computer processor) executable code stored on an electronic storage location of the computer system 2501, such as, for example, on the memory 2510 or electronic storage unit 2515. The machine executable or machine readable code can be provided in the form of software. During use, the code can be executed by the processor 2505. In some cases, the code can be retrieved from the storage unit 2515 and stored on the memory 2510 for ready access by the processor 2505. In some situations, the electronic storage unit 2515 can be precluded, and machine-executable instructions are stored on memory 2510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2501 can include or be in communication with an electronic display 2535 that comprises a user interface (UI) 2540 for providing, for example, cell separation parameters, cell plating, microscopy operation, deep learning model parameters, machine learning-based classifier parameters, drug candidate discovery throughput parameters, biological assay. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2505. The algorithm can, for example, process enhanced cell images, classify enhanced cell images, concatenate enhanced cell images, calculate weighted age of a plurality of cells, etc.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### EXAMPLES

### Example 1: Harvesting Dermal Tissue

Euthanize mouse by cervical dislocation after anesthesia. Trim the dorsal fur with hair clippers and apply hair removal cream for 1 to 5 minutes to the dorsum, ears and tail. Wipe the area clean and spray the animal down with ethanol; allow to dry. Harvest dorsal skin using dissecting scissors by separating along fascial planes. Optional: use scissors to remove the ears and tail. Rinse dorsal skin in betadine, followed by 1-2 minutes in 40 mL of PBS (with 1% pen/strep) on ice. Transfer the tissue to a 50 mL conical tube containing DMEM with 1% pen/strep. Perform all subsequent steps in a cell culture hood.

### Example 2: Mechanical and Enzymatic Skin Tissue Digestion

Transfer dermis to a 10 cm dish and scrape away excess adipose tissue with forceps and/or a scalpel. Weigh out 0.25 g of tissue per reaction. Use scissors to mince the tissue into a fine and uniform consistency (<2 mm). Continue with the skin dissociation kit. Note: digest tissue for 3 hours at 37° C. and use cell medium supplemented with serum to quench the reaction. Transfer 435 μL of Buffer L and 12.5 μL of Enzyme P into the MACS C Tube and mix carefully. Note: Some epitopes (e.g. CD4 and CD8) are sensitive for Enzyme P. If these epitopes are to be remained in the single-cell suspension, omit the addition of Enzyme P which lowers cell yields. Add 50 μL of Enzyme D and 2.5 μL of Enzyme A into the C Tube and mix carefully (keep buffer at the bottom of the tube). Note: Enzyme A and Enzyme D can be premixed before addition into the C Tube. Do not premix Enzyme P with Enzyme A or Enzyme D. Transfer one sample of skin tissue (4 mm) into the C Tube containing the enzyme mix and tightly close it. Close C Tube tightly beyond the first resistance. Note: Up to 3 samples (4 mm each) can be processed per C Tube if an overnight incubation is chosen in next step. Incubate sample in a water bath at 37° C. for 3 hours or overnight. Note: Longer incubation time increases cell yield. After incubation dilute the sample by adding 0.5 mL of cold cell culture medium. Tightly close C Tube and attach it upside down onto the sleeve of the MACS dissociator. Close C Tube tightly beyond the first resistance. It has to be ensured that the sample material is located in the area of the rotor/stator. Run the program h_skin_01. After termination of the program, detach C Tube from the MACS dissociator. Perform a short centrifugation step to collect the sample material at the tube bottom. Apply the cell suspension to a Pre-Separation Filter, 70 μm, placed on a 15 mL tube. Wash the filter with 4 mL of cold cell culture medium. (Optional: To collect remaining cells in the C Tube add the cold medium first to the C Tube and then on top of the filter). Discard the filter and centrifuge cell suspension at 300×g for 10 minutes at 4° C. Aspirate supernatant completely and resuspend with 500 uL of cold MACS buffer. Refilter into a 2 mL microcentrifuge tube through a 35 um Falcon mesh-cap. Wash the filter with 1 mL cold buffer. Centrifuge (300 g, 10 min, 4 C) and resuspend with 90 uL cold MACS buffer. Proceed to MACS microbead labeling for cell-type specific enrichment.

### Example 3: Depletion of CD45+ Hematopoietic Cells

Determine cell number after tissue dissociation. Centrifuge at 300×g for 10 minutes. Pipette off supernatant completely. Resuspend cell pellet in 90 μL of buffer per 10⁷ total cells. 4. Add 10 μL of CD45 MicroBeads per 10⁷ total cells. 5. Mix well and incubate for 15 minutes at 4-8° C. Wash cells by adding 1-2 mL of buffer per 10⁷ cells and centrifuge at 300×g for 10 minutes. Pipette off supernatant completely. Resuspend up to 10⁸ cells in 500 μL of buffer. For higher cell numbers, buffer volume may be scaled up accordingly. For depletion with LD columns, resuspend cell pellet in 500 μL of buffer for up to 1.25×108 cells. Proceed to magnetic separation. Place LD Column in the magnetic field of a suitable separator. Prepare column by rinsing with 2 mL of buffer. Apply cell suspension onto the column. Collect unlabeled cells which pass through and wash column with 2×1 mL of buffer. Collect total effluent. This is the unlabeled (CD45 negative) cell fraction. Take the negative fraction from the CD45 depletion and continue with the CD31 protocol to deplete endothelial cells. This fraction can be collected through positive selection if culturing of endothelial cells is desired.

### Example 4: CD31 Positive Selection for the Isolation of Endothelial Cells

Determine cell number if more than 10⁷ cells are expected. Centrifuge cell suspension at 300×g for 10 minutes. Aspirate supernatant completely. Add 90 μL of buffer per 10⁷ total cells to the cell pellet. Add 10 μL of buffer per 10⁷ total cells to the cell pellet. Mix well and incubate for 15 minutes in the refrigerator (2-8° C.). Wash cells by adding 1-2 mL of buffer per 10⁷ cells and centrifuge at 300×g for 10 minutes. Aspirate supernatant completely. Resuspend up to 10⁸ cells in 500 μL of buffer. Proceed to magnetic separation. Place column in the magnetic field of a suitable separator. Prepare column by rinsing with the appropriate amount of buffer: MS 500 μL LS: 3 mL. Apply cell suspension onto the column. Collect flow-through containing unlabeled cells. Wash column with the appropriate amount of buffer. MS: 3×500 LS: 3×3 mL. Collect unlabeled cells that pass through and combine with the flow-through from the previous step. Keep the negative fraction and continue with CD90.2 microbeads protocol. Remove column from the separator and place it on a suitable collection tube. Pipette the appropriate amount of buffer onto the column. Immediately flush out the magnetically labeled cells by firmly pushing the plunger into the column: MS: 1 mL LS: 5 mL 7. To increase the purity of CD31+ cells, the eluted fraction can be enriched over a second MS or LS Column. Repeat the magnetic separation procedure as described above by using a new column. After selection, centrifuge the positive fraction (300 g, 10 min, 4 C). Aspirate and resuspend with 100 μL of buffer or media. Count and plate CD45− CD31+ endothelial cells at 10K cells/well in a 96-well plate coated with 1:100 collagen I. For each well, pipet to mix and distribute cells evenly. Take the negative fraction from CD31 selection and continue with CD90.2 microbeads protocol starting at 2.2 Magnetic Labeling.

### Example 5: CD90.2 Positive Selection for the Isolation of Fibroblasts

Take the negative fraction from CD31 selection and continue with CD90.2 microbeads protocol. Determine cell number if more than 10⁷ cells are expected from previous steps. Centrifuge cell suspension at 300×g for 10 minutes. Aspirate supernatant completely. Add 90 μL of buffer per 10⁷ total cells to the cell pellet. Add 10 μL of CD90.2 microbeads per 10⁷ total cells. Mix well and incubate for 15 minutes in the refrigerator (2-8° C.). Wash cells by adding 1-2 mL of buffer per 107 cells and centrifuge at 300×g for 10 minutes. Aspirate supernatant completely. Resuspend up to 10⁸ cells in 500 μL of buffer. For higher cell numbers, scale up buffer volume accordingly. Proceed to magnetic separation. Place column in the magnetic field of a suitable separator. Prepare column by rinsing with the appropriate amount of buffer: MS 500 μL LS: 3 mL. Apply cell suspension onto the column. Collect flow-through containing unlabeled cells. Wash column with the appropriate amount of buffer. MS: 3×500 LS: 3×3 mL. Collect unlabeled cells that pass through and combine with the flow-through from the previous step as CD45− CD31− CD90.2 fraction. Remove column from the separator and place it on a suitable collection tube. Pipette the appropriate amount of buffer onto the column. Immediately flush out the magnetically labeled cells by firmly pushing the plunger into the column MS: 1 mL LS: 5 mL 7. To increase the purity of CD90.2+ cells, the eluted fraction can be enriched over a second MS or LS Column. Repeat the magnetic separation procedure as described above by using a new column. After selection, centrifuge the positive and negative fractions (300 g, 10 min, 4 C). Aspirate and resuspend with 100 μL of buffer or media. Count and plate CD45− CD31− CD90.2+ fibroblast and CD45− CD31− CD90.2+ cells (if desired) at 10K cells/well in a 96-well plate coated with 1:100 collagen I. For each well, pipet to mix and distribute cells evenly.

### Example 6: DAPI Staining

PFA-fixed cells in a 96-well plate are washed once with PBS. Working solution of DAPI is created by diluting a 1 mM stock solution to a final concentration of 10 micromolar (μM) using PBS. Cells are stained with DAPI by adding 100 μL/well. Cells are incubated at room temperature for 10 minutes in the dark.

### Example 7: Microscopy of DAPI Stained Cells

To image fixed cells, the temperature control of the microscope is turned off and the carbon dioxide (CO2) concentration is set to 0%. If using an automatic plate loader, 96-well plates are first placed in the magazine, which can hold up to twenty-four plates. Using software, each of the plates in the magazine are pre-scanned one at a time. The plates are then imaged using preset settings. The pre-defined imaging settings are: (a) images are acquired with a 20×0.95NA air objective and 1× optivar, using 20 millisecond (ms) exposure for DAPI with 50% LED intensity and 10 ms exposure for phase contrast gradient with 50% TL lamp intensity. (b) a total of 81 individual 2-channel micrographs are acquired in each well, which are then stitched together with a 20% overlap. (c) when imaging a well, the microscope uses autofocus software to identify the ideal Z-plane for a particular well. Specifically the microscope takes a 250-μm wide Z-stack using a 1.01 μm step size using the DAPI channel. Focal plane is selected from the image with the sharpest contrast. Finding the focal plane is done once per well in the upper left corner of the tiled image, or at different intervals. (d) During imaging, the microscope uses the hardware feature to maintain the Z distance between the objective and the focal plane calculated using autofocus software. Definite Focus is activated every 3 frames. When the imaging is complete, the software saves the experiment (a whole plate) as a single .czi file, which is then split well-wise using software. Each of the .czi files corresponding to individual wells is converted to an 8-bit .png file using a programming script (e.g python script). The pixel values are rescaled to occupy values between 0 and 255. This script also separates the channels into distinct .png files. Raw .czi files and 8-bit .png files are saved.

### Example 8: Building Datasets

Converted 8-bit .png images corresponding the DAPI channel are cropped to 14 k×10 k pixels to eliminate the well-to-well size variability created by the stitching of the tiles. Images are uploaded to interface which uses the U-Net convolutional neural network to segment nuclei. The trained model may be given a name. Segmenting 54-60 tiled wells takes approximately 45 minutes. This 3-classifier classifies each pixel into: (1) ‘good’ foreground (nuclei), (2) ‘bad’ foreground (binucleated nuclei), and (3) ‘background.’ When the segmentation is complete, the interface will output a folder containing two files per input file: (1) binary mask image, (2) overlay of raw image with binary mask. The binary mask image has the same name as the original input which is important to build further datasets. The programming script (e.g. MATLAB) will take in raw microscopy images (nuclei and phase) and nuclear masks, and will output enhanced cell images and concatenated enhanced cell images. Below are the steps performed by the script (a) script will need paths to raw images and nuclear masks. The script will also need a .csv file detailing the configuration of the 96-well plate it is processing. This file needs to indicate what each well contains (treatment) and the chronological age of the sample. Whether the sample will be used as training data should also be indicated. (b) at the level of the whole image (mask), debris and large imaging artifacts are removed using size filters. (c) for each well, the script will loop through each ‘good’ nucleus and draw bounding box that is 101×101 pixels in size around it. This bounding box, with the nuclear mask in the center, has cartesian coordinates of the raw nuclei images and raw phase images. (d) the sample is eliminated if nuclei are found inside the bounding box or if the bounding box is at the edge of the image (where pixels reach zero because of the stitching). (e) the binary mask is used to remove background pixels from the raw nuclear image. This background subtraction allows the deep learning algorithms to ignore any non-biologically relevant information. (f) an enhanced cell image is assembled by stacking a nuclear patch (background-subtracted) with two identical phase patches. This creates a 101×101×3 enhanced cell image (an RGB in principle). (g) once all enhanced cell images from a sample have been created, and perhaps pooled from several samples, they will randomly be concatenated into a 303×303×3 or 505×505×3 concatenated enhanced cell images. Once built, data are pushed to a server. Typically when wells are selected as training data during dataset building, a random 20% of the wells are flagged as validation wells. From that moment on, those data are kept separate.

### Example 9: Deep Learning-Based Classification

The classification framework is written in Pytorch. To build a classification model, data are structured as follows: ExperimentName: {train {3 mo, 24 mo}, val {3 mo, 24 mo}}

Start a server instance that has access to a graphics processing unit (GPU). Typically, the P2 instances are used: p2.8×large and p2.16×large, which have 8 and 16 GPUs respectively. A series of parameters are set: learning rate (0.01), minibatch size (32), number of epochs to train for (at least 20), momentum (0.9), and weight decay (0.0001). The learning rate decays by a factor of 0.1 every 10 epochs. Used The Adam optimizer and Cross Entropy for a loss function were used. The convolutional neural network used is ResNet 18, which has been pre-trained with ImageNet's dataset. Biological data are then used to fine-tune the neural network. Checkpoints are set up so that the weights of a trained network will be saved every time there is an improvement in the validation accuracy.

### Example 10: Fixing Cells for Staining/Imaging

Aspirate media and replace with 4% formaldehyde. Fix for 10 minutes at room temperature. Wash 3× with PBS (5-10 minutes each). Wrap plates in parafilm and store at 4° C. until staining and imaging.

### Example 11: Preparation of Aliquots

Aliquots of DMEM (30 mL) and PBS (50 mL) for harvesting dermis—one set per mouse. Plates were then coated with Poly-D-Lysine. PDL stock solution was thawed (1 mL per 4 plates). Dilute 1:10 in cell culture-grade water. 10-12 plates (96-well) were coated with 40 microliters (μl) per well for CV. The plates and wells were allowed to sit in a cell culture hood for 10 to 20 minutes. They were then washed once with cell culture-grade water. Then they were dried for at least 1 hours or overnight in the cell culture hood. PEB buffer was prepared by diluting BSA solution 1:20 in MACS running buffer. DCR buffer was prepared by diluting 20 binding buffer 1:20 in cell culture-grade water. FGM (PromoCell) was prepared with 5% HS and serum-free FGM (if needed).

### Example 12: Harvesting Dermis

Mice were euthanized using CO2 (flow rate 2-4) for 1-2 minutes, followed by cervical dislocation. The dorsal fur was trimmed with clippers and hair removal cream was applied for 1 to 3 minutes to the dorsum. The area was wiped clean with gauze. The animal was sprayed down with ethanol. The paws of the animal were pinned to the lid of a styrofoam box covered in a blue absorbent pad so that the limbs are outstretched to the front and rear of the animal. Dorsal skin was harvested using dissecting scissors by separating along fascial planes. Small incisions were made near the base of the tail and separate connective tissue by blunt dissection. Adipose tissue was avoided from harvesting. The dorsal skin was rinsed with betadine, followed by 1 to 2 minutes in 40 mL of PBS on ice. The tube was then shaken to wash off the betadine.

### Example 13: Tissue Dissociation

Enzyme aliquots were thawed to room temperature. Enzyme dissociation mix was added to C Tube with first adding 2.175 μl Buffer L, 62.25 μl Enzyme P, 250 μl Enzyme D, and 12.5 μl Enzyme A. Dermis was transferred to a 10 cm dish and scissors were used to mince the tissue into a fine and uniform consistency (about 2 mm). The minced tissue was transferred into the C tube using a cell scarper and tightly closed (past the first stop). The tube was sealed with parafilm. Samples were incubated in a shaking water bath at 37° C. for 3 hours at 50 rpm. The tubes were submerged horizontally to achieve a back and forth rocking motion. After incubation parafilm was removed and the C Tube was attached upside down onto the sleeve of the dissociator. The MACS program h_skin_01 was ran. After termination of the program, the C Tube was detached from the MACS dissociator. A short centrifugation (300 g for 20-30 seconds) was performed to collect the sample material at the bottom of the tube.

### Example 14: Single-Cell Suspension

Samples were returned to the cell culture hood and 2.5 mL of cold DMEM 10% HS was added to stop the enzymatic reaction. The cell suspension was ran through a cell strainer and then placed on a 50 mL tube. The filter was washed with 40 mL of cold DMEM with 10% HS and 1% p/s. The filter was discarded and the cell suspension was centrifuged at 600×g for 15 minutes. The supernatant was aspirated down to 10 mL. The pellet was resuspended by pipet and the cell suspension was ran filtered through a 10 μm filter with a 15 mL adapter into a 15 mL falcon tube. The filter was washed with 5 mL wash media. The number of cells in the suspension was counted to determine the volume of Dead Cell Removal microbeads needed for the following step. The tube was inverted gently 2 times to mix. A 10 μl aliquot was transferred to a microcentrifuge tube containing 10 μl of Trypan Blue. Pipet to mix and transfer 10 μl to a hemocytometer. Count four 4×4 squares and calculate cells/ml and total cells/sample. (total cell count/4 squares)×dilution factor (2)×10000=cells/ml×ml/sample=total cells/sample.

### Example 15: Dead Cell Removal

The cell suspension was centrifuged at 400 g for 10 minutes. The supernatant were aspirated completely. The pellet was resuspended in 100 μl of microbeads per approximately 10\hat{ }7 total cells. The sample was mixed well and incubated for 15 minutes at room temperature (20-25° C.) and protected from light. A 40 μm cell trainer was placed on top of a column with a 15 ml adapter. An LS column was prepared by rinsing with 3 ml of 1× Binding Buffer. The effluent was collected as the live cell fraction and the number of cells were counted. Optional—reserve aliquots of approximately 50 k cells from each mouse for flow cytometry (unstained, autocompensation; Sca1-BV421, compensation; CD90.2-APC, compensation; Sca1+CD90.2, analysis). Proceed with magnetic labeling and separation with the remaining cells.

### Example 16: CD90.2+Enrichment for Dermal Fibroblasts

Centrifuge the live cell fraction from DCR at 300×g for 10 minutes at 4° C. The supernatant was aspirated. The pellet was resuspended in 90 μl of PEB Buffer per 10\hat{ }7 total cells. 10 μl of CD90.2 microbeads per 10\hat{ }7 total cells was added. The sample was mixed well and incubated for 15 minutes at 4° C. The cells were washed by adding 2 ml of buffer per 10\hat{ }7 cells and centrifuged at 300×g for 10 minutes at 4° C. A LS column was prepared by rinsing with 3 ml of buffer. The supernatant was aspirated and resuspended in 500 4° C. of buffer per 10\hat{ }8 total cells. A cell suspension onto the column was applied. The column was washed with a 3×3 ml buffer. Washing steps were performed by adding buffer each time the column reservoir was empty. The column was removed from the magnet and placed over a 15 ml tube. 5 ml PEB buffer was added to the column and the plunger was used to expel the CD90.2+ cells from the column into the tube.

### Example 17: Plating and Dermal Fibroblast (DFB) Culture

The positive cell fractions from the CD90.2 selection were centrifuged at 300×g for 10 minutes 4° C. The supernatant was aspirated. The pellet was resuspended in 5 ml of Fibroblast Growth Medium (FGM) supplemented with 5% HS. The number of cells were counted in each sample as done previously. If cells are to be used for flow cytometry analysis, reserve an appropriate aliquot (about 50 k/sample) and place on ice until use. Start surface-antigen staining at this time and continue with plating. An appropriate volume of cell suspension was prepared via dilution in FGM with 5% HS for a final concentration of 100 k cells/ml (enough to fill the required number of wells per plate). A multichannel pipet was used to plate 100 k cells/well (100 μl) on glass 96-well plates coated with Poly-D-Lysine and Collagen Type 1. For ICC plate cells on an 8 chambered glass slide coated with poly-d-lysine and collagen (30 k cells/well). Remaining cells may be plated in a T25 or T75 coated with collagen type 1 for expansion.

### Example 18: Cell Culture

Cells were incubated overnight (18-24 hours) under normal cell culture conditions (37° C., 5% CO2, 100% humidity). The media was aspirated using a pipet, and replaced with serum-free FGM (add treatments at this time if need). Cells were fixed on Day 3 and stored at 4° C. until staining and imaging.

### Example 19: Flow Cytometry Analysis

Reserve a minimum of 50 k cells/sample. Conjugated flow antibodies were added at a 1:100 ratio. Pre-MACS (unstained, auto compensation; CD90.2-APC, compensation; Sca1-BV421, compensation; CD90.2+Sca1, analysis/QC). Post-Macs (CD90.2+)(/cd90.2+Sca1; analysis/QC to confirm enrichment). Then incubate at 40° C. for 20 minutes. Then 1 mL PEB was added. The sample was then centrifuged at 300 g for 10 minutes. The sample was aspirated and resuspended with 200 μl PEB. PI (1:100) was added immediately prior to analysis.

### Example 20: Raw Images of Cells in Plates

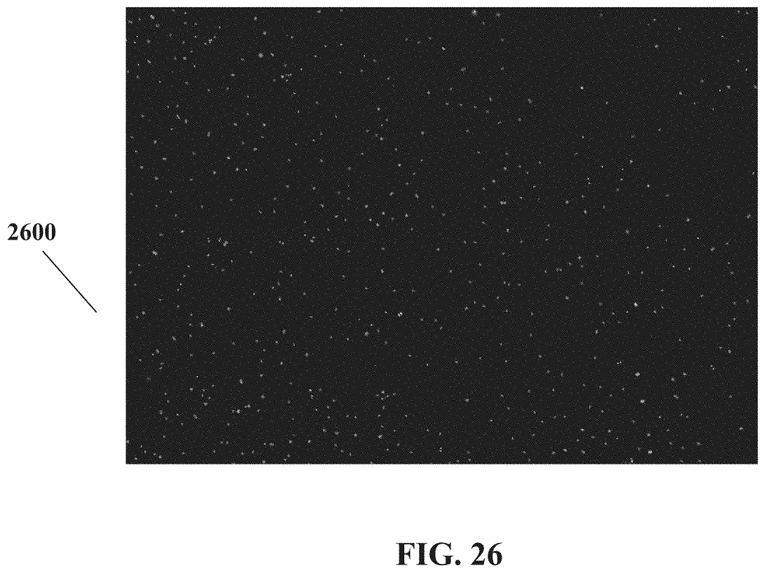

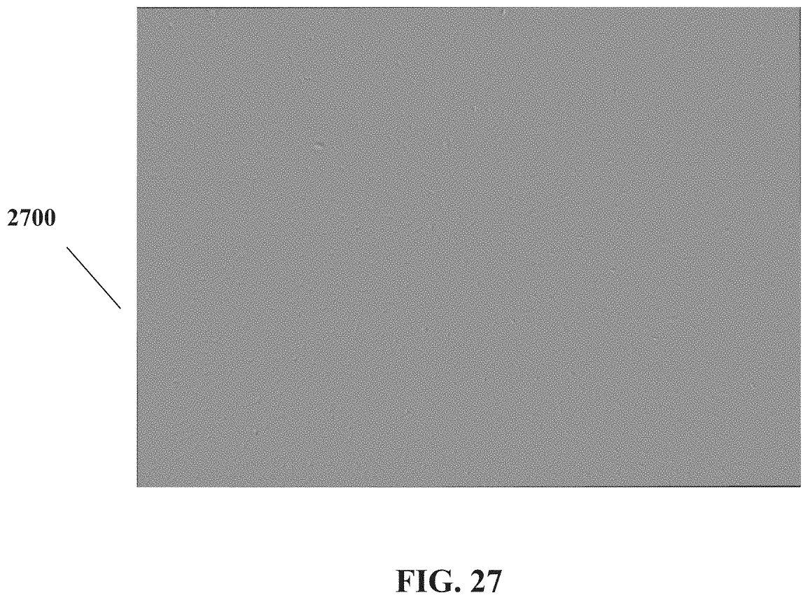

Raw images of cells in plates were obtained using a fluorescence excitation of 385 nm and emission of 425 nm. FIG. 26 illustrates a DAPI channel gray scale image 2600. Phase gradient contrasts (PGC) of transmitted light for the cells in plates were also obtained. FIG. 27 illustrates the phase channel or PGC as a gray-scale image 2700.

### Example 21: Identification of Cells in Images

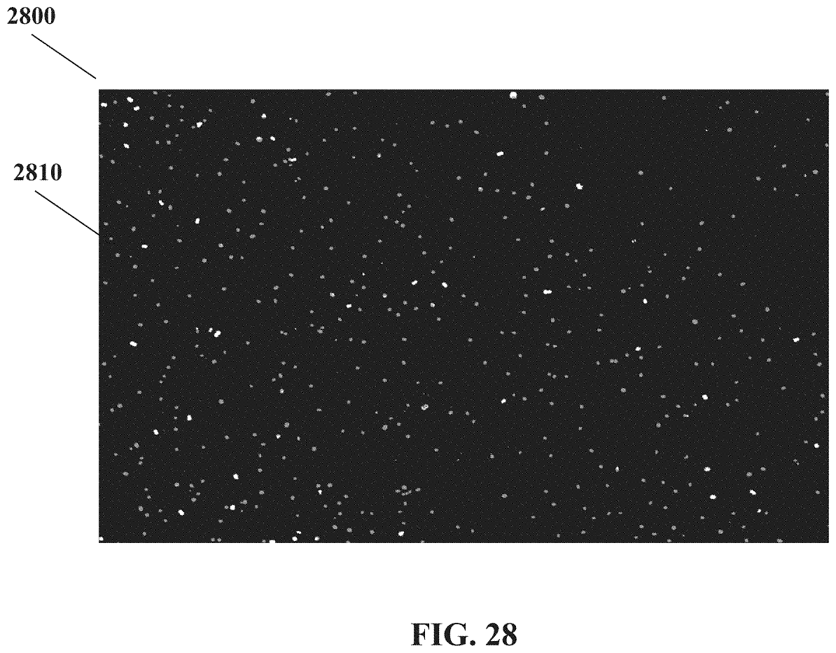

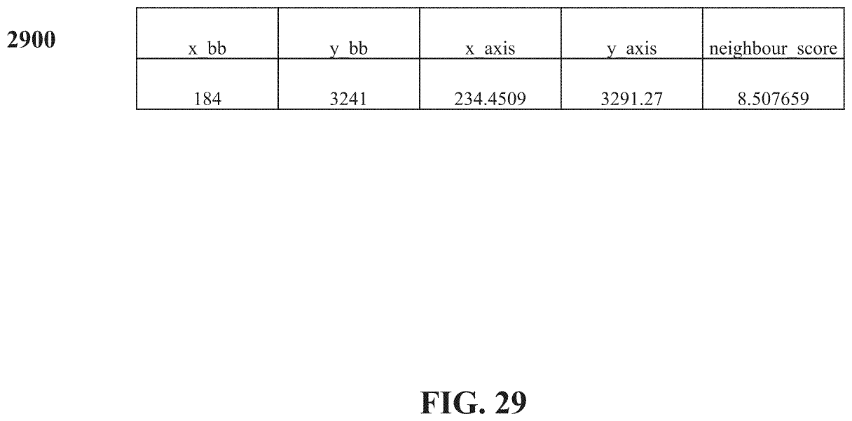

The segmenter (i.e a deep learning generate model) was trained to identify cells using DAPI channel images and trained to exclude debris, dead, and/or anomalous cells. The segmenter outputs the coordinates (e.g., X, Y) of the center of mass of each nucleus. FIG. 28 illustrates the nuclear mask image 2800 generated by the segmenter from the DAPI channel image (e.g., FIG. 26). Gray areas of 2800 were used to identify nuclei that are used to generate smart patches, white areas identify signal in the image that were excluded. FIG. 29 shows the X (x_axis), Y (y_axis) coordinates, the coordinates of the bounding box (x_bb, y_bb) (FIG. 29 and the red box 2810 in FIG. 28), and the neighbor score which represents the local cell density on the plate (i.e. the proximity, in pixels, to the 10 nearest cell neighbors).

### Example 22: Generation of the Smart Patch (SP)

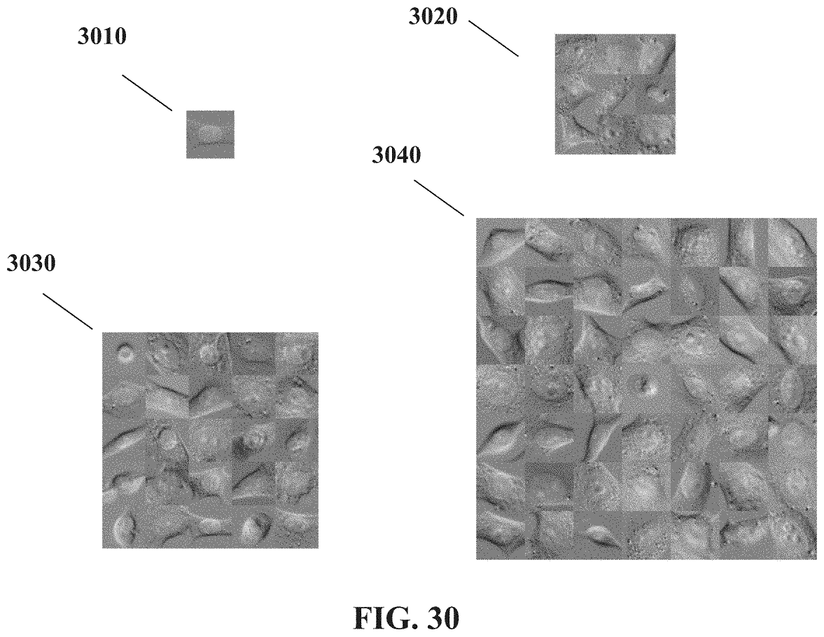

Using the coordinates, for example, in FIG. 29, a smart patch is created by generating a 101×101 bounding box around each cell in the DAPI and phase channel images. The DAPI and phase channel gray-scale images are assembled into an RGB (Red Green Blue) image (e.g., .png file). Shown in FIG. 30, the RBG image 3010 has a red channel (DAPI image), green channel (phase), and blue channel (phase). The 101×101 bounding box maximized the image size while minimizing the number of smart patches that contained two cells.

### Example 23: Generation of Concatenated Smart Patch

The intensity of each RGB channel for each smart patch were normalized by centering the pixel intensity histogram. The smart patches from a well were randomly rotated prior to tiling a square grid of 3×3 (3020), 5×5 (3030), or 7×7 (3040) images (i.e. a concatenated smart patch). FIG. 30 illustrates the various dimensions for a concatenated smart patch.

### Example 24: Model Training and Model Scoring

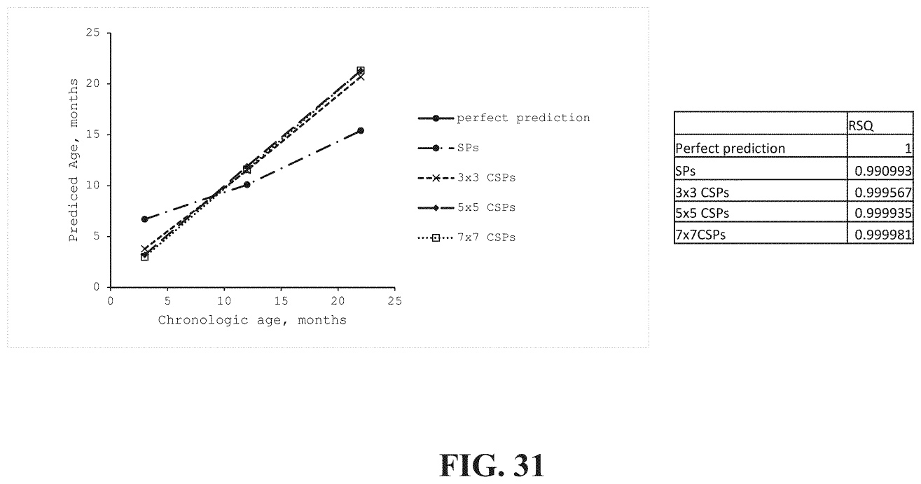

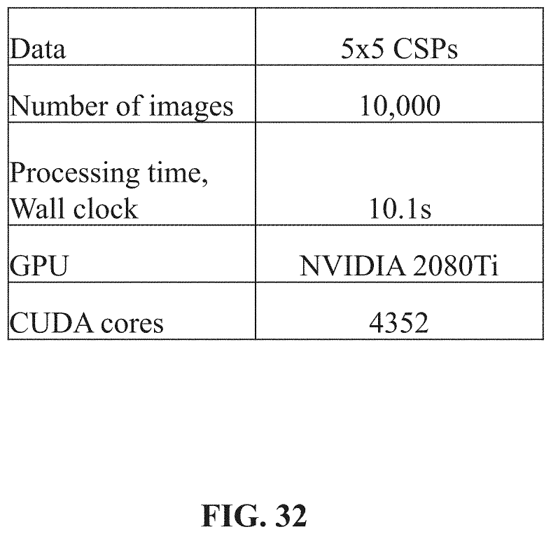

Computer models were trained using smart patches or concatenated smart patches with the chronological age of the donor as the label. The chronological age of the donor was measured from the date of birth to the date of sample isolation. Models were validated by measuring the accuracy of the predicted age compared to the actual chronological age of samples with a known age. A model with perfect accuracy may have a slope of 1 on a plot of chronological age vs predicted age and an R-squared (RSQ)=1. Increasing the size of the concatenated smart patch (e.g., increasing the number of smart patches in a concatenated smart patch) increased the accuracy of the computer models, allowing for more accurate age predictions of cells. Models trained on individual smart patches showed an RSQ of 0.990993, as shown in FIG. 31. Models trained with data structured as 3×3 concatenated smart patches showed an RSQ of 0.999567, as shown in FIG. 31. Models trained with data structured as 5×5 concatenated smart patches had an RSQ of 0.999395, as shown in FIG. 31. Models trained with data structured as 7×7 concatenated smart patches had an RSQ of 0.999981, as shown in FIG. 31. Computer models scored the predicted age of cells at a rate of one 5×5 concatenated smart patch per 0.00101 seconds (10,000 images were scored in 10.1 seconds), as shown in FIG. 32.

### Example 25: Extraction of Age-Associated Changes in Cell Morphological Features

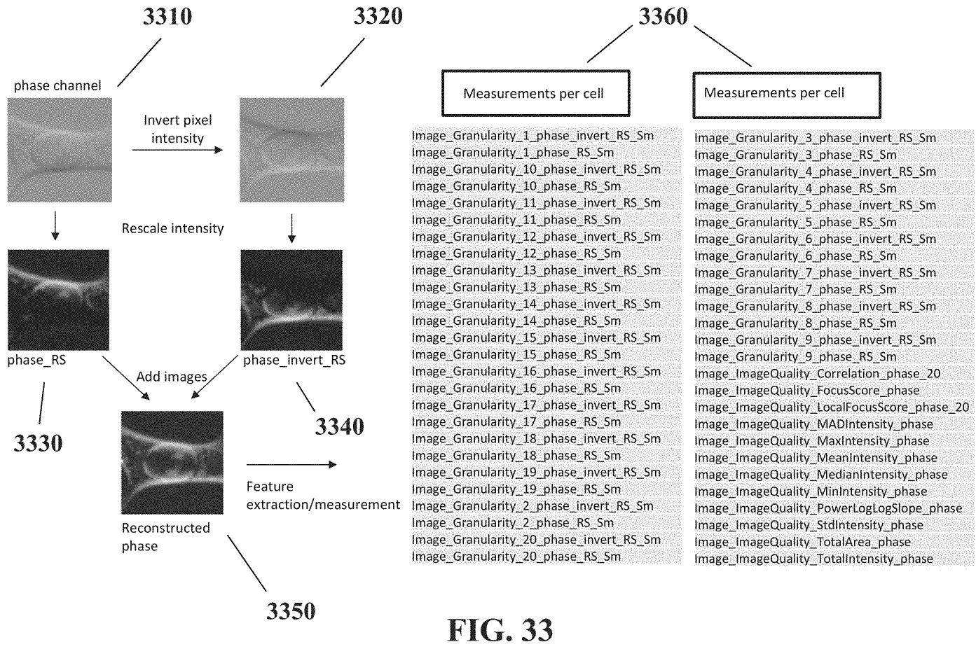

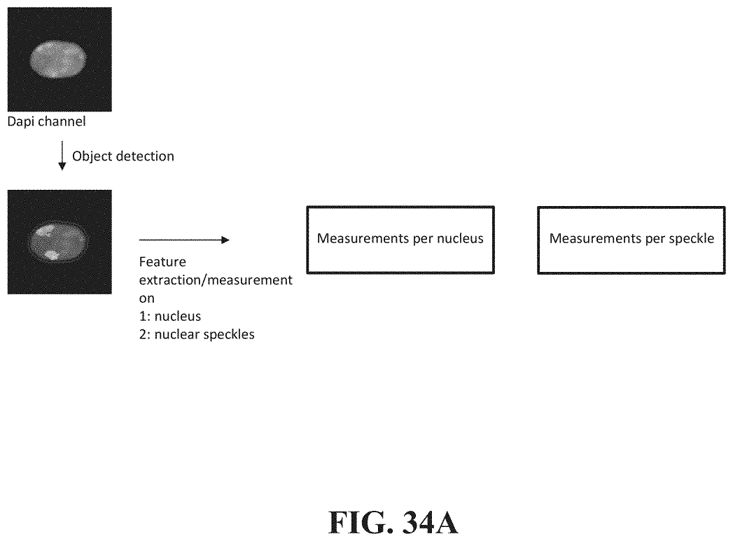

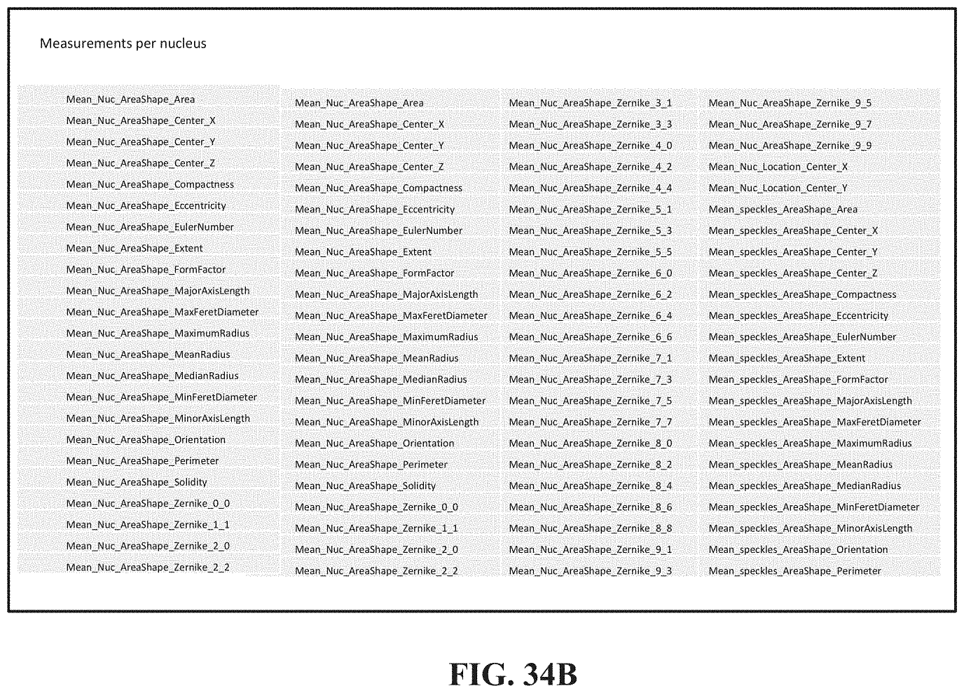

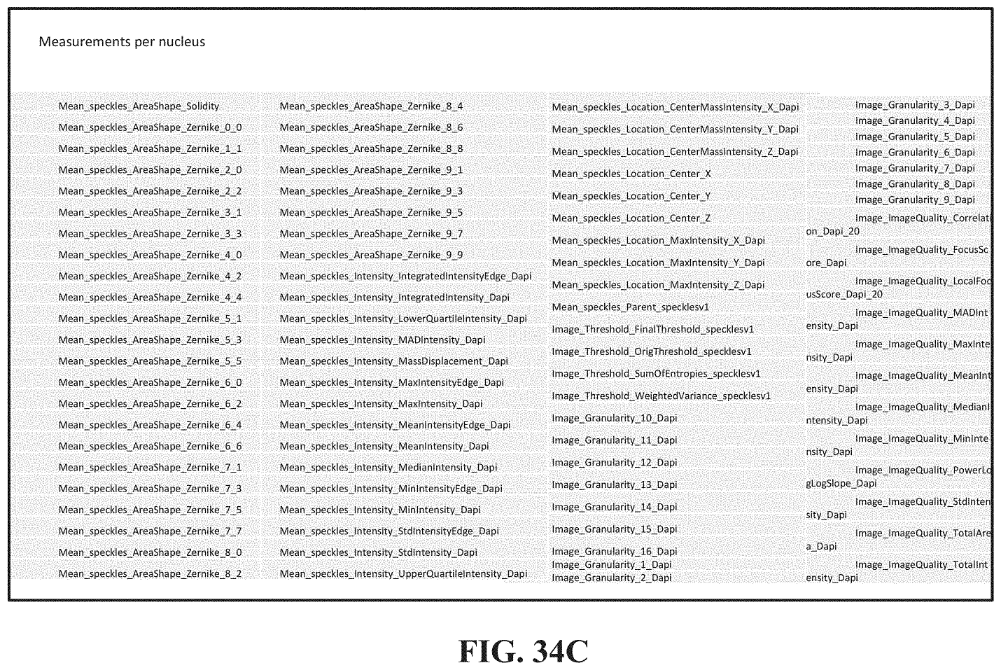

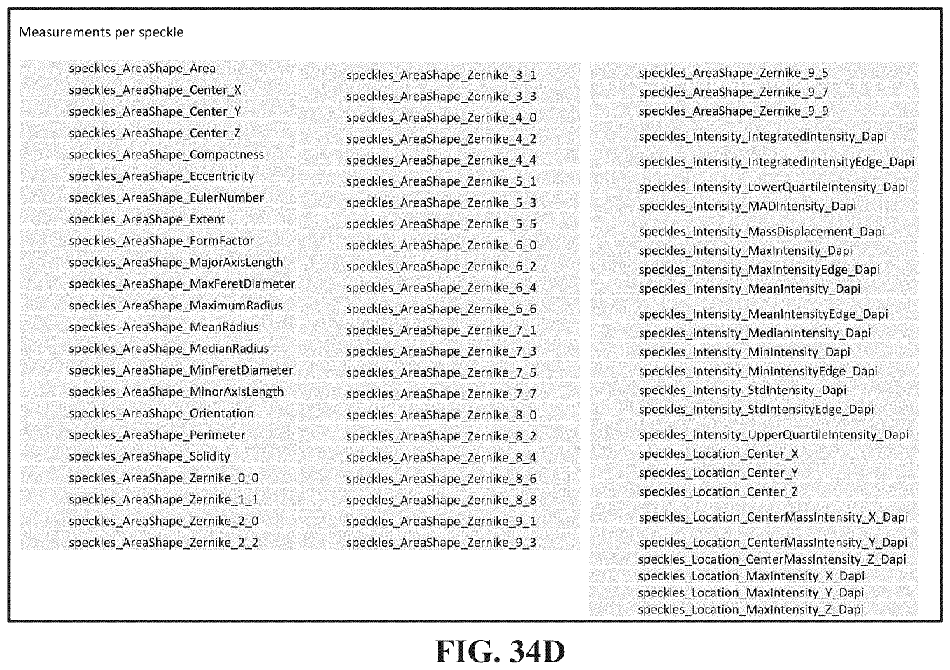

Smart patches were split into phase and DAPI channels. In parallel with the original phase channel data image 3310, the intensity of an inverted phase image 3320 was generated by subtracting the pixel value from 256 (e.g., 256-pixel value). The inverted phase image 3320 and the phase channel image 3310 were rescaled to generate a rescaled inverted phase image 3330 and a rescaled phase image 3340. The rescaled inverted phase image and rescaled inverted phase image were assembled into a reconstructed phase image 3350, as shown in FIG. 33. The listed features of the rescaled and reconstructed phase images were analyzed using cell profiler. The DAPI channel image was subject to object detection to measure the listed features of the nucleus (FIG. 34A, FIG. 34B, and FIG. 34C) and of the sub-nuclear feature (speckles) (FIG. 34A and FIG. 34D). This processing technique enhances contrast from both the light and dark (i.e. shadows) areas and re-combines them to produce a flat image (that greatly minimizes the shadow), allowing for easier identification of features. In some cases, in standard contrast enhancement, increasing the contrast of light areas reduces the contrast of dark areas (and vice versa), which may lead to more difficult identification of features.

### Example 26: Analysis of Age-Associated Changes in Cell Morphological Features

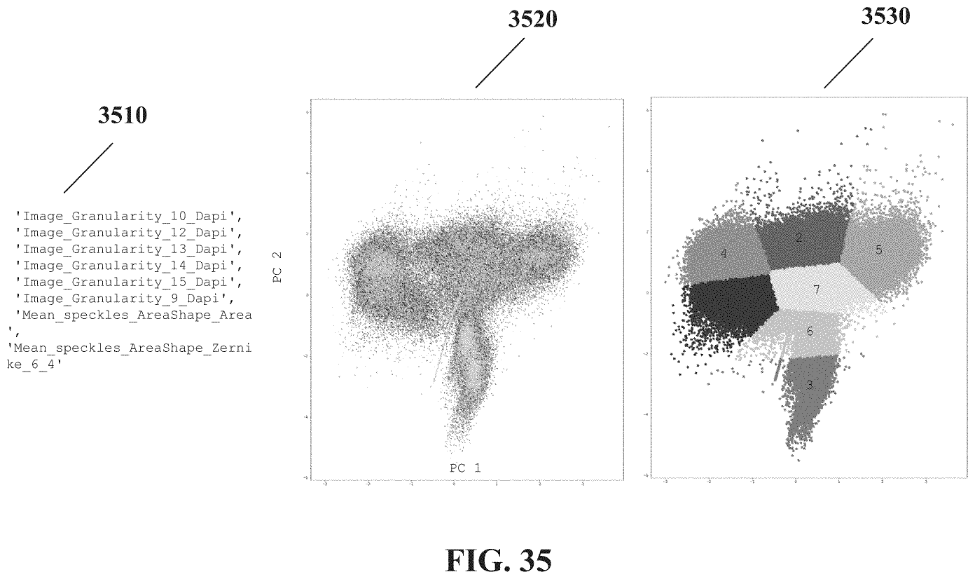

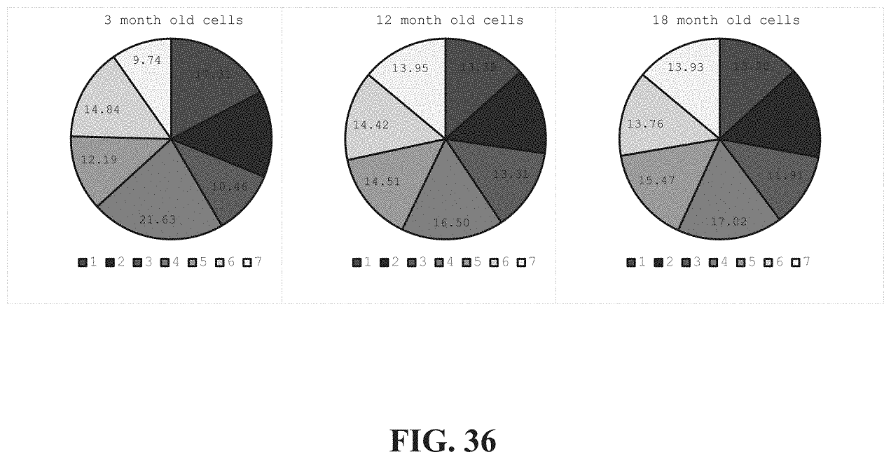

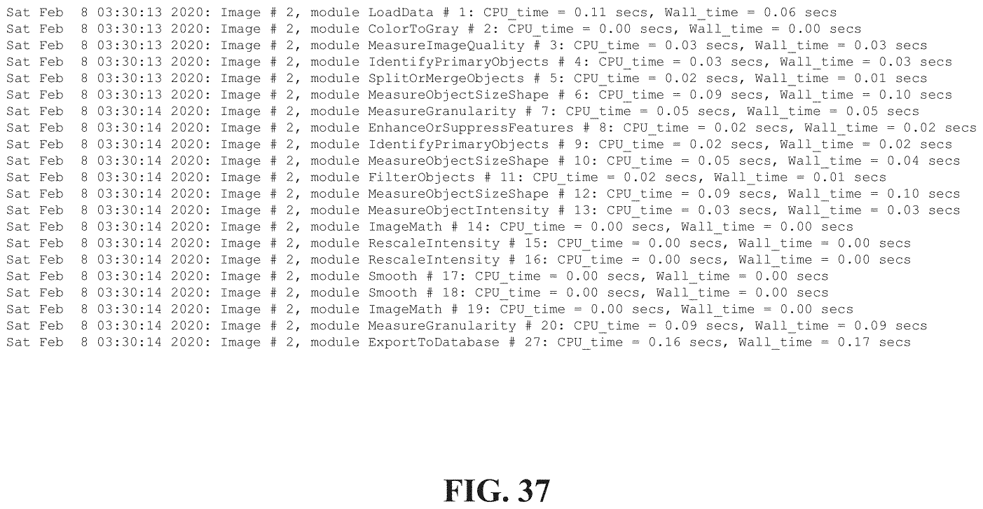

Dimensional reduction analysis (principle component analysis (PCA)) of extracted features was used to identify cells that display similar morphology features to each other 3520 (clusters or sub-populations of cells), as illustrated in FIG. 35. Morphologic features predictive of the age of a sample of cells 3510 are listed in FIG. 35. The label of each sub-population of cells identified by the PCA analysis is depicted 3530. The distribution of a population of cells into sub-populations can be predictive of the age of the sample of cells, as shown in FIG. 36. The age of a sample of cells can be predicted by analyzing the demographics of the sample. Extraction and analysis of age-associated changes in cell morphologic features on a smart patch were accomplished in 0.76 seconds on a single CPU core, as illustrated in FIG. 37.

1. A method for drug screening, comprising:
training a machine learning-based classifier comprising a multi-class model with a plurality of cell images with known chronological ages;
contacting one or more cells of a known chronological age with one or more drug candidates;
obtaining one or more images of a general region of the one or more cells at a time after said cells have been contacted with the one or more drug candidates; and
applying the machine learning-based classifier on the one or more images to determine a biological age of the one or more cells based on the general region without identifying to the classifier any morphological features in the one or more images.

2. The method of claim 1, further comprising: comparing the biological age of the one or more cells with the known chronological age, to determine if the one or more drug candidates have an effect on the cell morphology.

3. The method of claim 2, wherein the one or more drug candidates are used to research effects on aging.

4. The method of claim 3, wherein the one or more drug candidates comprise one or more therapeutic candidates that are designed to modify one or more age-dependent phenotypes.

5. The method of claim 4, further comprising: contacting each of the one or more cells with a different therapeutic candidate.

6. The method of claim 1, wherein the one or more cells comprises a plurality of cells of different chronological ages.

7. The method of claim 6, wherein the different chronological ages are on an order ranging from weeks, months, or years.

8. The method of claim 1, wherein the one or more drug candidates comprise small molecules, GRAS molecules, FDA/EMA approved compounds, biologics, aptamers, viral particles, nucleic acids, peptide mimetics, peptides, monoclonal antibodies, proteins, fractions from cell-conditioned media, fractions from plasma, serum, or any combination thereof.

9. The method of claim 1, wherein the one or more cells comprise epithelial cells, neurons, fibroblast cells, stem or progenitor cells, endothelial cells, muscle cells, astrocytes, glial cells, blood cells, contractile cells, secretory cells, adipocytes, vascular smooth muscle cells, vascular endothelial cells, cardiomyocytes, or hepatocytes.

10. The method of claim 1, further comprising: contacting the one or more cells with one or more labels, wherein said labels comprise fluorophores or antibodies.

11. The method of claim 10, wherein the fluorophores are selected from the group consisting of 4′,6-diamidino-2-phenylindole (DAPI), fluorescein, 5-carboxyfluorescein, 2′7′-dimethoxy-4′5′-dichloro-6-carboxyfluorescein, rhodamine, 6-carboxyrhodamine (R6G), N,N,N′,N′-tetramethyl-6-carboxyrhodamine, 6-carboxy-X-rhodamine, 4-acetamido-4′-isothiocyanato-stilbene-2,2′ disulfonic acid, acridine, acridine isothiocyanate, 5-(2′-aminoethyl)amino-naphthalene1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide; anthranilamide, Brilliant Yellow, coumarin, 7-amino-4-methylcoumarin, 7-amino-4-trifluoromethylcoumarin, cyanosine, 5′,5″-dibromopyrogallol-sulfonephthalein (Bromopyrogallol Red), 7-diethylamino-3-(4′-isothiocyanatophenyl)-4-methylcoumarin, diethylenetraimine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-dimethylaminophenylazophenyl-4′-isothiocyanate (DABITC), eosin, eosin isothiocyanate, erythrosine, erythrosine B, erythrosine isothiocyanate, ethidium, 5-(4,6-dichlorotriazin-2-yl)aminofluorescein (DTAF), fluorescein, fluorescein isothiocyanate, QFITC (XRITC), fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene, pyrene butyrate, succinimidyl 1-pyrene butyrate, Reactive Red 4 (Cibacron Brilliant Red 3B-A), lissamine rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101, tetramethyl rhodamine, tetramethyl rhodamine isothiocyanate (TRITC), riboflavin, rosolic acid, terbium chelate derivatives, Hoescht 33342, Hoescht 33258, Hoescht 34580, Propidium iodine, and DRAQ5.

12. The method of claim 1, further comprising enhancing a clarity of a nuclear region of the cell in each of the one or more images.

13. The method of claim 12, wherein the clarity of the nuclear region of the cell in each of the one or more images is enhanced by using (1) at least one image of the cell generated using light microscopy or (2) at least one image of the cell generated using fluorescence staining.

14. The method of claim 13, wherein the clarity of the nuclear region of the cell in each of the one or more images is enhanced by combining (1) and (2).

15. The method of claim 13, wherein the clarity of the nuclear region of the cell in each of the one or more images is enhanced by using each of (1) and (2) separately.

16. The method of claim 13, wherein the light microscopy includes phase-contrast, brightfield, confocal, DIC, polarized light or darkfield microscopy.

17. The method of claim 1, further comprising processing the one or more images comprising at least one of the following: size filtering, background subtraction, normalization, standardization, whitening, edge enhancement, adding noise, reducing noise, elimination of imaging artifacts, cropping, magnification, resizing, color adjustment, contrast adjustment, brightness adjustment, or object segmentation.

18. The method of claim 4, wherein the one or more age-dependent phenotypes comprise: size of chromosomes, size of nucleus, size of cell, nuclear shape, nuclear and or cytoplasmic granularity, pixel intensity, texture, and nucleoli number and appearance, or subcellular structures including mitochondria, lysosomes, endomembranes, actin filaments, cell membrane, microtubules, endoplasmic reticulum, or shape of cell.

19. The method of claim 1, wherein the training uses a plurality of images obtained from a same cell type of different known chronological ages.

20. The method of claim 4, further comprising: determining an extent or rate of accelerated aging if the one or more cells are determined to have undergone the accelerated aging based on changes to the one or more age-dependent phenotypes.

21. The method of claim 20, further comprising: determining an aging effect attributable to the one or more drug candidates that is causing the accelerated aging.

22. The method of claim 4, further comprising: determining an extent or rate of delay in natural aging if the one or more cells are determined to have experienced the delay in natural aging based on changes to the one or more age-dependent phenotypes.

23. The method of claim 22, further comprising: determining a rejuvenation effect attributable to the one or more drug candidates that is causing the delay in natural aging.

24. The method of claim 1, wherein the multi-class model comprises a plurality of age groups.

25. The method of claim 4, wherein the machine learning-based classifier is further configured to account for molecular data in conjunction with the one or more images to determine changes to the one or more age-dependent phenotypes.

26. The method of claim 4, wherein the machine learning-based classifier is further configured to account for proteomics, metabolomics or gene expression data in conjunction with the one or more images to determine changes to the one or more age-dependent phenotypes.

27. The method of claim 4, wherein the machine learning-based classifier is further configured to account for one or more functional assays in conjunction with the one or more images to determine changes to the one or more age-dependent phenotypes.

28. The method of claim 27, wherein the one or more functional assays include assays for mitochondrial, lysosomal, mitotic function/status, DNA or epigenetic repair, or response to injury.

29. The method of claim 1, wherein the one or more cells comprises a plurality of cells of different cell types.

30. The method of claim 12, further comprising enhancing a clarity of an organelle of the cell in each of the one or more images.

31. The method of claim 30, wherein the organelle of the cell is nucleolus, nucleus, ribosome, vesicle, rough endoplasmic reticulum, golgi apparatus, cytoskeleton, smooth endoplasmic reticulum, mitochondria, vacuole, cytosol, lysosome, and/or chloroplasts.

32. The method of claim 1, wherein the general region includes a cytoplasm of the cell.

33. The method of claim 1, wherein the general region is defined by a plasma membrane of the cell.

34. The method of claim 1, further comprising: comparing the biological age of the one or more cells with the known chronological age, to determine if the one or more drug candidates have an effect on cell function.

35. The method of claim 1, wherein the applying the machine learning-based classifier on the one or more images to determine a biological age of the one or more cells is further based on cell function.
